(19) United States
(12) Patent Application Publication
(10) Pub. No.: US 2007/0042295 A1
(43) Pub. Date: Feb. 22, 2007

(54) Optical data carrier comprising a polymeric network in the information layer

(76) Inventors: Horst Berneth, Leverkusen (DE); Friedrich-Karl Bruder, Krefeld (DE); Rainer Hagen, Leverkusen (DE); Karin Hassenruck, Dusseldorf (DE); Serguei Kostromine, Swisstal-Buschhoven (DE); Christa Maria Kruger, Schneverdingen (DE); Timo Meyer-Friedrichsen, Schneverdingen (DE); Rafael Oser, Krefeld (DE); Josef-Walter Stawitz, Odenthal (DE)

Correspondence Address: Lanxess Corporation;Law and Intellectual Property Department, 111 Ridc Park West Drive, Pittsburgh, PA, 15275-1112, US

(21) Appl. No.: 10/549,100

(22) PCT Filed: Mar. 12, 2004
(86) PCT No.: PCT/EP04/02585

§ 371 Date: Oct. 3, 2006

(30) Foreign Application Priority Data
Mar. 25, 2003 (DE) 103 13 173.6

(51) Int. Cl. G11B 7/24

(52) U.S. Cl. 430/270.14

(57) ABSTRACT

Optical data carriers having at least one information layer which comprises a polymeric network comprising covalently bound light-absorbent compounds.

The invention relates to optical data stores having a polymeric network based on organic dyes in the information layer, processes for producing it, its use and layer-like polymeric networks, their preparation and use.

DE-A-10115227 has described write-once optical data carriers comprising light-absorbent compounds having at least two chromophoric centres in their information layer. Such compounds can be, for example, appropriate homopolymers, copolymers or graft polymers or else dendrimers.

However, such data carriers have some disadvantages.

Thus, the polymeric dyes of DE-A-10115227 have a deformability which is too high. Furthermore, it is not possible to build up a plurality of information layers by means of a plurality of successive spin coating cycles using these polymeric dyes and also other dyes, since the dye of the first layer applied would redissolve when using, for example, identical solvents in the application by spin coating of the subsequent layer. This causes nonuniform layer thicknesses and a particularly undesirable mixing of the dyes of the different layers if the individual layers are to be built up of different dyes.

Films of organic dyes or polymeric dyes generally have mechanical surface hardnesses and scratch resistances which are often insufficient to make do without a protective coating. For this reason, information layers based on organic dyes or polymeric dyes are unsuitable or have only limited suitability for optical data stores using the principle of “first surface recording/reading”. Here, the information is written or read directly on or directly under the surface of the data carrier. The distance between the surface of the lens or the aperture of the writing/reading head and the data carrier surface is less than the light wavelength in vacuo λ used (near-field optics). For this reason, mechanical contact of the writing/reading head with the data carrier surface can frequently occur. Information layers having a low mechanical surface hardness and a low scratch resistance are damaged and become unusable as a result.

It is therefore an object of the invention to provide optical data carriers which are improved compared with the prior art and no longer have the above-described disadvantages.

The invention accordingly provides optical data carriers having at least one information layer comprising a polymeric network containing covalently bound light-absorbent compounds.

The data carriers of the invention preferably have an information layer having a high mechanical surface hardness and a high scratch resistance and are therefore suitable for “first surface recording/reading”.

The polymeric network is preferably present in layer form as information layer or as part of the information layer on the data carrier.

The information layer is preferably a light-writable and light-readable layer. The light is preferably blue, red or infrared light, in particular laser light.

The wavelength ranges are particularly preferably 380-450 nm, in particular 390-420 nm, for blue light, 630-680 nm, in particular 635-660 nm, for red light and 750-830 nm, in particular 770-800 nm, for infrared light.

One or more information layers can be applied to the optical data carrier. For the formats such as CD-R, DVD-R and BD-R, there is, however, preferably one information layer per side on the data carrier.

It is also possible to apply a plurality of layers of the polymeric network in succession to the data carrier.

To write on and read the information layers in the case of CD-R, DVD-R and BD-R, preference is given to using far-field optics. To write on and read the information layers in first surface recording/reading, preference is given to using near-field optics realised by means of, for example, a solid immersion lens or an aperture having a diameter of less than the laser light wavelength λ in vacuo used.

The thickness of each information layer on the optical data carrier when using far-field optics for writing and reading is preferably from 1 to

$$λ \cdot \frac{\sqrt{{n}^{2} - {NA}^{2}}}{4 \cdot π \cdot {NA}^{2}} nm ,$$

in particular from 10 to

$$λ \cdot \frac{\sqrt{{n}^{2} - {NA}^{2}}}{4 \cdot π \cdot {NA}^{2}} nm .$$

$$λ \cdot \frac{\sqrt{{n}^{2} - {NA}^{2}}}{4 \cdot π \cdot {NA}^{2}}$$

describes the depth of field of the far-field optics used (J.-Ph. Perez, Optik, Spektrum akademischer Verlag). λ is the laser light wavelength in vacuo, NA is the numerical aperture of the lens and n is the index of refraction of the substrate material or cover layer material which is located between lens and information layer and through which the light passes.

The thickness of each information layer on the optical data carrier when using near-field optics for writing and reading is preferably from 1 to

$$λ \cdot \frac{1}{5} nm ,$$

in particular from 10 to

$$λ \cdot \frac{1}{10} nm .$$

λ is in nm. The thickness of the information layer on the optical data carrier can therefore be fixed, since the surface of the substrate on which the information layer is located generally has a pregroove in the form of a groove-like structure. For this reason, when the dyes which on curing form the future information layer are applied by spin coating, not all regions of the data carrier surface will have the same thickness of information layer.

The polymeric network preferably has an absorption maximum in the range from 340 to 820 nm.

The polymeric network is based on at least one monomer containing at least one group which absorbs light.

Preference is given to monomers which have an absorption maximum λₘₐₓ₁ in the range from 340 to 410 nm or an absorption maximum λₘₐₓ₂ in the range from 400 to 650 nm or an absorption maximum λₘₐₓ₃ in the range from 630 to 820 nm, where the wavelength λ_{1/2}, at which the absorbance in the long wavelength flank of the absorption maximum at the wavelength λₘₐₓ₁, λₘₐₓ₂ or λₘₐₓ₃ or the absorbance in the short wavelength flank of the absorption maximum at the wavelength λₘₐₓ₂ or λₘₐₓ₃ is half of the absorbance value at λₘₐₓ₁, λₘₐₓ₂ or λₘₐₓ₃ and the wavelength λ_{1/10} at which the absorbance in the long wavelength flank of the absorption maximum at the wavelength λₘₐₓ₁, λₘₐₓ₂ or λₘₐₓ₃ or the absorbance in the short wavelength flank of the absorption maximum at the wavelength λₘₐₓ₂ or λₘₐₓ₃ is one tenth of the absorbance value at λₘₐₓ₁, λₘₐₓ₂ or λₘₐₓ₃ are preferably not more than 80 nm apart.

The light-absorbing groups of the monomers should preferably be able to be changed thermally. The thermal change preferably occurs at a temperature of <600° C., particularly preferably at a temperature of <400° C., very particularly preferably at a temperature of <300° C., in particular <200° C. Such a change can be, for example, a decomposition or chemical change of the chromophoric centre of the monomer.

In a preferred embodiment of the invention, the absorption maximum λₘₐₓ₁ of the monomer is in the range from 340 to 410 nm, preferably from 345 to 400 nm, in particular from 350 to 380 nm, particularly preferably from 360 to 370 nm, where the wavelength λ_{1/2} at which the absorbance in the long wavelength flank of the absorption maximum at the wavelength λₘₐₓ₁ is half of the absorbance value at λₘₐₓ₁ and the wavelength λ_{1/10} at which the absorbance in the long wavelength flank of the absorption maximum at the wavelength λₘₐₓ₁ is one tenth of the absorbance value at λₘₐₓ₁ must not be more than 50 nm apart. Such as monomer preferably has no longer-wavelength maximum λₘₐₓ₂ up to a wavelength of 500 nm, particularly preferably 550 nm, very particularly preferably 600 nm.

In such a monomer, λ_{1/2} and λ_{1/10} as defined above are preferably not more than 40 nm apart, particularly preferably not more than 30 nm apart, very particularly preferably not more than 10 nm apart.

In a further preferred embodiment of the invention, the absorption maximum λₘₐₓ₂ of the monomer is in the range from 420 to 550 nm, preferably from 410 to 510 nm, in particular from 420 to 510 nm, particularly preferably from 430 to 500 nm, where the wavelength λ_{1/2} at which the absorbance in the short wavelength flank of the absorption maximum at the wavelength λₘₐₓ₂ is half of the absorbance value at λₘₐₓ₂ and the wavelength λ_{1/10} at which the absorbance in the short wavelength flank of the absorption maximum at the wavelength λₘₐₓ₂ is one tenth of the absorbance value at λₘₐₓ₂ must not be more than 50 nm apart. Such a light-absorbent compound preferably has no shorter-wavelength maximum λₘₐₓ₁ down to a wavelength of 350 nm, particularly preferably 320 nm, very particularly preferably 290 nm.

In these monomers, λ_{1/2} and λ_{1/10} as defined above are preferably not more than 40 nm apart, particularly preferably not more than 30 nm apart, very particularly preferably not more than 20 nm apart.

In a further embodiment of the invention, the absorption maximum λₘₐₓ₂ of the monomer is in the range from 500 to 650 nm, preferably from 530 to 630 nm, in particular from 550 to 620 nm, particularly preferably from 580 to 610 nm, where the wavelength λ_{1/2} at which the absorbance in the long wavelength flank of the absorption maximum at the wavelength λₘₐₓ₂ is half of the absorbance value at λₘₐₓ₂ and the wavelength λ_{1/10} at which the absorbance in the long wavelength flank of the absorption maximum at the wavelength λₘₐₓ₂ is one tenth of the absorbance value at λₘₐₓ₂ must not be more than 50 nm apart. Such a compound preferably has no longer-wavelength maximum λₘₐₓ₃ up to a wavelength of 750 nm, particularly preferably 800 nm, very particularly preferably 850 nm.

In these monomers, λ_{1/2} and λ_{1/10} as defined above are preferably not more than 40 nm apart, particularly preferably not more than 30 nm apart, very particularly preferably not more than 10 nm apart.

In a further embodiment of the invention, the absorption maximum λₘₐₓ₃ of the monomer is in the range from 630 to 800 nm, preferably from 650 to 770 nm, in particular from 670 to 750 nm, particularly preferably from 680 to 720 nm, where the wavelength λ_{1/2} at which the absorbance in the short wavelength flank of the absorption maximum at the wavelength λₘₐₓ₃ is half of the absorbance value at λₘₐₓ₃ and the wavelength λ_{1/10} at which the absorbance in the short wavelength flank of the absorption maximum at the wavelength λₘₐₓ₃ is one tenth of the absorbance value at λₘₐₓ₃ must not be more than 50 nm apart. Such a compound preferably has no shorter-wavelength maximum λₘₐₓ₂ down to a wavelength of 600 nm, particularly preferably 550 nm, very particularly preferably 500 nm.

In this monomer, λ_{1/2} and λ_{1/10} as defined above are preferably not more than 40 nm apart, particularly preferably not more than 30 nm apart, very particularly preferably not more than 20 nm apart.

In a further embodiment of the invention, the absorption maximum λₘₐₓ₃ of the monomer is in the range from 650 to 810 nm, preferably from 660 to 790 nm, in particular from 670 to 760 nm, particularly preferably from 680 to 740 nm, where the wavelength λ_{1/2} at which the absorbance in the long wavelength flank of the absorption maximum at the wavelength λₘₐₓ₃ is half of the absorbance value at λₘₐₓ₃ and the wavelength λ_{1/10} at which the absorbance in the long wavelength flank of the absorption maximum at the wavelength λₘₐₓ₃ is one tenth of the absorbance value at λₘₐₓ₃ are preferably not more than 50 nm apart.

In these monomers, λ_{1/2} and λ_{1/10} as defined above are preferably not more than 40 nm apart, particularly preferably not more than 30 nm apart, very particularly preferably not more than 20 nm.

The monomers preferably have a molar extinction coefficient ε of >10 000 l/mol cm, more preferably >15 000 l/mol cm, particularly preferably >20 000 l/mol cm, very particularly preferably >25 000 l/mol cm, in particular >30 000 l/mol cm, most preferably >40 000 l/mol cm, at the absorption maximum λₘₐₓ₁, λₘₐₓ₂ and/or λₘₐₓ₃.

Apart from the ε value which is a solution-typical parameter, the same physical properties also apply to the polymeric network.

Possible polymeric networks are ones prepared by polymerization, polycondensation or polyaddition reactions.

Polymeric networks are preferably based on

A) polyfunctional monomers and, if desired,

B) monofunctional monomers,

where at least 50% by weight of the monomers used bears a radical of a light-absorbent compound.

For the present purposes, polyfunctional means bearing a plurality of groups which are available as reactive centre for the appropriate reaction, i.e. polymerization, polycondensation or polyaddition. Correspondingly, only one such group is present in monofunctional monomers.

For the polymerization to prepare the networks, these are preferably polymerizable C—C double bonds and also specific heterocyclic structures such as ethers, thioethers, esters and acetals, in particular C—C double bonds or oxirane rings which can be polymerized by free-radical or cationic mechanisms.

For the purposes of the present invention, “based on” means that other components apart from A) and B) can also be used for preparing the polymeric networks. However, preference is given to more than 90% by weight, more preferably more than 95% by weight, in particular more than 98% by weight, of the reactants being of the types A) and, if desired, B).

In the polymerization, component

A) preferably consists of bifunctional or higher-functional monomers.

For the polyaddition or polycondensation, components A) used are preferably made up of

A1) at least one bifunctional monomer and

A2) at least one trifunctional or higher-functional monomer.

For the present purposes, monomers of course also include functional prepolymers which can be used for polymerization in the sense of the patent application.

Preferred polyfunctional monomers of the component A) are monomers of the formula (II)
KₖB_{b}F_{f} (II),
where
F is a chromophoric centre, with all f chromophoric centres being able to be different;
K is a polymerizable group, with all k polymerizable groups being able to be different,
B is a bivalent bridge, with all b bridges being able to be different,
k is an integer from 2 to 1000,
b, f are integers which can independently assume values from 1 to 1000.

The polymerization is preferably carried out using a mixture of the components A) and B) in which up to 90% by weight is made up of the component B).

Particular preference is given to monomers corresponding to the formulae III-VI:
(K—B¹—)ₙF (III)
(K—B¹—)ₙF—B²—F(—B¹—K)ₙ (IV)
B³[—F(—B¹—K)ₙ]ₘ (V)
[(K—)₍ₘ₋₁₎B³—]ₙF (VI),
where
B¹ and B² are each a bivalent bridge,
B³ is an m-valent bridge,
n is an integer from 1 to 8,
m is 3 or 4.

Particular preference is also given to polymeric monomers, in particular those corresponding to the formulae VII and VIII:
. . . —[—F(B¹—K)ₙ—B²]ₚ₍₀₎— . . . (VII)
. . . —{—P[—B¹—F(—B²—K¹)ₙ₋₁]—}ₚ₍₀₎— . . . (VIII),
where
P— is a repeating unit of the polymeric backbone, with very particular preference being given to compounds whose backbone has been formed by polymerization of the groups K,
p(0) is the mean degree of polymerization customary for the polymers and can be from 3 to 1000, very particularly preferably from 3 to 100,
K¹ is a polymerizable group which may be different from the polymerizable group K.

Particular preference is likewise given to chromophore-containing copolymers having the polymerizable groups in the side chains (formulae IX to XI)
. . . —{—P¹[—B¹—F¹(—B²—K¹)ₙ₋₁]—}ₚ₍₁₎— . . . —{—P²[—B⁴—F²]—}ₚ₍₂₎— . . . (IX)
. . . —{—P¹[—B¹—F¹(—B²—K¹)ₙ₋₁]—}ₚ₍₁₎— . . . —{—P²[—B⁴—F²(—B⁵—K¹)ₗ₋₁]—}ₚ₍₂₎— . . . (X)
. . . —{—P¹[—B¹—F]—}ₚ₍₁₎— . . . —{—P²B³[—K¹]ₘ₋₁—}ₚ₍₂₎— . . . (XI)
where
P¹ and P²— are the identical or different repeating units of the polymeric backbone, with very particular preference being given to compounds whose backbone has been formed by polymerization of identical or different groups K,
B⁴ and B⁵ are as defined for B¹ and B²,
p(1) and p(2) are the corresponding contributions to the degree of polymerization which together correspond to a mean degree of polymerization p(0) which is customary for the polymers and can be from 3 to 1000.

Particularly preferred monomers for producing the information layers are monomers of the formulae (III) to (XI),

where

B¹, B², B⁴, B⁵ are each -Q¹-T¹-Q²-,
B³ is 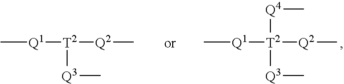
Q¹ to Q⁴ are each, independently of one another, a direct bond or —O—, —S—, —NR¹—, —C(R²R³)—, —(C═O)—, —(CO—O)—, —(CO—NR¹)—, —(SO₂)—, —(SO₂—O)—, —(SO₂—NR¹)—, —(C═NR⁴)—, —(CNR¹—NR⁴)—, —(CH₂)ₚ—, —(CH₂CH₂O)ₚ—CH₂CH₂—, o-, m- or p-phenylene, where the chain —(CH₂)ₚ— may be interrupted by —O—, —NR¹— or —OSiR⁵₂O—, or a 1,2-, 1,3- or 1,4-cyclohexane ring in all its possible isomeric variants, where the cyclohexane ring may bear up to 3 methyl substituents,
T¹ is a direct bond or —(CH₂)ₚ— or o-, m- or p-phenylene, where the chain —(CH₂)ₚ— may be interrupted by —O—, —NR¹— or —OSiR⁵₂O—, or is a 1,2-, 1,3- or 1,4-cyclohexane ring in all its possible isomeric variants, where the cyclohexane ring may bear up to 3 methyl substituents,
T² is 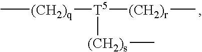
where the chains —(CH₂)_{q}—, —(CH₂)ᵣ— and/or —(CH₂)ₛ— may be interrupted by —O—, —NR¹— or —OSiR⁵₂O—,
T³ is 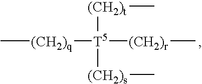
T⁵ is CR⁶, N or a trivalent radical of the formula 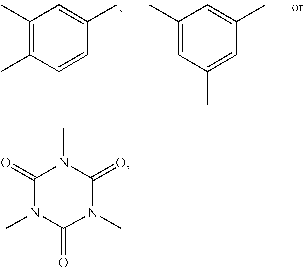
T⁶ is C, Si(O—)₄, 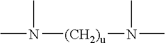
or a tetravalent radical of the formula 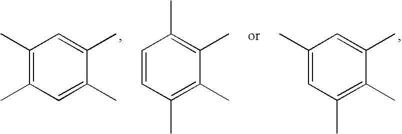
p is an integer from 1 to 12,
q, r, s and t are each, independently of one another, an integer from 0 to 12,
u is an integer from 2 to 4,
R¹ is hydrogen, C₁-C₁₂-alkyl, C₃-C₁₀-cycloalkyl, C₂-C₁₂-alkenyl, C₆-C₁₀-aryl, C₁-C₁₂-alkyl-(C═O)—, C₃-C₁₀-cycloalkyl-(C═O)—, C₂-C₁₂-alkenyl-(C═O)—, C₆-C₁₀-aryl-(C═O)—, C₁-C₁₂-alkyl-(SO₂)—, C₃-C₁₀-cycloalkyl-(SO₂)—, C₂-C₁₂-alkenyl-(SO₂)— or C₆-C₁₀-aryl-(SO₂)—,
R² to R⁴ and R⁶ are each, independently of one another, hydrogen, C₁-C₁₂-alkyl, C₃-C₁₀-cycloalkyl, C₂-C₁₂-alkenyl, C₆-C₁₀-aryl,
R⁵ is methyl or ethyl
and the other radicals are as defined above.
K and K¹ are each, independently of one another, a polymerizable group. Preference is given to acryloyloxy, methacryloyloxy, 2-chloroacryloyloxy and 2-bromoacryloyloxy, o-, m-, and p-styryl, acryloylamide and methacryloylamide, N-alkylacryloylamide and N-alkylmethacryloylamide, vinyloxy and vinyloxycarbonyl, oxiranyl, 2- and 3-oxetanyl, 2 and 3-tetrahydrofuranyl, vinylphosphonyl and vinylsulphonyl, 2-, 3-, 4-vinylpyridinium and N-vinylimidazolium groups. Particular preference is given to acryloyloxy, methacryloyloxy, vinyloxy and oxiranyl groups.

Preferred functionalized polymers and copolymers of the formulae (VII)-(XI) are ones whose polymer chain is based on identical or different structural elements P, P¹ and P², where
P, P¹ and P² are each, independently of one another, a structural element of a polyacrylate, polymethacrylate, polyacrylamide, polymethacrylamide, polysiloxane, poly-α-oxirane, polyether, polyamide, polyurethane, polyurea, polyester, polycarbonate, polystyrene or polymaleic acid derivative. Preference is given to polyacrylates, polymethacrylates, polyvinyl ethers and esters and also poly(α-oxiranes). Preference is likewise given to copolymers comprising acrylate or methacrylate and acrylamide units. Particular preference is given to polyacrylates and polymethacrylates. In these cases, P, P¹ and P² are each, independently of one another, 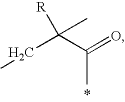
   where
   R is hydrogen or methyl and
   the asterisked (*) bond leads to spacer groups B¹, B³, B⁴.

The chromophoric centres of the monomers having light-absorbing groups can be, for example, radicals of the following structural types (cf., for example, G. Ebner and D. Schulz, Textilfärberei und Farbstoffe, Springer-Verlag, Berlin Heidelberg, 1989; H. Zollinger, Color Chemistry, VCH Verlagsgesellschaft mbH Weinheim, 1991):

azo dyes, anthraquinoid dyes, indigoid dyes, polymethine dyes, arylcarbonium dyes, nitro dyes, perylenes, coumarins, formazanes, bridged or unbridged (hetero)cinnamic acid derivatives, (hetero)stilbenes, methines, cyanines, hemicyanines, neutromethines (merocyanines), nullmethines, azomethines, hydrazones, azine dyes, triphenodioxazines, pyronines, acridines, rhodamines, indamines, indophenols, diphenylmethanes or triphenylmethanes, aryl and hetaryl azo dyes, quinoid dyes, phthalocyanines, naphthocyanines, subphthalocyanines, porphyrins, tetraazaporphyrins and metal complexes.

The light-absorbing groups of the monomers used for preparing the polymeric networks and thus the light-absorbing groups of the polymeric network itself are derived from light-absorbent compounds.

Preferred light-absorbent compounds having an absorption maximum λₘₐₓ₁ in the range from 340 to 410 nm (corresponds also to the monomer bearing these groups) are, for example, those of the following formulae. Corresponding optical data stores comprise these polymeric networks based on corresponding monomers having light-absorbing groups based on compounds in the information layer can be read and written on by means of blue or red light, in particular laser light: 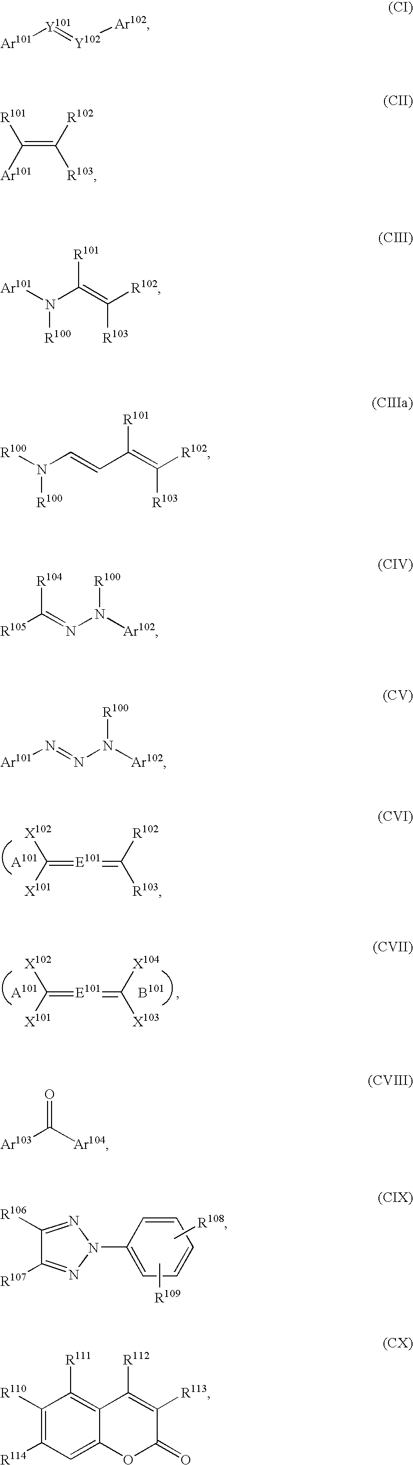 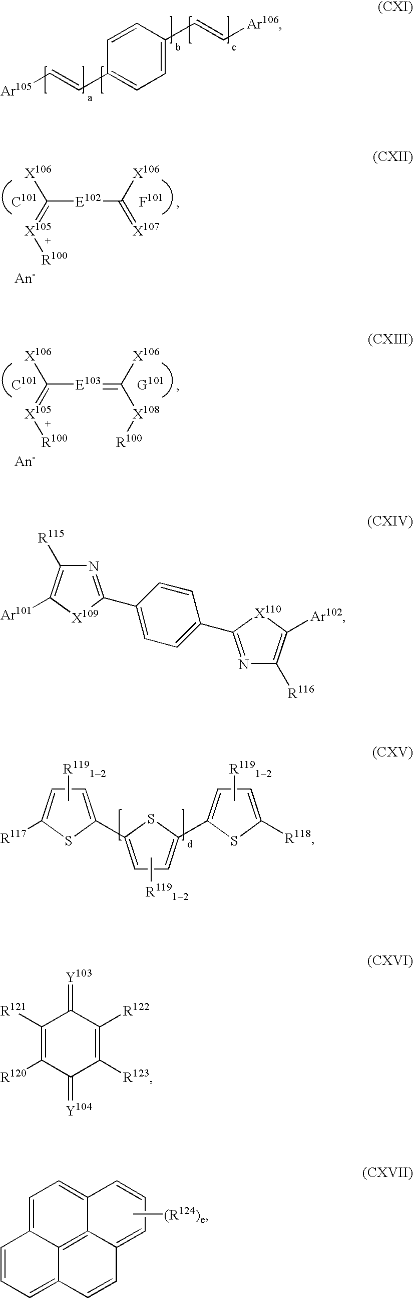 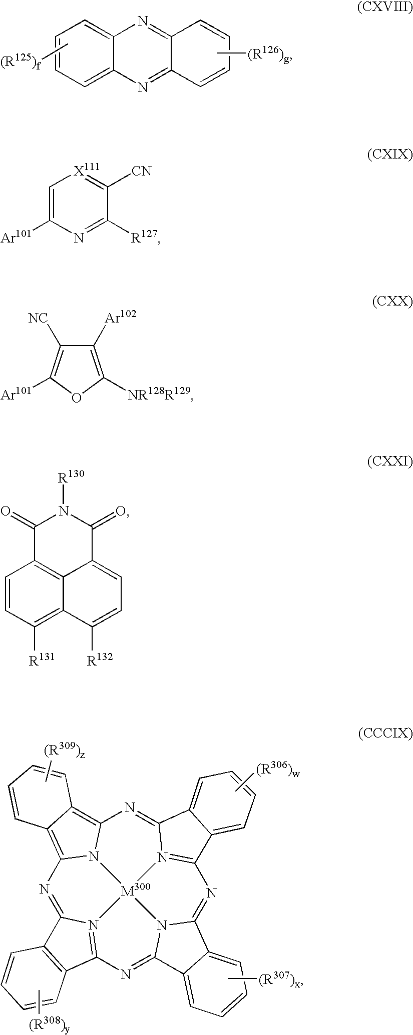
where
Ar¹⁰¹ and Ar¹⁰² are each, independently of one another, C₆-C₁₀-aryl or the radical of a five- or six-membered aromatic, pseudoaromatic or partially hydrogenated heterocyclic ring which may be benzo- or naphtho-fused and/or substituted by nonionic radicals,
Y¹⁰¹ and Y¹⁰² are each, independently of one another, N or C—R¹⁰¹ or
Y¹⁰¹═Y¹⁰² can be a direct bond,
R¹⁰¹ and R¹⁰⁴ are each, independently of one another, hydrogen, C₁-C₁₆-alkyl, cyano, carboxyl, C₁-C₁₆-alkoxycarbonyl, C₁-C₁₆-alkanoyl or Ar¹⁰², or R¹⁰¹ is a bridge to Ar¹⁰¹,
R¹⁰² and R¹⁰³ are each, independently of one another, cyano, nitro, carboxyl, C₁-C₁₆-alkoxycarbonyl, aminocarbonyl or C₁-C₁₆-alkanoyl or R¹⁰² is hydrogen, halogen, C₁-C₁₆-alkyl or a radical of the formula 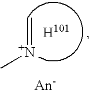
or R¹⁰³ is Ar¹⁰², CH₂—COO-alkyl or P(O)(O—C₁-C₁₂-Alkyl)₂ or C₁-C₁₆-alkyl or R¹⁰²; R¹⁰³ together with the carbon atom connecting them form a five- or six-membered carbocyclic or aromatic, pseudoaromatic or partially hydrogenated heterocyclic ring which may be benzo- or naphtho-fused and/or substituted by nonionic radicals, or R¹⁰³ forms a bridge to Ar¹⁰¹ or ring A¹⁰¹ which may contain a heteroatom and/or be substituted by nonionic radicals,
R¹⁰⁰ is hydrogen, C₁-C₁₆-alkyl, C₇-C₁₆-aralkyl or R¹⁰¹ or
NR¹⁰⁰R¹⁰⁰ is pyrrolidino, piperidino or morpholino or
R¹⁰⁰ and R¹⁰⁴ together form a —CH₂—CH₂— or —CH₂—CH₂—CH₂— bridge,
R¹⁰⁵ is cyano, carboxyl, C₁-C₁₆-alkoxycarbonyl, aminocarbonyl, C₁-C₁₆-alkanoyl or Ar¹⁰¹, or R¹⁰⁴; R¹⁰⁵ together with the carbon atom connecting them form a five- or six-membered carbocyclic or aromatic, pseudoaromatic or partially hydrogenated heterocyclic ring which may be benzo- or naphtho-fused and/or substituted by nonionic radicals,
X¹⁰¹, X¹⁰², X¹⁰³, X¹⁰⁴, X¹⁰⁶, X¹⁰⁹ and X¹¹⁰ are each, independently of one another O, S, or N—R¹⁰⁰, or X¹⁰², X¹⁰⁴ or X¹⁰⁶ may also be CH or CR¹⁰⁰R¹⁰⁰,
A¹⁰¹, B¹⁰¹, C¹⁰¹, F¹⁰¹, G¹⁰¹ and H¹⁰¹ are each, independently of one another, a five- or six-membered aromatic, pseudoaromatic or partially hydrogenated heterocyclic ring which may be benzo- or naphtho-fused and/or substituted by nonionic radicals,
X¹⁰⁵ and X¹⁰⁸ are each, independently of one another, N,
E¹⁰¹ is a direct double bond, ═CH—CH═, ═N—CH═ or ═N—N═,
E¹⁰² is a direct bond, —CH═CH—, —N═CH— or —N═N—,
Ar¹⁰³ and Ar¹⁰⁴ are each, independently of one another, 2-hydroxyphenyl radicals which may be benzo-fused and/or substituted by hydroxy, C₁-C₁₆-alkoxy or C₆-C₁₀-aryloxy,
R¹⁰⁶ and R¹⁰⁷ are each, independently of one another, hydrogen, C₁-C₁₆-alkyl or C₆-C₁₀-aryl or together form a —CH═CH—CH═CH— or o-C₆H₄—CH═CH—CH═CH— bridge,
R¹⁰⁸ is C₁-C₁₆-alkyl, CHO, CN, CO—C₁-C₈-alkyl, CO—C₆-C₁₀-aryl or CH═C(CO—C₁-C₈-alkyl)-CH₂—CO—C₁-C₈-alkyl,
R¹⁰⁹ is hydroxy or C₁-C₁₆-alkoxy,
R¹¹⁰ and R¹¹¹ are each hydrogen or together form a —CH═CH—CH═CH— bridge,
R¹¹² is hydrogen, C₁-C₁₆-alkyl or cyano,
R¹¹³ is hydrogen, cyano, C₁-C₄-alkoxycarbonyl, C₆-C₁₀-aryl, thien-2-yl, pyrid-2- or -4-yl, pyrazol-1-yl or 1,2,4-triazol-1- or -4-yl, each of which may be benzo- or naphtho-fused and/or substituted by nonionic radicals,
R¹¹⁴ is hydrogen, C₁-C₁₆-alkoxy, 1,2,3-triazol-2-yl which may bear nonionic radicals as substituents, C₁-C₁₆-alkanoylamino, C₁-C₈-alkanesulphonylamino or C₆-C₁₀-arylsulphonylamino,
Ar¹⁰⁵ and Ar¹⁰⁶ are each, independently of one another, C₆-C₁₀-aryl or a radical of a five- or six-membered aromatic, pseudoaromatic or partially hydrogenated heterocyclic ring which may be benzo- or naphtho-fused and/or substituted by nonionic radicals and/or by sulpho,
a, b and c are each, independently of one another, an integer from 0 to 2,
X¹⁰⁷ is N or N⁺—R¹⁰⁰An⁻,
An⁻ is an anion,
E¹⁰³ is N, CH, C—CH₃ or C—CN,
R¹¹⁵ and R¹⁶ are each, independently of one another, hydrogen or C₁-C₁₆-alkyl,
R¹¹⁷ and R¹¹⁸ are each, independently of one another, hydrogen, C₁-C₁₆-alkyl, cyano or C₁-C₁₆-alkoxycarbonyl,
R¹¹⁹ is hydrogen, C₁-C₁₆-alkyl, C₁-C₁₆-alkoxy or 2 radicals R¹¹⁹ of a thiophene ring are each for a bivalent radical of the formula —O—CH₂—CH₂—O—,
Y¹⁰³ and Y¹⁰⁴ are each, independently of one another, O or N—CN,
R¹²⁰ to R¹²³ are each, independently of one another, hydrogen, C₁-C₁₆-alkyl, C₁-C₁₆-alkoxy, cyano, C₁-C₁₆-alkoxycarbonyl, halogen, Ar¹⁰¹, Ar¹⁰² or
R¹²⁰ together with R¹²¹ and/or R¹²² together with R¹²³ form a —CH═CH—CH═CH— or o-C₆H₄—CH═CH—CH═CH— bridge which may be substituted by nonionic substituents,
R¹²⁴ is C₁-C₁₆-alkyl, C₁-C₁₆-alkoxy, cyano, C₁-C₁₆-alkoxycarbonyl, carboxyl, C₁-C₁₆-alkylaminocarbonyl or C₁-C₁₆-dialkylaminocarbonyl,
R¹²⁵ and R¹²⁶ are each, independently of one another, hydrogen, C₁-C₁₆-alkyl, C₁-C₁₆-alkoxy, cyano, C₁-C₁₆-alkoxycarbonyl, hydroxy, carboxyl or C₆-C₁₀-aryloxy,
e, f and g are each, independently of one another, an integer from 1 to 4, where, when e, f or g>1, the radicals may be different,
X¹¹¹ is N or C—Ar¹⁰²,
R¹²⁷ is hydrogen, C₁-C₁₆-alkyl or C₆-C₁₀-aryl,
R¹²⁸ and R¹²⁹ are each, independently of one another, hydrogen, C₁-C₁₆-alkyl, C₆-C₁₀-aryl or C₇-C₁₅-aralkyl or
NR¹²⁸R¹²⁹ is morpholino, piperidino or pyrrolidino,
R¹³⁰ is C₁-C₁₆-alkyl, C₇-C₁₅-aralkyl or Ar¹,
R¹³¹ and R¹³² are each, independently of one another, hydrogen, C₁-C₁₆-alkyl, C₁-C₁₆-alkoxy, cyano, C₁-C₁₆-alkoxycarbonyl, halogen or C₆-C₁₀-aryl or together form a bridge of the formula —CO—N(R¹³⁰)—CO—, and
the radicals M³⁰⁰, R³⁰⁶ to R³⁰⁹ and w to z of the formula (CCCIX) are explained further below,
   where the linkage to the bridges B and from B¹ to B⁵ is via the radicals R¹⁰⁰ to R¹³², M³⁰⁰, R³⁰⁶ to R³⁰⁹ or via the nonionic radicals by which Ar¹⁰¹ to Ar¹⁰⁶ and the rings A¹⁰¹ to H¹⁰¹ may be substituted. In this case, these radicals represent a direct bond.

Nonionic radicals are preferably C₁-C₄-alkyl, C₁-C₄-alkoxy, halogen, cyano, nitro, C₁-C₄-alkoxycarbonyl, C₁-C₄-alkylthio, C₁-C₄-alkanoylamino, benzoylamino, mono- or di-C₁-C₄-alkylamino.

Alkyl, alkoxy, aryl and heterocyclic radicals may if appropriate bear further radicals such as alkyl, halogen, nitro, cyano, CO—NH₂, alkoxy, trialkylsilyl, trialkylsiloxy or phenyl, the alkyl and alkoxy radicals can be linear or branched, the alkyl radicals can be partially halogenated or perhalogenated, the alkyl and alkoxy radicals can be ethoxylated or propoxylated or silylated, adjacent alkyl and/or alkoxy radicals on aryl or heterocyclic radicals can together form a three- or four-membered bridge and the heterocyclic radicals can be benzo-fused and/or quaternized.

Particular preference is given to light-absorbent compounds of the formulae (CI) to (CXXI), (CIIIa) and (CCCIX),

where

Ar¹⁰¹ and Ar¹⁰² are each, independently of one another, phenyl, naphthyl, benzothiazol-2-yl, benzoxazol-2-yl, benzimidazol-2-yl, thiazol-2-yl, thiazolin-2-yl, pyrrolin-2-yl, isothiazol-3-yl, imidazol-2-yl, 1,3,4-thiadiazol-2-yl, 1,3,4-triazol-2-yl, 2- or 4-pyridyl, 2- or 4-quinolyl, pyrrol-2- or -3-yl, thien-2- or -3-yl, furan-2- or -3-yl, indol-2- or -3-yl, benzothien-2-yl, benzofuran-2-yl or 3,3-dimethylindolen-2-yl which may each be substituted by methyl, ethyl, propyl, butyl, methoxy, ethoxy, propoxy, butoxy, chlorine, bromine, iodine, cyano, nitro, methoxycarbonyl, ethoxycarbonyl, methylthio, acetylamino, propionylamino, butanoylamino, benzoylamino, dimethylamino, diethylamino, dipropylamino or dibutylamino,
Y¹⁰¹ and Y¹⁰² are each, independently of one another, N or C—R¹⁰¹ or
Y¹⁰¹═Y¹⁰² can be a direct bond,
R¹⁰¹ and R¹⁰⁴ are each, independently of one another, hydrogen, methyl, ethyl, propyl, butyl, cyano, carboxyl, methoxycarbonyl, ethoxycarbonyl, acetyl, propionyl or Ar¹⁰², or Ar¹⁰¹ and R¹⁰¹ together form a ring of the formula 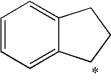
which may be substituted by methyl, ethyl, propyl, butyl, methoxy, ethoxy, propoxy, butoxy, where the asterisk (*) indicates the ring atom from which the double bond extends,
R¹⁰², R¹⁰³ and R¹⁰⁵ are each, independently of one another, cyano, carboxyl, methoxycarbonyl, ethoxycarbonyl, propoxycarbonyl, butoxycarbonyl, methoxyethoxycarbonyl, acetyl, propionyl or butanoyl, or R¹⁰² is hydrogen or a radical of the formula 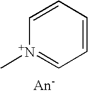
or R¹⁰³ is Ar¹⁰², or R¹⁰⁵ is Ar¹⁰¹, or R¹⁰²; R¹⁰³ or R¹⁰⁴; R¹⁰⁵ together with the carbon atom connecting them form a ring of the formula 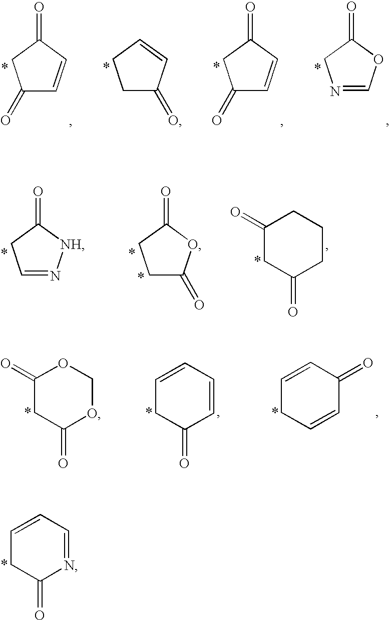
which may each be benzo- or naphtho-fused and/or substituted by nonionic radicals, where the asterisk (*) indicates the ring atom from which the double bond extends, or R¹⁰³ is a —CH₂—, —C(CH₃)₂—, —O—, —NH—, —N(CH₃)—, —N(C₂H₅)—, —N(COCH₃)—, N(COC₄H₉)— or —N(COC₆H₅)— bridge which is attached in the 2 position (based on the site of substitution) of Ar¹⁰¹ or ring A¹⁰¹,
R¹⁰⁰ is hydrogen, methyl, ethyl, propyl, butyl or benzyl or
NR¹⁰⁰R¹⁰⁰ is pyrrolidino, morpholino or piperidino or
R¹⁰⁰ and R¹⁰⁴ together form a —CH₂—CH₂— bridge or
two radicals R¹⁰⁰ in formula (CVII) or (CXIII) form a —CH₂—CH₂— or —CH₂—CH₂—CH₂— bridge,
A¹⁰¹, B¹⁰¹ and G¹⁰¹ are each, independently of one another, benzothiazol-2-ylidene, benzoxazol-2-ylidene, benzimidazol-2-ylidene, thiazol-2-ylidene, thiazolin-2-ylidene, pyrrolin-2-ylidene, isothiazol-3-ylidene, imidazol-2-ylidene, 1,3,4-thiadiazol-2-ylidene, 1,3,4-triazol-2-ylidene, pyridin-2- or -4-ylidene, quinolin-2- or -4-ylidene, pyrrol-2- or -3-ylidene, thien-2- or -3-ylidene, furan-2- or -3-ylidene, indol-2- or -3-ylidene, benzothien-2-ylidene, benzofuran-2-ylidene or 3,3-dimethylindolen-2-ylidene and A and B may also be 1,3-dithiol-2-ylidene or benzo-1,3-dithiol-2-ylidene, each of which may be substituted by methyl, ethyl, propyl, butyl, methoxy, ethoxy, propoxy, butoxy, chlorine, bromine, iodine, cyano, nitro, methoxycarbonyl, ethoxycarbonyl, methylthio, acetylamino, propionylamino, butanoylamino or benzoylamino,
C¹⁰¹ and F¹⁰¹ are each, independently of one another, benzothiazol-2-yl, benzoxazol-2-yl, benzimidazol-2-yl, thiazol-2-yl, thiazolin-2-yl, pyrrolin-2-yl, isothiazol-3-yl, imidazol-2-yl, 1,3,4-thiadiazol-2-yl, 1,3,4-triazol-2-yl, 2- or 4-pyridyl, 2- or 4-quinolyl, pyrrol-2- or -3-yl, thien-2- or -3-yl, furan-2- or -3-yl, indol-2- or -3-yl, benzothien-2-yl, benzofuran-2-yl or 3,3-dimethylindolen-2-yl, each of which may be substituted by methyl, ethyl, propyl, butyl, methoxy, ethoxy, propoxy, butoxy, chlorine, bromine, iodine, cyano, nitro, methoxy-carbonyl, ethoxycarbonyl, methylthio, acetylamino, propionylamino, butanoylamino or benzoylamino, where
   X¹⁰¹, X¹⁰², X¹⁰³, X¹⁰⁴, X¹⁰⁶, X¹⁰⁹ and X¹¹⁰ are each, independently of one another, O, S or N—R¹⁰⁰ and X¹⁰², X¹⁰⁴ or X¹⁰⁶ may also be CH or CR¹⁰⁰R¹⁰⁰,
   X¹⁰⁵ and X¹⁰⁸ are each, independently of one another, N,
   X¹⁰⁷ is N or N⁺—R¹⁰⁰An⁻ and
   An⁻ is an anion,
E¹⁰¹ is a direct double bond or ═N—N═,
Ar¹⁰³ and Ar¹⁰⁴ are each, independently of one another, a 2-hydroxyphenyl radical which may be substituted by hydroxy, methoxy, ethoxy, propoxy, butoxy or phenoxy,
R¹⁰⁶ and R¹⁰⁷ are each, independently of one another, hydrogen, methyl, ethyl, propyl, butyl or phenyl or together form a —CH═CH—CH═CH— or o-C₆H₄—CH═CH—CH═CH— bridge,
R¹⁰⁸ is methyl, ethyl, propyl, butyl, CHO, CN, acetyl, propionyl or benzoyl,
R¹⁰⁹ is hydroxy, methoxy, ethoxy, propoxy or butoxy,
R¹¹⁰ and R¹¹¹ are each hydrogen or together form a —CH═CH—CH═CH— bridge,
R¹¹² is hydrogen or methyl,
R¹¹³ is hydrogen, cyano, methoxycarbonyl, ethoxycarbonyl, phenyl, thien-2-yl, pyrid-2- or -4-yl, pyrazol-1-yl or 1,2,4-triazol-1- or 4-yl, each of which may be substituted by methyl, methoxy or chlorine,
R¹¹⁴ is hydrogen, methoxy, ethoxy, propoxy, butoxy, 1,2,3-triazol-2-yl which may bear methyl and/or phenyl groups as substituents, acetylamino, methanesulphonylamino or benzenesulphonylamino,
Ar¹⁰⁵ and Ar¹⁰⁶ are each, independently of one another, phenyl, benzothiazol-2-yl, benzoxazol-2-yl, benzimidazol-2-yl, thiazol-2-yl, thiazolin-2-yl, pyrrolin-2-yl, isothiazol-3-yl, imidazol-2-yl, 1,3,4-triazol-2-yl, 2- or 4-pyridyl, 2- or 4-quinolyl, thien-2- or -3-yl, furan-2- or -3-yl, benzothien-2-yl or benzofuran-2-yl, each of which may be substituted by methyl, ethyl, propyl, butyl, methoxy, ethoxy, propoxy, butoxy, chlorine, bromine, iodine, cyano, nitro, methoxycarbonyl, ethoxycarbonyl or sulpho,
a, b and c are each, independently of one another, an integer from 0 to 1,
E¹⁰² is a direct bond, —CH═CH— or —N═CH—,
E¹⁰³ is N or C—CN,
R¹¹⁵ and R¹¹⁶ are each, independently of one another, hydrogen, methyl or ethyl,
R¹¹⁷ and R¹¹⁸ are each, independently of one another, hydrogen, methyl, ethyl, propyl, butyl, cyano, methoxycarbonyl or ethoxycarbonyl,
R¹¹⁹ is hydrogen, methyl, methoxy, ethoxy or 2 radicals R¹¹⁹ of a thiophene ring form a bivalent radical of the formula —O—CH₂ CH₂—O—,
Y¹⁰³ and Y¹⁰⁴ are each, independently of one another, O or N—CN,
R¹²⁰ to R¹²³ are each, independently of one another, hydrogen, methyl, ethyl, propyl, butyl, methoxy, ethoxy, propoxy, butoxy, cyano, methoxycarbonyl, ethoxycarbonyl, chlorine, bromine, or
R¹²⁰ together with R¹²¹ and/or R¹²² together with R¹²³ form a —CH═CH—CH═CH— bridge,
R¹²⁴ is methyl, ethyl, propyl, butyl, methoxy, ethoxy, propoxy, butoxy, cyano, methoxycarbonyl or ethoxycarbonyl,
R¹²⁵ and R¹²⁶ are each, independently of one another, hydrogen, methyl, ethyl, propyl, butyl, methoxy, ethoxy, propoxy, butoxy, cyano, methoxycarbonyl, ethoxycarbonyl or hydroxy, where at least one of the radicals R¹²⁶ is located in ring position 1 or 3 and is methoxy, ethoxy, propoxy or butoxy,
e, f and g are each, independently of one another, 1 or 2, where, when e, f or g>1, the radicals may be different,
X¹¹¹ is N or C—Ar¹⁰²,
R¹²⁷ is hydrogen, methyl, ethyl, propyl, butyl or phenyl,
R¹²⁸ and R¹²⁹ are each, independently of one another, hydrogen, methyl, ethyl, propyl, butyl, phenyl or benzyl or
NR¹²⁸R¹²⁹ is morpholino, piperidino or pyrrolidino,
R¹³⁰ is methyl, ethyl, propyl, butyl, methoxyethyl, ethoxyethyl, methoxypropyl, benzyl, phenethyl or Ar¹,
R¹³¹ and R¹³² are each, independently of one another, hydrogen, methyl, ethyl, propyl, butyl, methoxy, ethoxy, propoxy, butoxy, methoxycarbonyl, ethoxycarbonyl, chlorine or bromine or together form a bridge of the formula —CO—N(R¹³⁰)—CO—,
M³⁰⁰ is 2H atoms, Al, Si, Ge, Zn, Mg or Ti^{IV}, where when M³⁰⁰ is Al, Si, Ge or Ti^{IV} it bears one or two further substituents or ligands R³¹³ and/or R³¹⁴ which are arranged axially relative to the phthalocyanine plane,
R³⁰⁶ to R³⁰⁹ are each, independently of one another, methyl, ethyl, propyl, butyl, methoxy or chlorine,
w to z are each, independently of one another, an integer from 0 to 4,
R³¹³ and R³¹⁴ are each, independently of one another, methyl, ethyl, phenyl, hydroxy, fluorine, chlorine, bromine, methoxy, ethoxy, phenoxy, tolyloxy, cyano or ═O,
   and the radicals R³⁰⁶ to R³⁰⁹, M³⁰⁰ and w to z may also be as defined further below,
   where the linkage to the bridges B and from B¹ to B⁵ is via the radicals R¹⁰⁰ to R¹³², via the radicals by which Ar¹⁰¹ to Ar¹⁰⁶ and the rings A¹⁰¹ to G¹⁰¹ may be substituted, via R³⁰⁶ to R³⁰⁹, R³¹³ or R³¹⁴. In this case, these radicals represent a direct bond.

The following examples are for illustrative purposes:

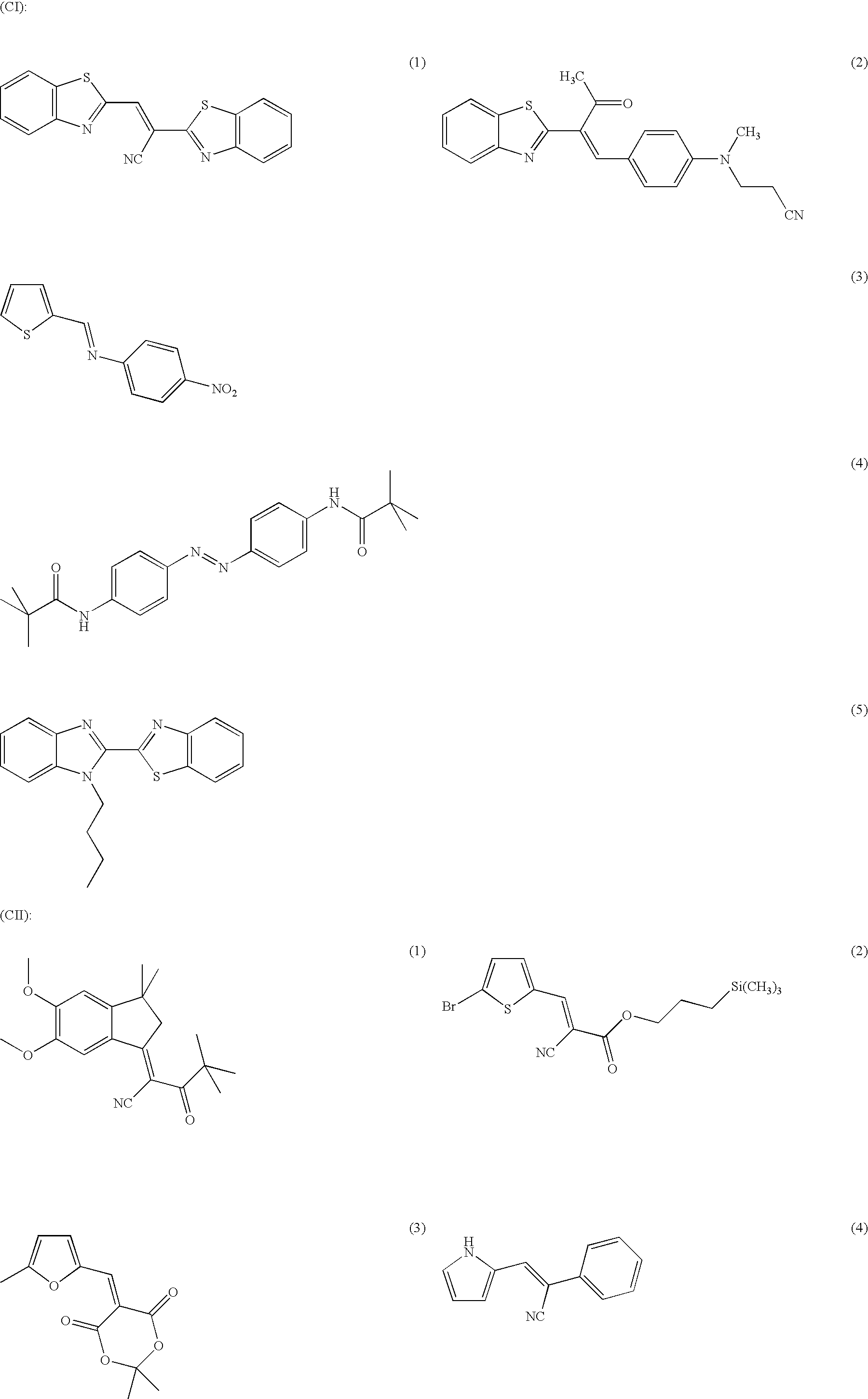

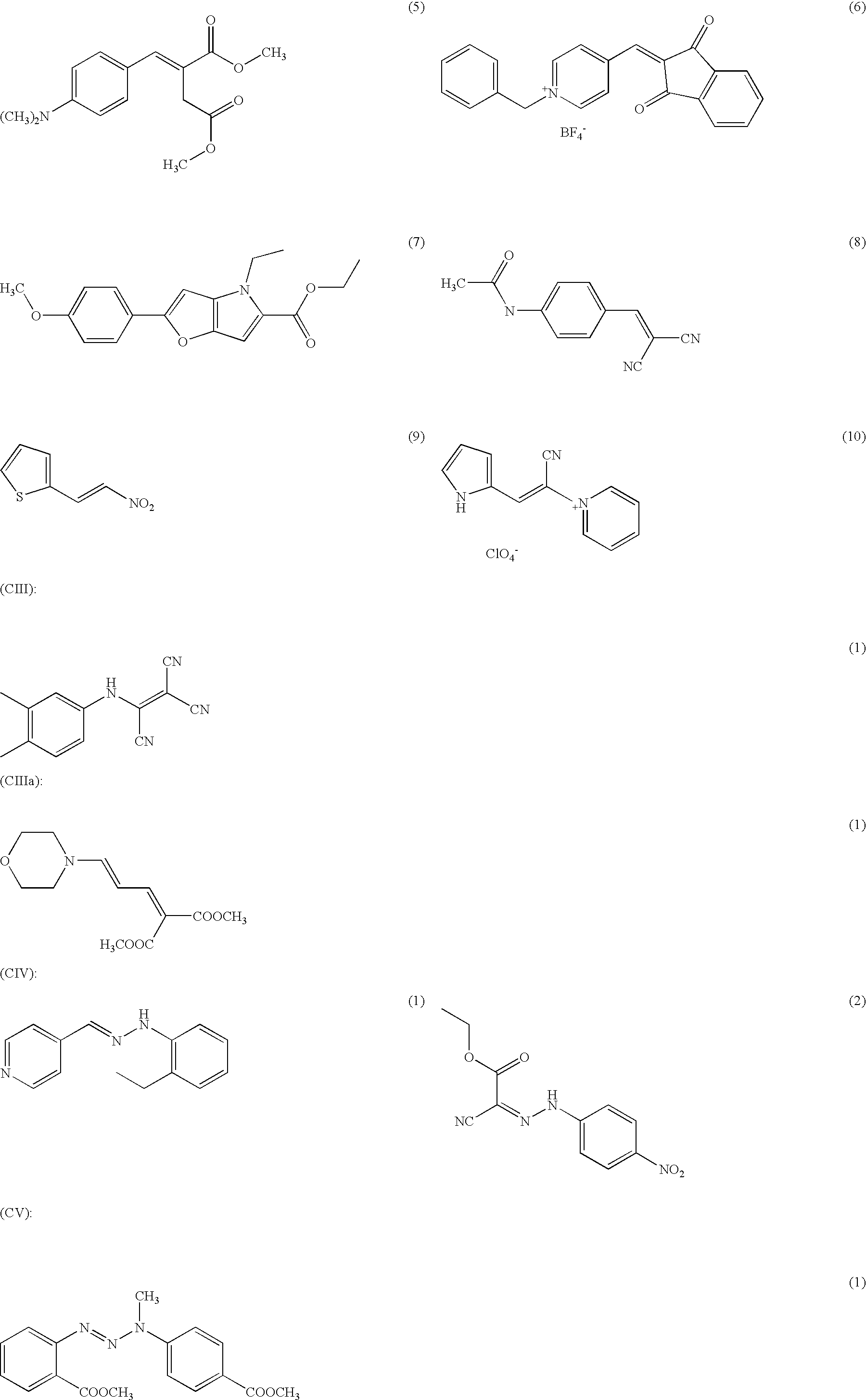

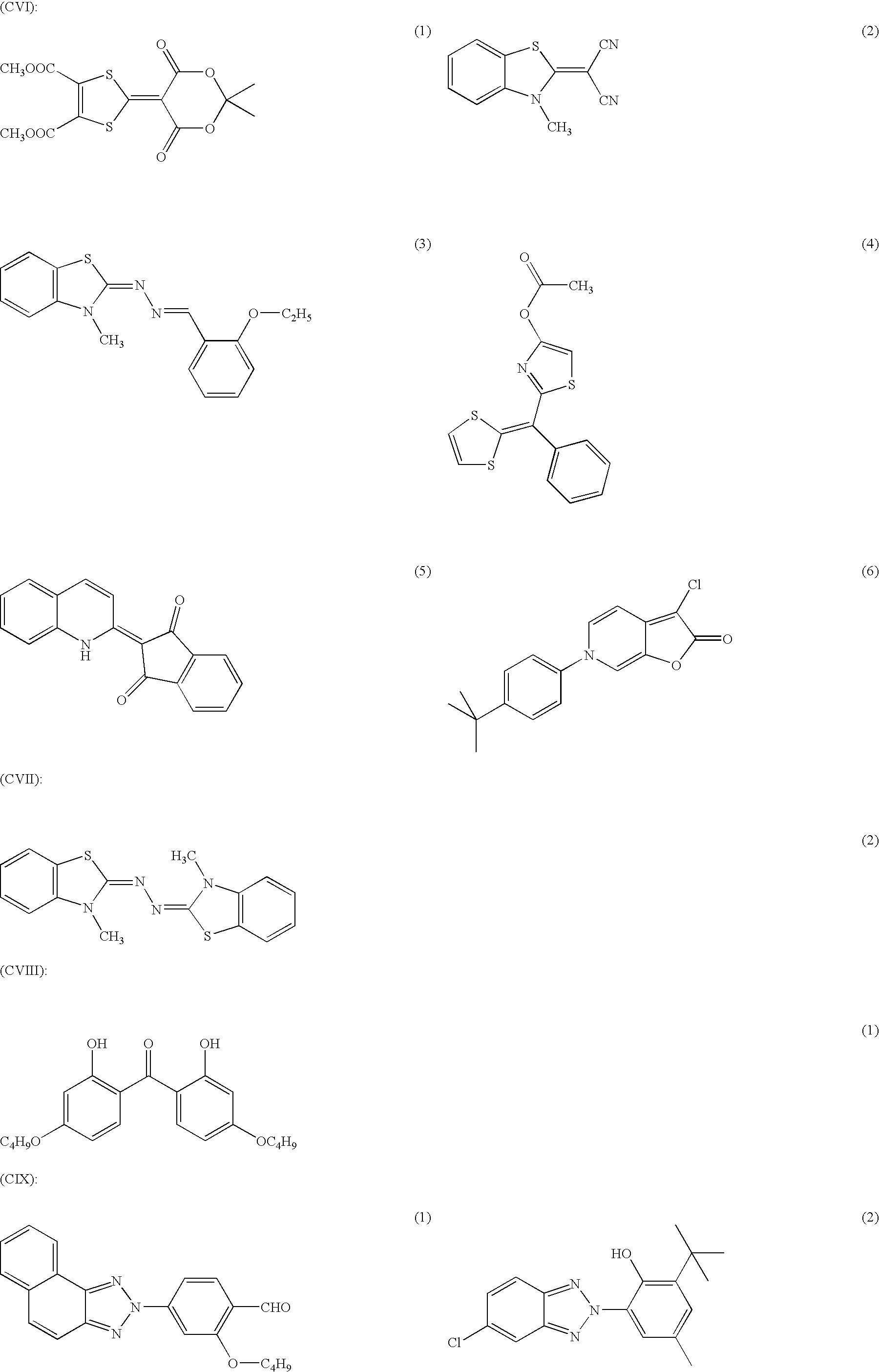

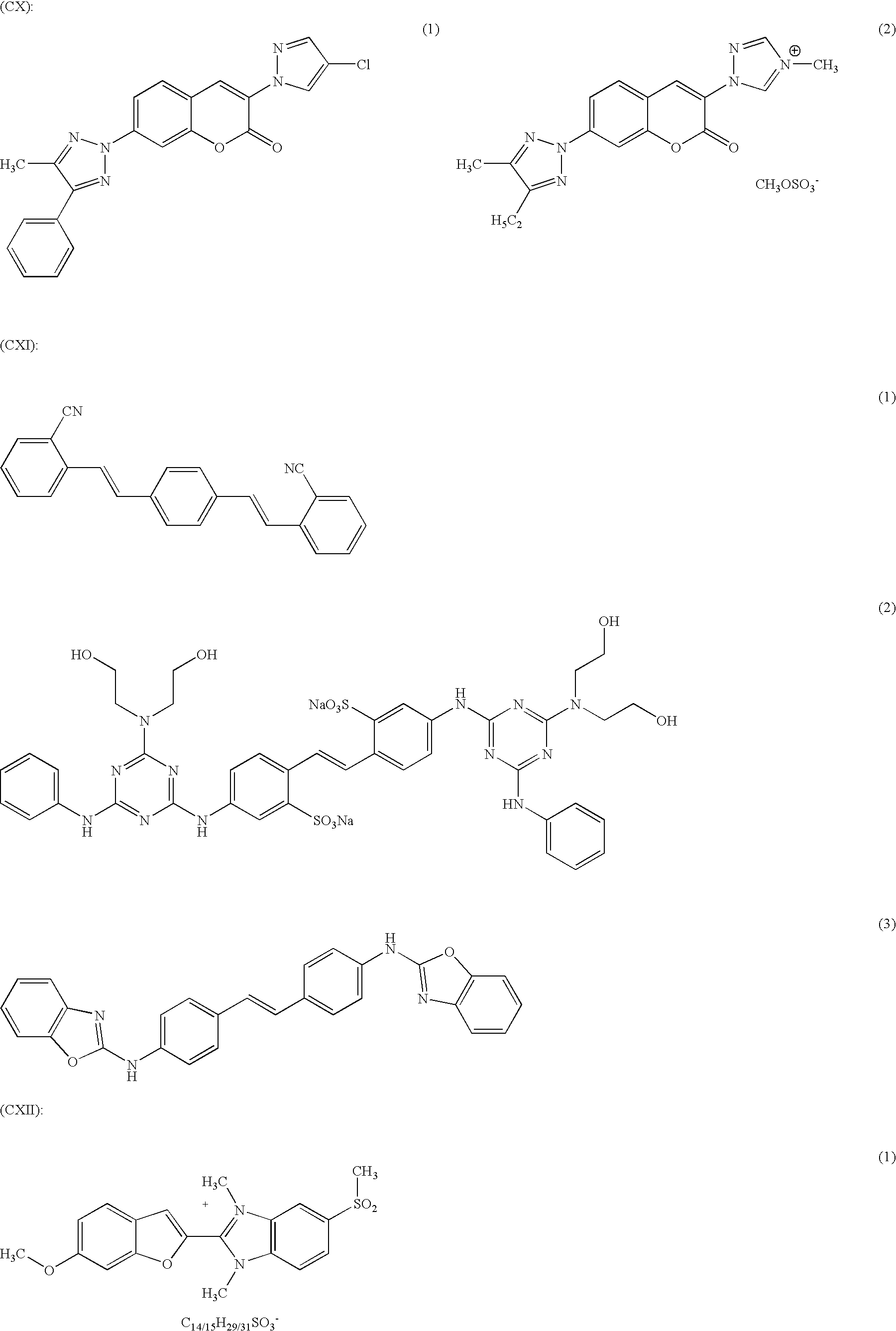

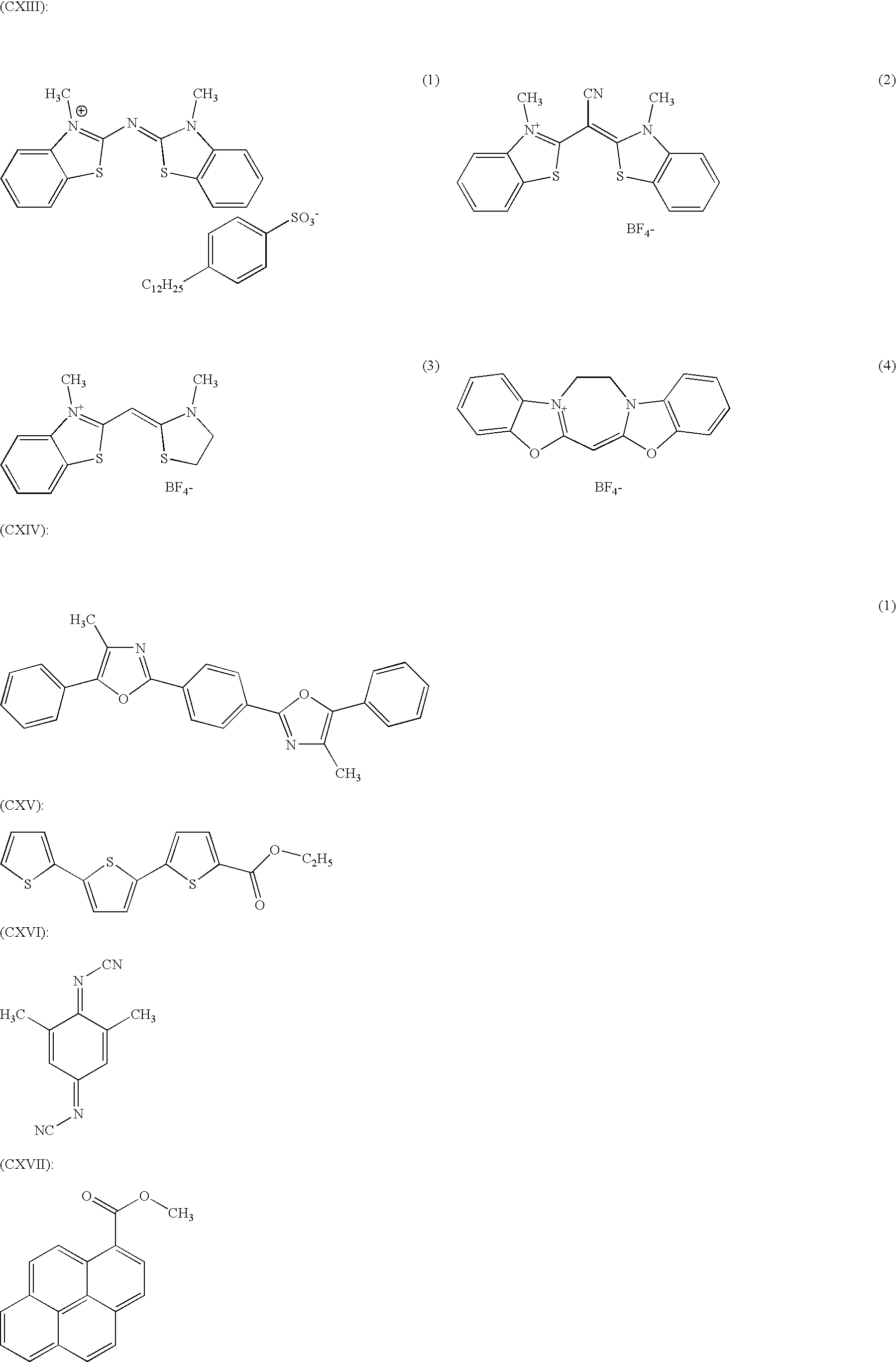

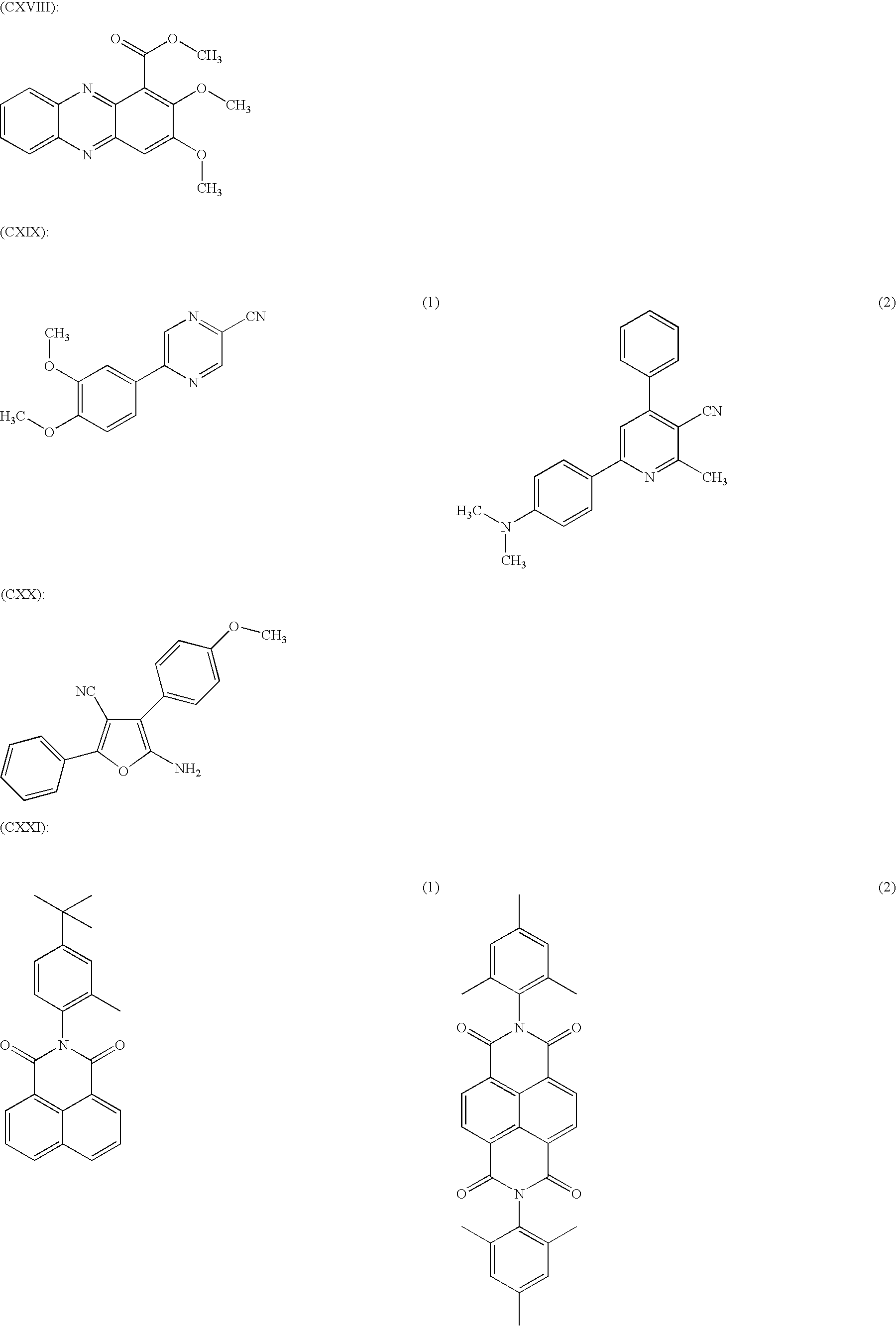

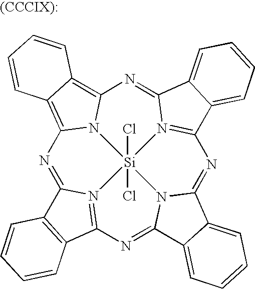

The light-absorbing groups of the monomers used for preparing the polymeric networks and thus also the light-absorbing groups of the polymeric network itself are derived from light-absorbent compounds.

Preferred light-absorbent compounds having an absorption maximum λₘₐₓ₂ in the range from 400 to 650 nm (corresponds also to the monomer bearing these groups) are, for example, compounds of the following formulae: corresponding optical data stores having polymeric networks based on corresponding monomers containing light-absorbing groups derived from these compounds in the information layer can be read and written on by means of blue or red light, in particular blue or red laser light: 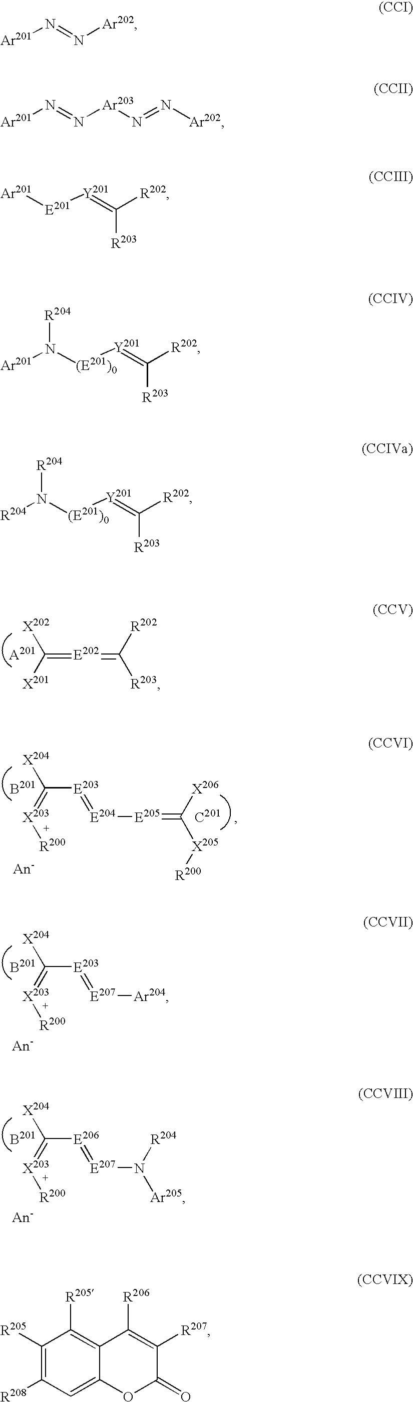 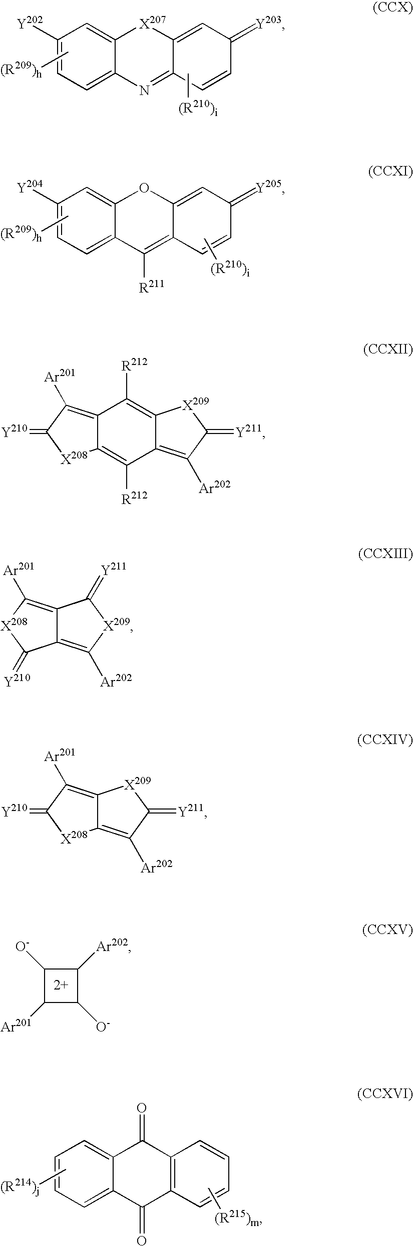 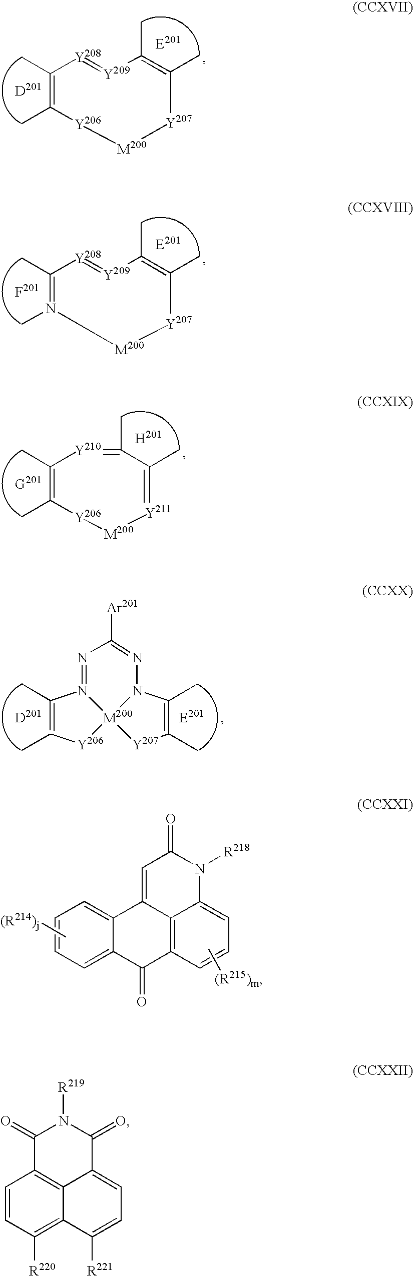 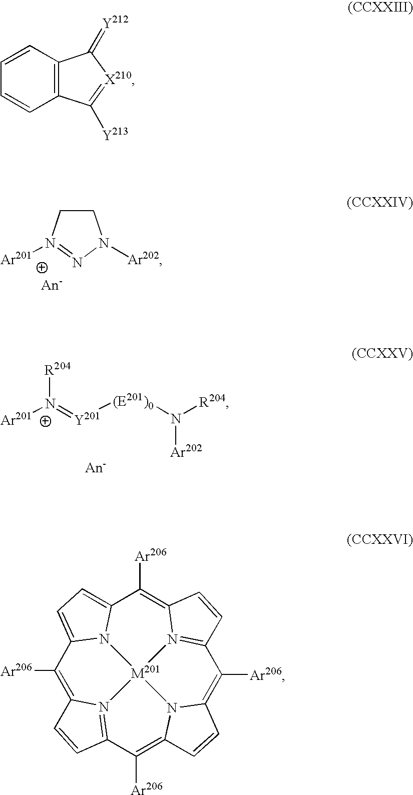
where
Ar²⁰¹, Ar²⁰², Ar²⁰⁴, Ar²⁰⁵ and Ar²⁰⁶ are each, independently of one another, C₆-C₁₀-aryl or the radical of a five- or six-membered aromatic, pseudoaromatic or partially hydrogenated heterocyclic ring which may be benzo- or naphtho-fused and/or substituted by nonionic radicals or sulpho,
Ar²⁰³ is the bifunctional radical of a C₆-C₁₀-aromatic or the bifunctional radical of a five- or six-membered aromatic, pseudoaromatic or partially hydrogenated heterocyclic ring which may be benzo- or naphtho-fused and/or substituted by nonionic radicals or sulpho, where two such bifunctional radicals may also be connected via a bifunctional bridge,
Y²⁰¹ is N or C—R²⁰¹,
R²⁰¹ is hydrogen, C₁-C₁₆-alkyl, cyano, carboxyl, C₁-C₁₆-alkoxycarbonyl, C₁-C₁₆-alkanoyl or Ar²⁰² or a bridge to Ar²⁰¹ or R²⁰⁰,
R²⁰² and R²⁰³ are each, independently of one another, cyano, carboxyl, C₁-C₁₆-alkoxycarbonyl, aminocarbonyl or C₁-C₁₆-alkanoyl or R²⁰² is hydrogen, halogen or a radical of the formula 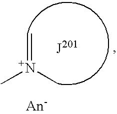
or R²⁰³ is Ar²⁰², CH₂—COO-alkyl or P(O)(O—C₁-C₁₂-alkyl)₂ or C₁-C₁₆-alkyl, or R²⁰²; R²⁰³ together with the carbon atom connecting them form a five- or six-membered carbocylic or aromatic, pseudoaromatic or partially hydrogenated heterocyclic ring which may be benzo- or naphtho-fused and/or substituted by nonionic radicals,
E²⁰¹ is a direct bond, —CH═CH—, —CH═C(CN)— or —C(CN)═C(CN)—,
o is 1 or 2,
R²⁰⁴ is hydrogen, C₁-C₁₆-alkyl or C₇-C₁₆-aralkyl or a bridge to A²⁰¹ or Ar²⁰² or E²⁰¹ or Ar²⁰⁵ or E²⁰⁷ or
NR²⁰⁴R²⁰⁴ is pyrrolidino, piperidino or morpholino,
X²⁰¹, X²⁰², X²⁰⁴ and X²⁰⁶ are each, independently of one another, O, S or N—R²⁰⁰ and X²⁰², X²⁰⁴ and X²⁰⁶ may also be CH or CR²⁰⁰R²⁰⁰,
A²⁰¹, B²⁰¹, C²⁰¹ and J²⁰¹ are each, independently of one another, a five- or six-membered aromatic, pseudoaromatic or partially hydrogenated heterocyclic ring which may be benzo- or naphtho-fused and/or substituted by nonionic radicals,
X²⁰³ and X²⁰⁵ are each, independently of one another, N,
R²⁰⁰ is hydrogen, C₁-C₁₆-alkyl or C₇-C₁₆-aralkyl or form a ring to E²⁰², E²⁰³, E²⁰⁵ or E²⁰⁶,
E²⁰² is a direct double bond, ═CH—CH═, ═N—CH═ or ═N—N═,
E²⁰³, E²⁰⁴, E²⁰⁵, E²⁰⁶ and E²⁰⁷ are each, independently of one another, N or C—R²⁰¹, E²⁰³=E²⁰⁴- or -E²⁰⁶=E²⁰⁷- may be a direct bond and two radicals R²⁰¹ may together form a two-, three- or four-membered bridge which may contain heteroatoms and/or be substituted by nonionic radicals and/or be benzo-fused,
R²⁰⁵ and R^{205′} are each hydrogen or together form a —CH═CH—CH═CH— bridge,
R²⁰⁶ is hydrogen, cyano or C₁-C₄-alkyl-SO₂—,
R²⁰⁷ is hydrogen, cyano, C₁-C₄-alkoxycarbonyl or Ar²⁰¹,
R²⁰⁸ is NR²²²R²²³, piperidino, morpholino or pyrrolidino,
R²¹³, R²¹⁸, R²¹⁹, R²²² and R²²³ are each, independently of one another, hydrogen, C₁-C₁₆-alkyl, C₇-C₁₆-aralkyl or C₆-C₁₀-aryl,
X²⁰⁷ is O, S, N—R²²² or C(CH₃)₂,
Y²⁰² and Y²⁰⁴ are each, independently of one another, OR²²², SR²²² or NR²²²R²²³,
Y²⁰³ and Y²⁰⁵ are each, independently of one another, O, S or N⁺R²²²R²²³An⁻,
An⁻ is an anion,
R²⁰⁹ and R²¹⁰ are each, independently of one another, hydrogen, C₁-C₄-alkyl, C₁-C₄-alkoxy, halogen, Y²⁰² or Y²⁰⁴ or together with R²¹⁶ and/or R²¹⁷ form a bridge or two adjacent radicals R²⁰⁹ or R²¹⁰ form a —CH═CH—CH═CH— bridge,
h and i are each, independently of one another, an integer from 0 to 3,
R²¹¹ is hydrogen, C₁-C₄-alkyl or Ar²⁰¹,
Y²¹⁰ and Y²¹¹ are each, independently of one another, O, S or N—CN,
X²⁰⁸ and X²⁰⁹ are each, independently of one another, O, S or N—R²¹³,
R²¹² is hydrogen, halogen, C₁-C₁₆-alkyl, C₇-C₁₆-aralkyl or C₆-C₁₀-aryl,
R²¹⁴ and R²¹⁵ are each, independently of one another, hydrogen, C₁-C₈-alkyl, C₁-C₈-alkoxy, halogen, cyano, nitro or NR²²²R²²³ or two adjacent radicals R²¹⁴ or R²¹⁵ form a —CH═CH—CH═CH— bridge which may in turn be substituted by R²¹⁴ or R²¹⁵, where at least one of the radicals R²¹⁴ or R²¹⁵ is NR²²²R²²³,
j and m are each, independently of one another, an integer from 1 to 4,
D²⁰¹, E²⁰¹, G²⁰¹ and H²⁰¹ are each, independently of one another, a five- or six-membered aromatic or pseudoaromatic carbocyclic ring or an aromatic, pseudoaromatic or partially hydrogenated heterocyclic ring, each of which may be benzo- or naphtho-fused and/or substituted by nonionic radicals or sulpho,
Y²⁰⁶ and Y²⁰⁷ are each, independently of one another, —O—, —NR²²⁴—, —CO—O—, —CO—NR²²⁴—, —SO₂—O— or —SO₂—NR²²⁴—,
Y²⁰⁸, Y²⁰⁹ and Y²¹⁰ are each, independently of one another, N or CH,
Y²¹¹ is O or —NR²²⁴,
R²²⁴ is hydrogen, C₁-C₁₆-alkyl, cyano, C₁-C₁₆-alkoxycarbonyl, C₁-C₁₆-alkanoyl, C₁-C₁₆-alkylsulphonyl, C₆-C₁₀-aryl, C₆-C₁₀-arylcarbonyl or C₆-C₁₀-arylsulphonyl,
M²⁰⁰ and M²⁰¹ are each, independently, of one another, an at least divalent metal ion which may bear further substituents and/or ligands, and M²⁰¹ may also represent two hydrogen atoms,
F²⁰¹ is a five- or six-membered aromatic, pseudoaromatic or partially hydrogenated heterocyclic ring which may contain further heteroatoms and/or be benzo- or naphtho-fused and/or be substituted by nonionic radicals or sulpho,
R²²⁰ and R²²¹ are each, independently of one another, hydrogen, C₁-C₁₆-alkyl, C₁-C₁₆-alkoxy, cyano, C₁-C₁₆-alkoxycarbonyl, halogen, C₆-C₁₀-aryl, NR²²²R²²³ or together form a bivalent radical of the formula 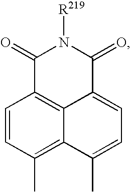
X²¹⁰ is N, CH, C₁-C₆-alkyl, C—Ar²⁰¹, C—Cl or C—N(C₁-C₆-alkyl)₂,
Y²¹² is N—R²⁰⁴, N—Ar²⁰¹, N—N═CH—Ar²⁰¹, CR²⁰²R²⁰³ or CH—C⁻R²⁰²R²⁰³An⁻,
Y²¹³ is NH—R²⁰⁴, NH—Ar²⁰¹, NH—N═CH—Ar²⁰¹, C—R²⁰²R²⁰³An⁻ or CH═CR²⁰²R²⁰³,
   where the linkage to the bridges B and from B¹ to B⁵ is via the radicals R²⁰⁰ to R²²⁴ or via the nonionic radicals by which Ar²⁰¹ to Ar²⁰⁵ and the rings A²⁰¹ to J²⁰¹ may be substituted. In this case, these radicals represent a direct bond.

Nonionic radicals are preferably C₁-C₄-alkyl, C₁-C₄-alkoxy, halogen, cyano, nitro, C₁-C₄-alkoxycarbonyl, C₁-C₄-alkylthio, C₁-C₄-alkanoylamino, benzoylamino, mono- or di-C₁-C₄-alkylamino.

Alkyl, alkoxy, aryl and heterocyclic radicals may bear further radicals such as alkyl, halogen, nitro, cyano, COOH, CO—NH₂, alkoxy, trialkylsilyl, trialkylsiloxy, phenyl or SO₃H, the alkyl and alkoxy radicals can be linear or branched, the alkyl radicals may be partially halogenated or perhalogenated, the alkyl and alkoxy radicals may be ethoxylated or propoxylated or silylated, adjacent alkyl and/or alkoxy radicals on aryl or heterocyclic radicals may together form a three- or four-membered bridge and the heterocyclic radicals may be benzo-fused and/or quaternized.

Particular preference is given to light-absorbent compounds of the formulae (CCI) to (CCXXVI) and (CCIVa),

where

Ar²⁰¹, Ar²⁰², Ar²⁰⁴, Ar²⁰⁵ and Ar²⁰⁶ are each, independently of one another, phenyl, naphthyl, benzothiazol-2-yl, benzoxazol-2-yl, benzimidazol-2-yl, thiazol-2- or -5-yl, thiazolin-2-yl, pyrrolin-2-yl, isothiazol-3-yl, imidazol-2-yl, 1,3,4-thiadiazol-2-yl, 1,3,4-triazol-2-yl, 2- or 4-pyridyl, 2- or 4-quinolyl, pyrrol-2- or -3-yl, thien-2- or -3-yl, furan-2- or -3-yl, indol-2- or -3-yl, benzo-thien-2-yl, benzofuran-2-yl or 3,3-dimethylindolen-2-yl, each of which may be substituted by methyl, ethyl, propyl, butyl, methoxy, ethoxy, propoxy, butoxy, hydroxy, chlorine, bromine, iodine, cyano, nitro, methoxycarbonyl, ethoxycarbonyl, methylthio, acetylamino, propionylamino, butanoylamino, benzoylamino, amino, dimethylamino, diethylamino, dipropylamino, dibutylamino, pyrrolidino, piperidino, morpholino, COOH or SO₃H,
Ar²⁰³ is phenylene, naphthylene, 1,3,4-thiadiazole-2,5-diyl, 1,3,4-oxadiazole-2,5-diyl, 1,3,4-triazole-2,5-diyl or a bifunctional radical of one of the following formulae 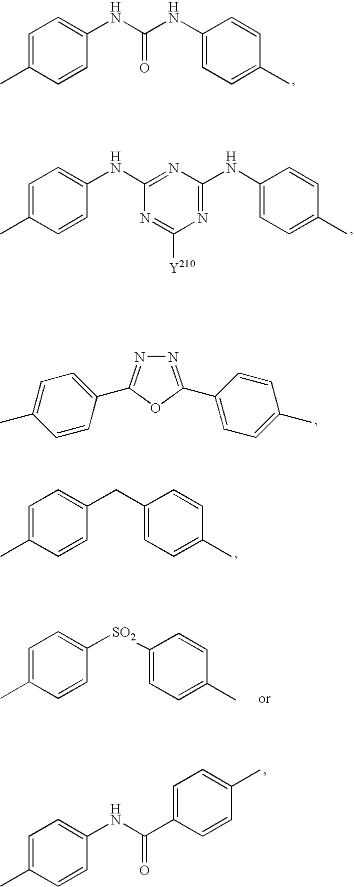
each of which may be substituted by chlorine, bromine, iodine, cyano, nitro, methoxycarbonyl, ethoxycarbonyl, methylthio, acetylamino, propionylamino, butanoylamino, benzoylamino, amino, dimethylamino, diethylamino, dipropylamino, dibutylamino, COOH or SO₃H,
Y²¹⁰ is Cl, OH, NHR²⁰⁰ or NR²⁰⁰₂,
Y²⁰¹ is N or C—R²⁰¹,
R²⁰¹ is hydrogen, methyl, ethyl, propyl, butyl, cyano, carboxyl, methoxycarbonyl, ethoxycarbonyl, acetyl, propionyl or Ar²⁰²,
R²⁰² and R²⁰³ are each, independently of one another, cyano, carboxyl, methoxycarbonyl, ethoxycarbonyl, propoxycarbonyl, butoxycarbonyl, methoxyethoxycarbonyl, acetyl, propionyl or butanoyl, or R²⁰² is hydrogen or a radical of the formula 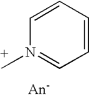
or R²⁰³ is Ar²⁰², or R²⁰²; R²⁰³ together with the carbon atom connecting them form a ring of the formula 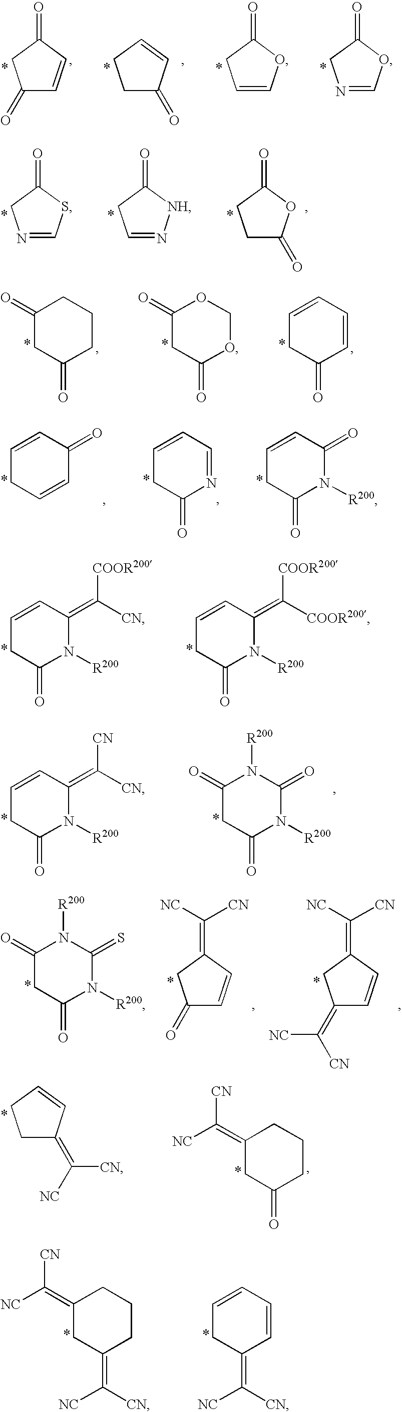 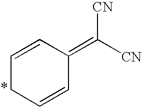
each of which may be benzo- or naphtho-fused and/or substituted by nonionic or ionic radicals, where the asterisk (*) indicates the ring atom from which the double bond extends,
E²⁰¹ is a direct bond or —CH═CH—,
R²⁰⁴ is hydrogen, methyl, ethyl, propyl, butyl, benzyl or
Ar²⁰¹—N—R²⁰⁴ or Ar²⁰⁵—N—R²⁰⁴ is a pyrrole, indole or carbazole ring which is bound via N and may be substituted by methyl, ethyl, methoxy, ethoxy, propoxy, chlorine, bromine, iodine, cyano, nitro or methoxycarbonyl, or
NR²⁰⁴R²⁰⁴ is pyrrolidino, piperidino or morpholino,
A²⁰¹ is benzothiazol-2-ylidene, benzoxazol-2-ylidene, benzimidazol-2-ylidene, thiazol-2-ylidene, thiazolin-2-ylidene, pyrrolin-2-ylidene, isothiazol-3-ylidene, imidazol-2-ylidene, 1,3,4-thiadiazol-2-ylidene, 1,3,4-triazol-2-ylidene, pyridin-2- or -4-ylidene, quinolin-2- or -4-ylidene, pyrrol-2- or -3-ylidene, thien-2- or -3-ylidene, furan-2- or -3-ylidene, indol-2- or -3-ylidene, benzothien-2-ylidene, benzofuran-2-ylidene, 1,3-dithiol-2-ylidene, benzo-1,3-dithiol-2-ylidene or 3,3-dimethylindolen-2-ylidene, each of which may be substituted by methyl, ethyl, propyl, butyl, methoxy, ethoxy, propoxy, butoxy, chlorine, bromine, iodine, cyano, nitro, methoxycarbonyl, ethoxycarbonyl, methylthio, acetylamino, propionylamino, butanoylamino, benzoylamino, dimethylamino, diethylamino, dipropylamino, dibutylamino, methylbenzylamino, methylphenylamino, pyrrolidino or morpholino,
B²⁰¹ is benzothiazol-2-yl, benzoxazol-2-yl, benzimidazol-2-yl, thiazol-2-yl, thiazolin-2-yl, pyrrolin-2-yl, isothiazol-3-yl, imidazol-2-yl, 1,3,4-thiadiazol-2-yl, 1,3,4-triazol-2-yl, 2- or 4-pyridyl, 2- or 4-quinolyl, indol-3-yl or 3,3-dimethylindolen-2-yl, each of which may be substituted by methyl, ethyl, propyl, butyl, methoxy, ethoxy, propoxy, butoxy, chlorine, bromine, iodine, cyano, nitro, methoxycarbonyl, ethoxycarbonyl, methylthio, acetylamino, propionylamino, butanoylamino, benzoylamino, dimethylamino, diethylamino, dipropylamino, dibutylamino, methylbenzylamino, methylphenylamino, pyrrolidino or morpholino,
C²⁰¹ is benzothiazol-2-ylidene, benzoxazol-2-ylidene, benzimidazol-2-ylidene, thiazol-2-ylidene, thiazol-5-ylidene, thiazolin-2-ylidene, pyrrolin-2-ylidene, isothiazol-3-ylidene, imidazol-2-ylidene, 1,3,4-thiadiazol-2-ylidene, 1,3,4-triazol-2-ylidene, pyridin-2- or -4-ylidene, quinolin-2- or -4-ylidene, indol-3-ylidene or 3,3-dimethylindolen-2-ylidene, each of which may be substituted by methyl, ethyl, propyl, butyl, methoxy, ethoxy, propoxy, butoxy, chlorine, bromine, iodine, cyano, nitro, methoxycarbonyl, ethoxycarbonyl, methylthio, acetylamino, propionylamino, butanoylamino, benzoylamino, dimethylamino, diethylamino, dipropylamino, dibutylamino, methylbenzylamino, methylphenylamino, pyrrolidino, piperidino or morpholino, where
   X²⁰¹, X²⁰², X²⁰⁴ and X²⁰⁶ are each, independently of one another, O, S or N—R²⁰⁰ and X²⁰², X²⁰⁴ and X²⁰⁶ may also be CR²⁰⁰R²⁰⁰,
   X²⁰³ and X²⁰⁵ are each, independently of one another, N, and An⁻ is an anion,
R²⁰⁰ is hydrogen, methyl, ethyl, propyl, butyl or benzyl,
R^{200′} is methyl, ethyl, propyl, butyl or benzyl,
E²⁰² is ═CH—CH═, ═N—CH═ or ═N—N═,
-E²⁰³=E²⁰⁴-E²⁰⁵= is —CR^{201′}═CR^{201′}—CR^{201′}═, —N═N—N═, —N═CR^{201′}—CR^{201′}═, —CR^{201′}═N—CR^{201′}═, —CR^{201′}═CR^{201′}—N═, —N═N—CR^{201′}═ or —CR^{201′}═N—N═,
E²⁰⁶=E²⁰⁷ is CR^{201′}═CR^{201′}, N═N, N═CR^{201′}, CR^{201′}═N or a direct bond,
R^{201′} is hydrogen, methyl or cyano, or two radicals R^{201′} form a —CH₂—CH₂—, —CH₂—CH₂—CH₂— or —CH═CH—CH═CH— bridge,
R²⁰⁵ and R^{205′} are each hydrogen or together form a —CH═CH—CH═CH— bridge,
R²⁰⁶ is cyano or methyl-SO₂—,
R²⁰⁷ is hydrogen, cyano, C₁-C₄-alkoxycarbonyl or Ar²⁰¹,
R²⁰⁸ is NR²²²R²²³, piperidino, morpholino or pyrrolidino,
R²¹³, R²¹⁸, R²¹⁹, R²²² and R²²³ are each, independently of one another, hydrogen, methyl, ethyl, propyl, butyl, pentyl, hexyl, benzyl, phenethyl, phenylpropyl or phenyl, each of which may be substituted by methyl, ethyl, propyl, butyl, methoxy, ethoxy, propoxy, butoxy, chlorine, bromine, iodine, cyano, nitro, methoxycarbonyl, ethoxycarbonyl, methylthio, acetylamino, propionylamino, butanoylamino, benzoylamino, COOH or SO₃H,
X²⁰⁷ is O, S or N—R²²²,
Y²⁰² and Y²⁰⁴ are each, independently of one another, NR²²²R²²³,
Y²⁰³ and Y²⁰⁵ are each, independently of one another, O or N⁺R²²²R²²³An⁻,
R²⁰⁹ and R²¹⁰ are each independently of one another, hydrogen, methyl, ethyl, methoxy, ethoxy, chlorine or bromine, or R²⁰⁹; R²²², R²⁰⁹; R²²³, R²¹⁰; R²²² and/or R²¹⁰; R²²³ form a —CH₂—CH₂— or —CH₂—CH₂—CH₂— bridge, or two adjacent radicals R²⁰⁹ or R²¹⁰ form a —CH═CH—CH═CH— bridge,
a and b are each, independently of one another, an integer from 0 to 3,
R²¹¹ is hydrogen, methyl, ethyl, propyl, butyl, pentyl, hexyl or phenyl, each of which may be substituted by from 1 to 3 radicals selected from among hydroxy, methyl, methoxy, chlorine, bromine, COOH, methoxycarbonyl, ethoxycarbonyl and SO₃H,
Y²¹⁰ and Y²¹¹ are each, independently of one another, O or N—CN,
X²⁰⁸ and X²⁰⁹ are each, independently of one another, O or N—R²¹³,
R²¹² is hydrogen or chlorine,
R²¹⁴ and R²¹⁵ are each, independently of one another, hydrogen, methyl, ethyl, propyl, butyl, methoxy, ethoxy, propoxy, butoxy, chlorine, bromine, cyano, nitro or NR²²²R²²³, or two adjacent radicals R²¹⁴ and R²¹⁵ may form a —CH═CH—CH═CH— bridge, where at least one, preferably two, of the radicals R²¹⁴ or R²¹⁵ is/are NR²²²R²²³,
d and e are each, independently of one another, an integer from 1 to 3,
D²⁰¹ and E²⁰¹ are each, independently of one another, phenyl, naphthyl, pyrrole, indole, pyridine, quinoline, pyrazole or pyrimidine, each of which may be substituted by methyl, ethyl, propyl, butyl, methoxy, ethoxy, propoxy, butoxy, chlorine, bromine, cyano, nitro, hydroxy, NR²²²R²²³, acetylamino, propionylamino or benzoylamino,
Y²⁰⁶ and Y²⁰⁷ are each, independently of one another, —O—, —NR²²⁴—, —CO—O— or —CO—NR²²⁴,
Y²⁰⁸═Y²⁰⁹ is N═N or CH═N,
Y²¹⁰ is N or CH,
R²²⁴ is hydrogen, methyl, formyl, acetyl, propionyl, methylsulphonyl or ethylsulphonyl,
M²⁰⁰ is Cu, Fe, Co, Ni, Mn or Zn,
M²⁰¹ is 2H atoms, Cu^{II}, Co^{II}, Co^{III}, Ni^{II}, Zn, Mg, Cr, Al, Ca, Ba, In, Be, Cd, Pb, Ru, Be, Pd^{II}, Pt^{II}, Al, Fe^{II}, Fe^{III}, Mn^{II}, V^{IV}, Ge, Sn, Ti or Si, where when M²⁰¹ is Co^{III}, Fe^{II}, Fe^{III}, Al, In, Ge, Ti, V^{IV} or Si it bears one or two further substituents or ligands R²²⁵ and/or R²²⁶ which are arranged axially relative to the plane of the porphyrin ring,
R²²⁵ and R²²⁶ are each, independently of one another, methyl, ethyl, phenyl, hydroxy, fluorine, chlorine, bromine, methoxy, ethoxy, phenoxy, tolyloxy, cyano or ═O, F²⁰¹ is pyrrol-2-yl, imidazol-2- or -4-yl, pyrrazol-3- or -5-yl, 1,3,4-triazol-2-yl, thiazol-2- or -4-yl, thiazolin-2-yl, pyrrolin-2-yl, oxazol-2- or -4-yl, isothiazol-3-yl, isoxazol-3-yl, indol-2-yl, benzimidazol-2-yl, benzothiazol-2-yl, benzoxazol-2-yl, benzoisothiazol-3-yl, 1,3,4-thiadiazol-2-yl, 1,2,4-thiadiazol-3- or -5-yl, 1,3,4-oxadiazol-2-yl, pyrid-2-yl, quinol-2-yl, each of which may be substituted by methyl, ethyl, propyl, butyl, methoxy, ethoxy, propoxy, butoxy, chlorine, bromine, iodine, cyano, nitro, methoxycarbonyl, ethoxycarbonyl, methylthio, acetylamino, propionylamino, butanoylamino, benzoylamino, dimethylamino, diethylamino, dipropylamino, diethylamino, dicyclohexylamino, anilino, N-methylanilino, diethanolamino, N-methylethanolamino, pyrrolidino, morpholino or piperidino,
G²⁰¹ is a ring of the formula 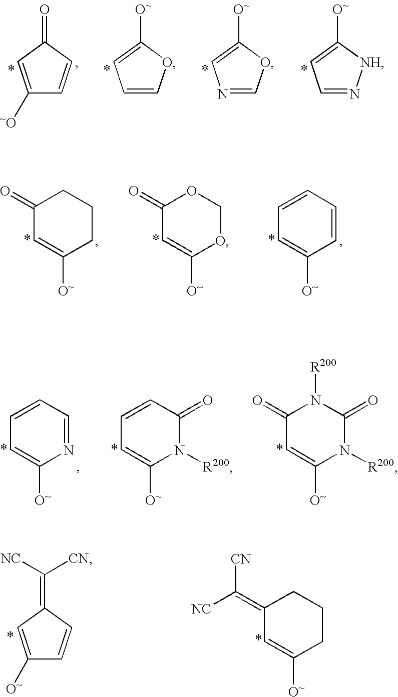
each of which may be benzo- or naphtho-fused and/or substituted by nonionic radicals, where the asterisk (*) indicates the ring atom from which the single bond Y²¹⁰ extends and the squiggle (−) indicates the oxygen atom (═Y²⁰⁶) from which the single bond to M extends and Y²⁰⁶ is —O—,
H²⁰¹ is a ring of the formula 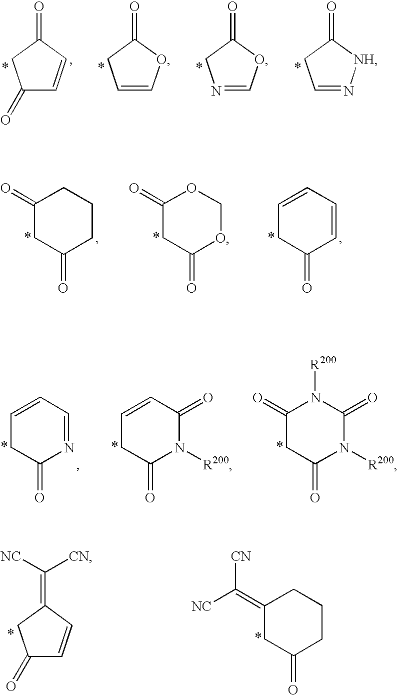
each of which may be benzo- or naphtho-fused and/or substituted by nonionic radicals, where the asterisk (*) indicates the ring atom from which the double bond to Y²¹⁰ extends and
Y²¹¹ is ═O,
E²⁰¹ is a direct bond,
R²⁰⁴ is hydrogen, methyl, ethyl, propyl, butyl, benzyl or
Ar²⁰¹—N—R²⁰⁴ or Ar²⁰⁵—N—R²⁰⁴ is a pyrrole, indole or carbazole ring which is bound via N and may be substituted by methyl, ethyl, methoxy, ethoxy, propoxy, chlorine, bromine, iodine, cyano, nitro or methoxycarbonyl,
R²²⁰ and R²²¹ are each, independently of one another, hydrogen, methoxy, ethoxy, propoxy, butoxy, cyano, methoxycarbonyl, chlorine, bromine, phenyl, dimethylamino, diethylamino, dipropylamino, dibutylamino, anilino or together form a bivalent radical of the formula 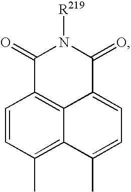
X²¹⁰ is N or CH,
Y²¹² is N—R²⁰⁴, N—Ar²⁰¹ or CR²⁰²R²⁰³,
Y²¹³ is NH—R²⁰⁴, NH—Ar²⁰¹ or C⁻R²⁰²R²⁰³An⁻,
   where the linkage to the bridges B and from B¹ to B⁵ is via the radicals R²⁰⁰ to R²²⁴ or via the nonionic radicals by which Ar²⁰¹ to Ar²⁰⁵ and the rings A²⁰¹ to H²⁰¹ may be substituted. In this case, these radicals represent a direct bond.

The following examples are for the purposes of illustration:

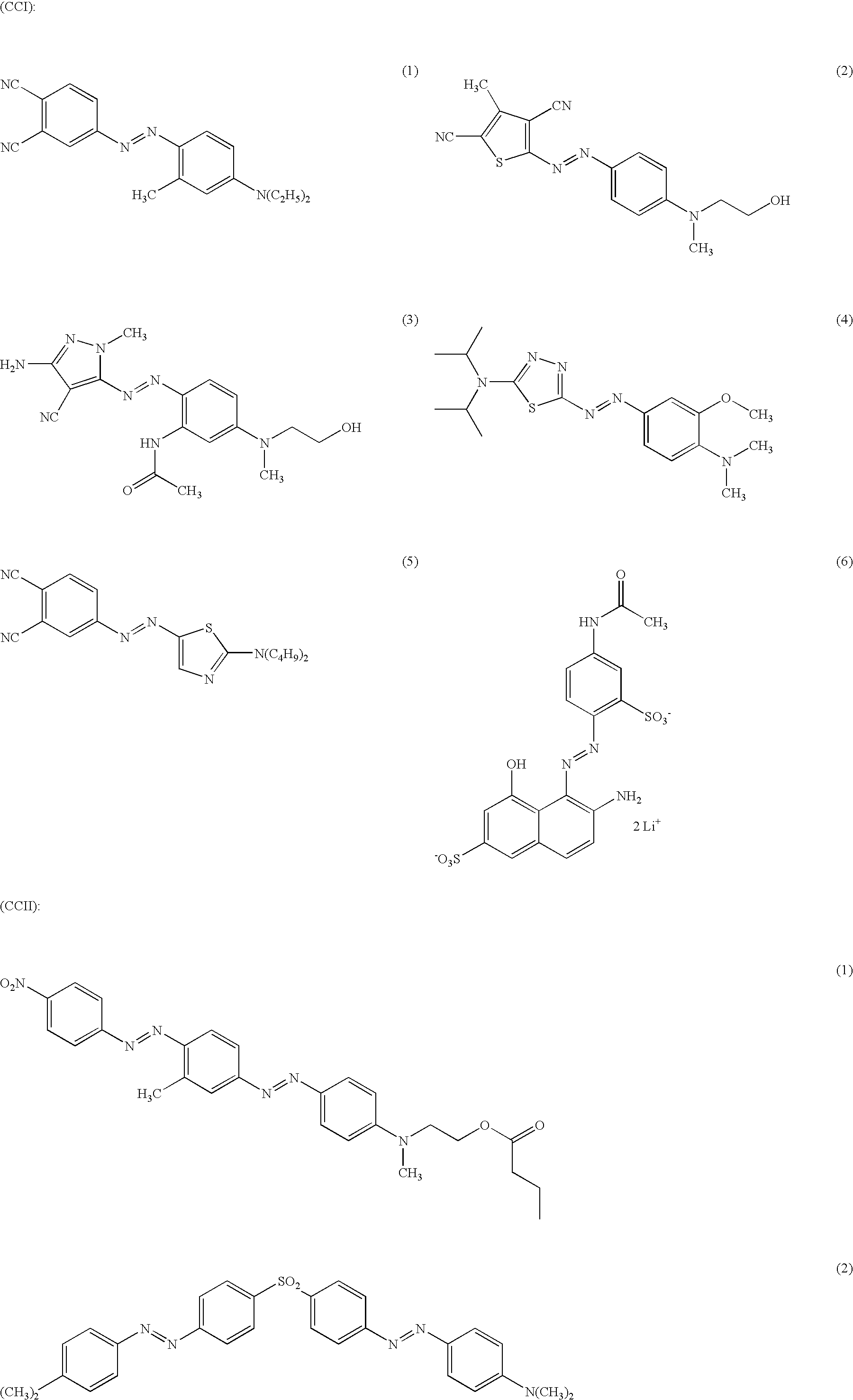

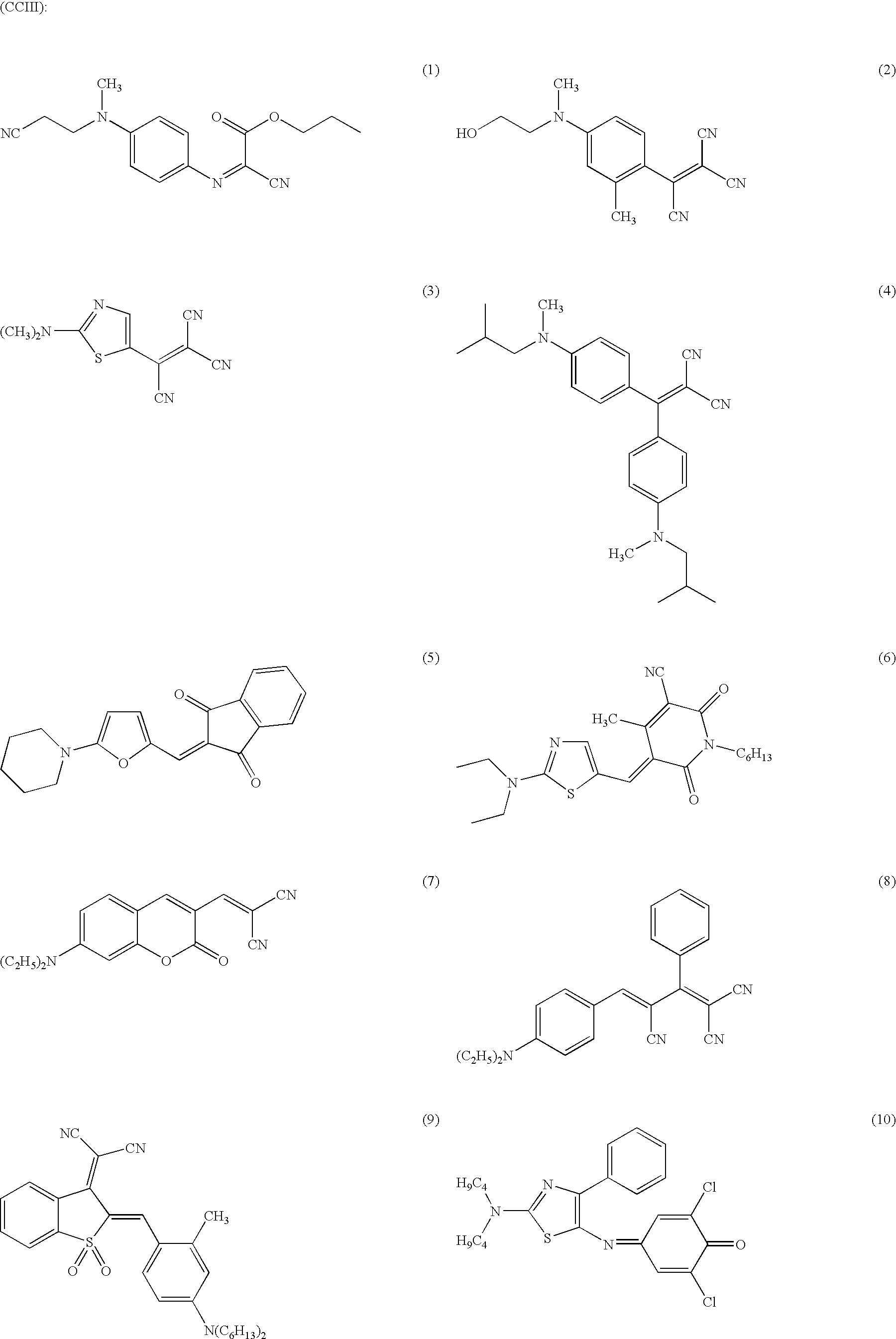

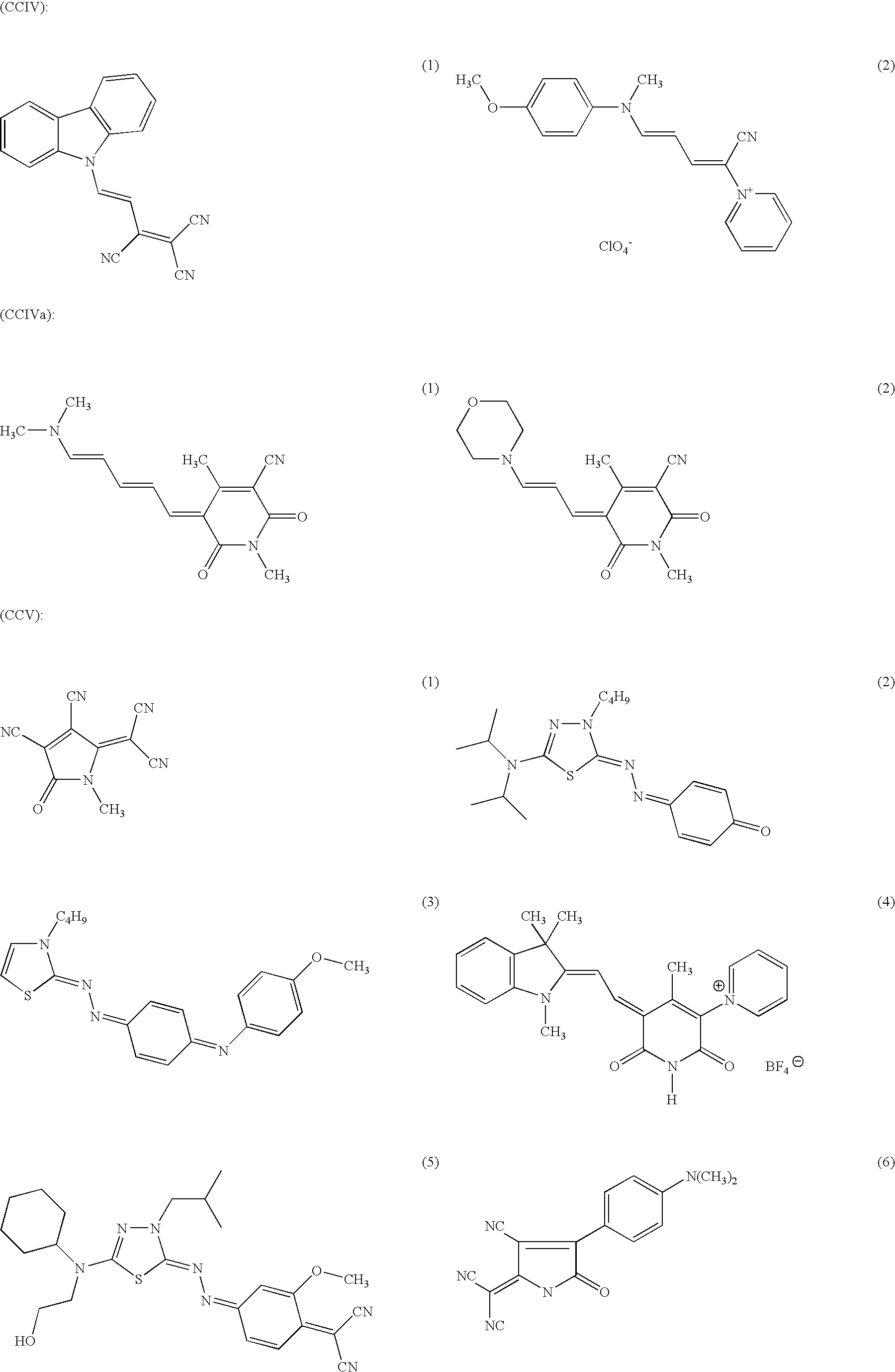

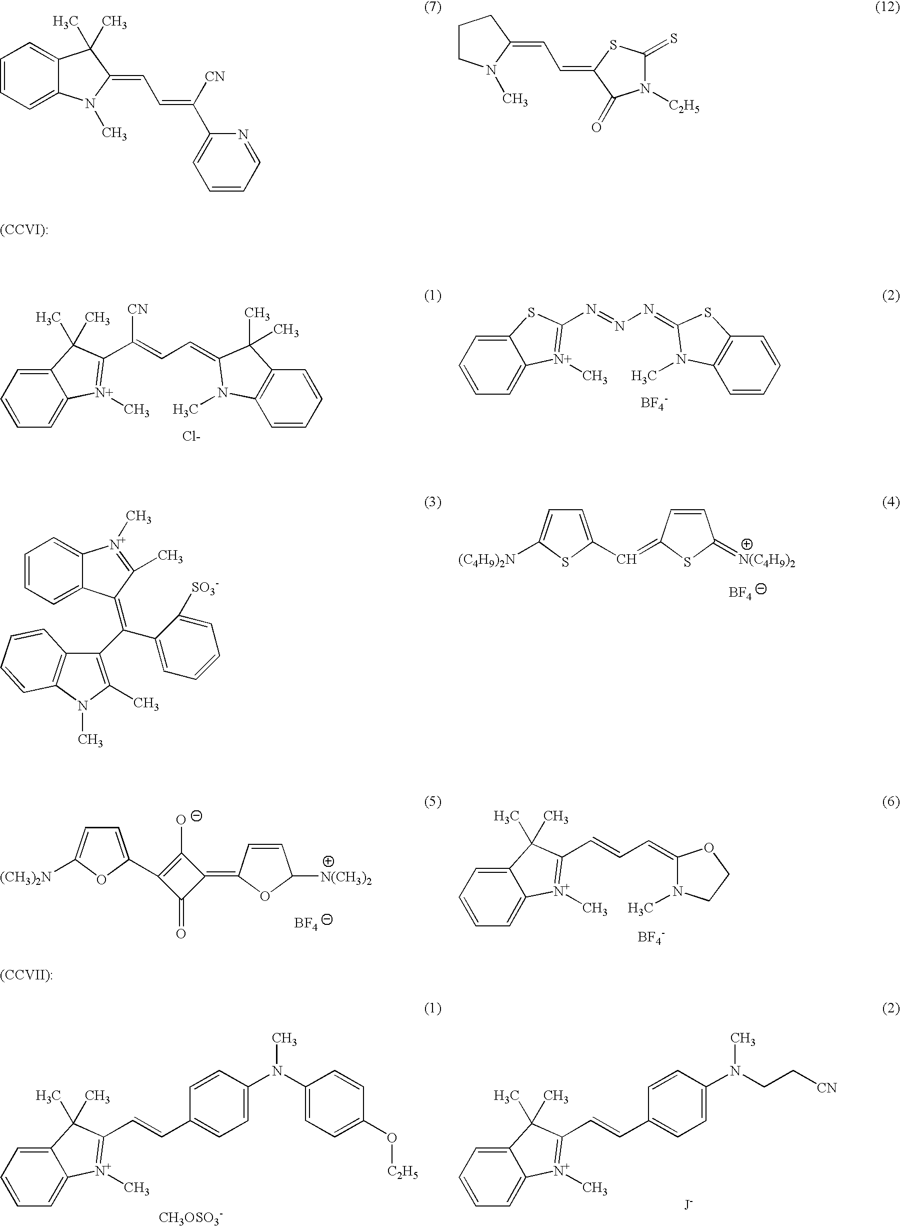

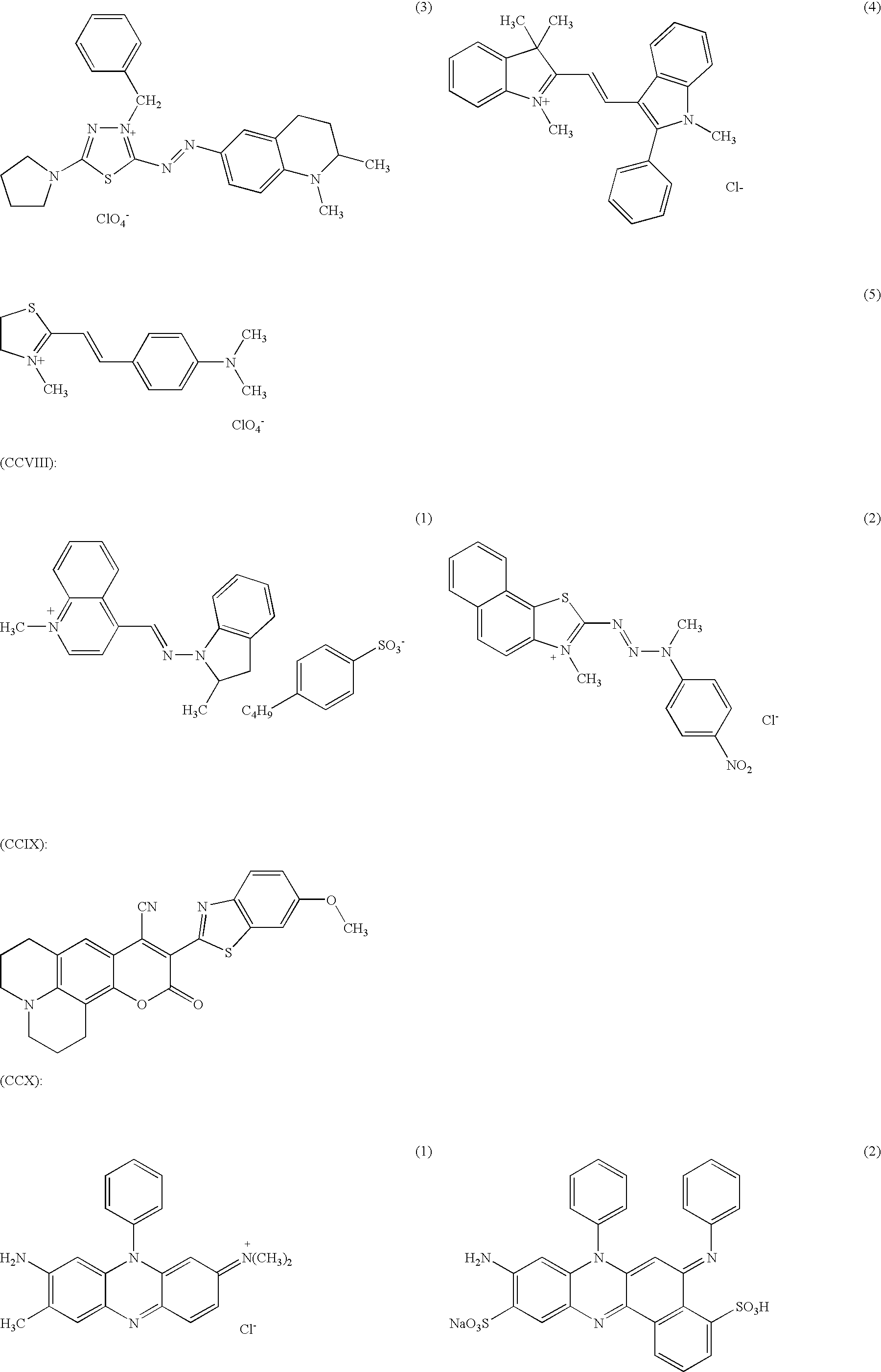

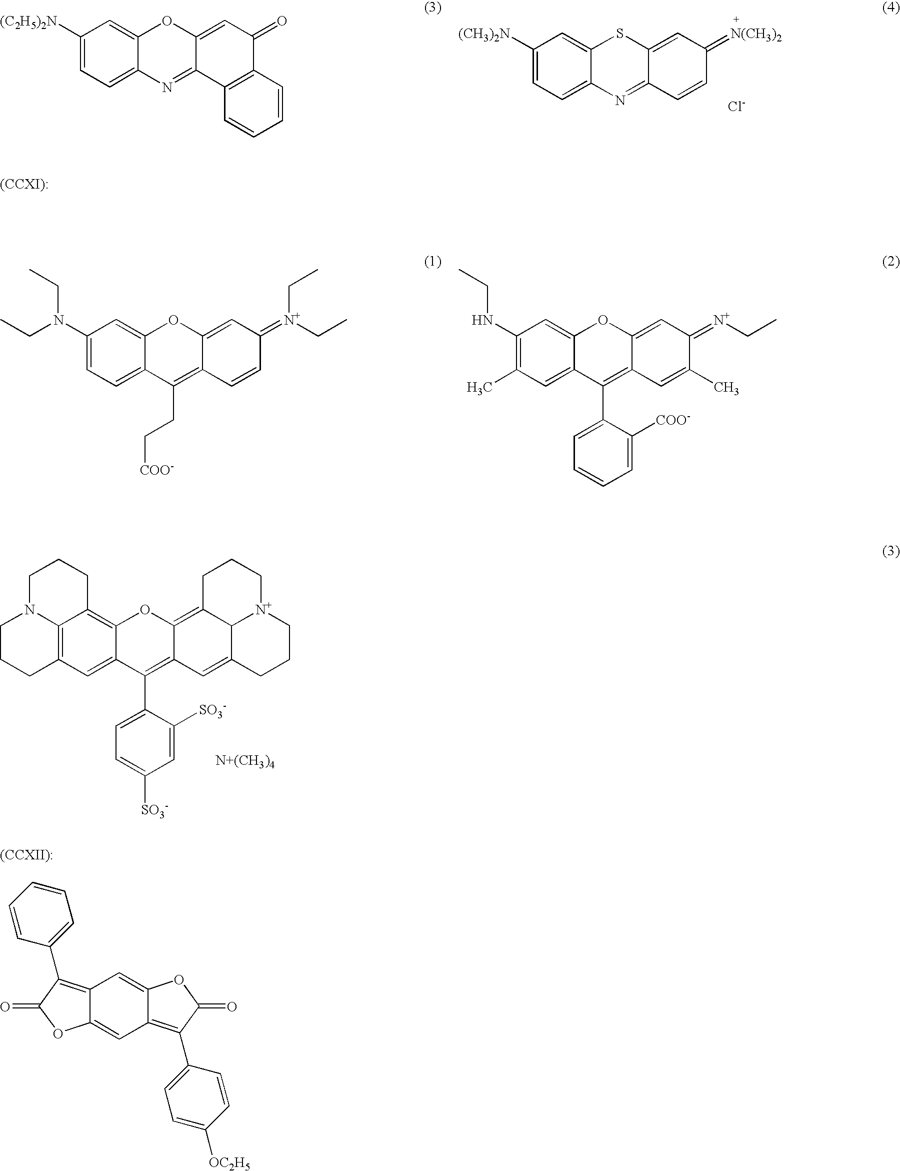

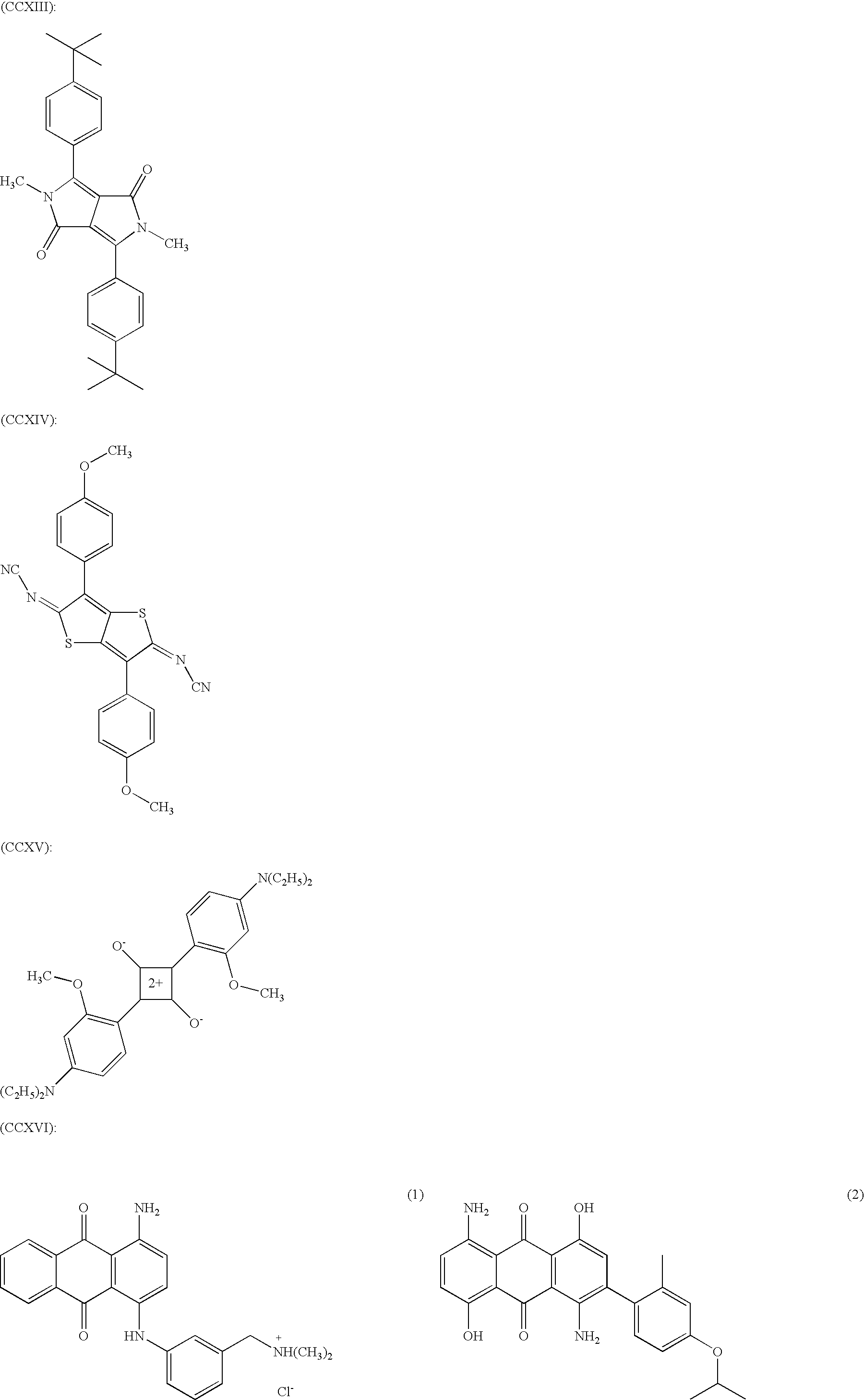

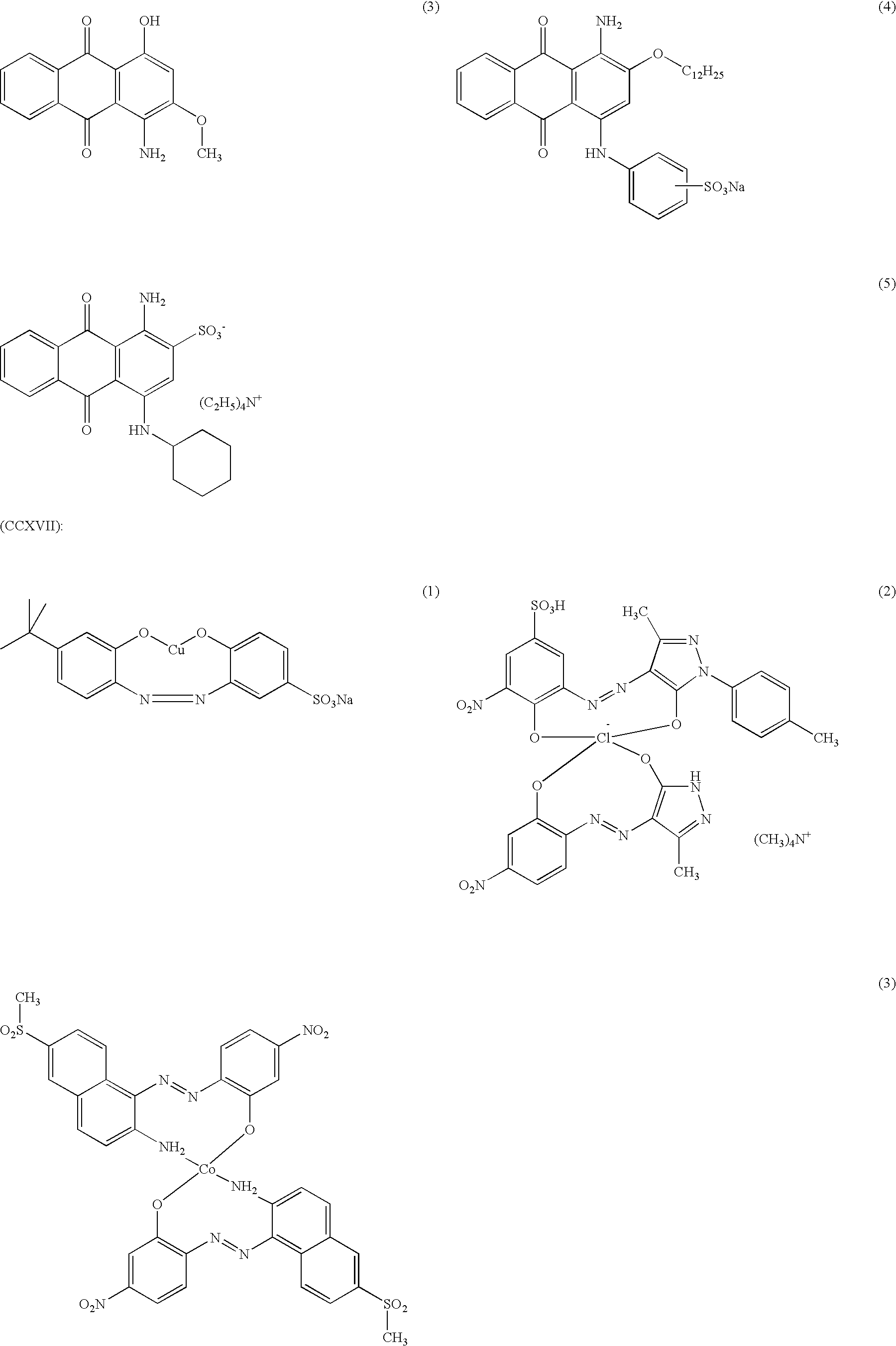

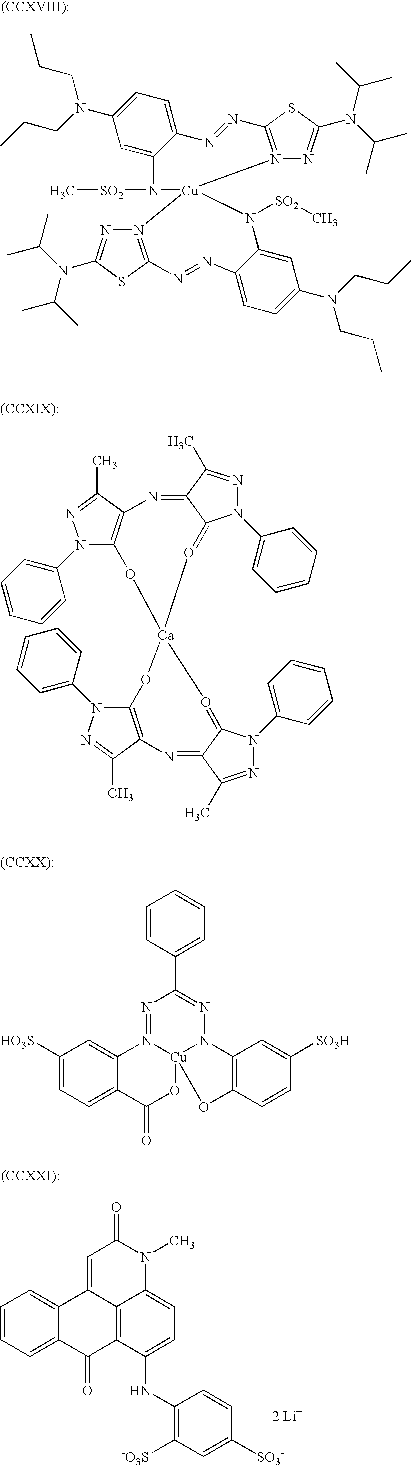

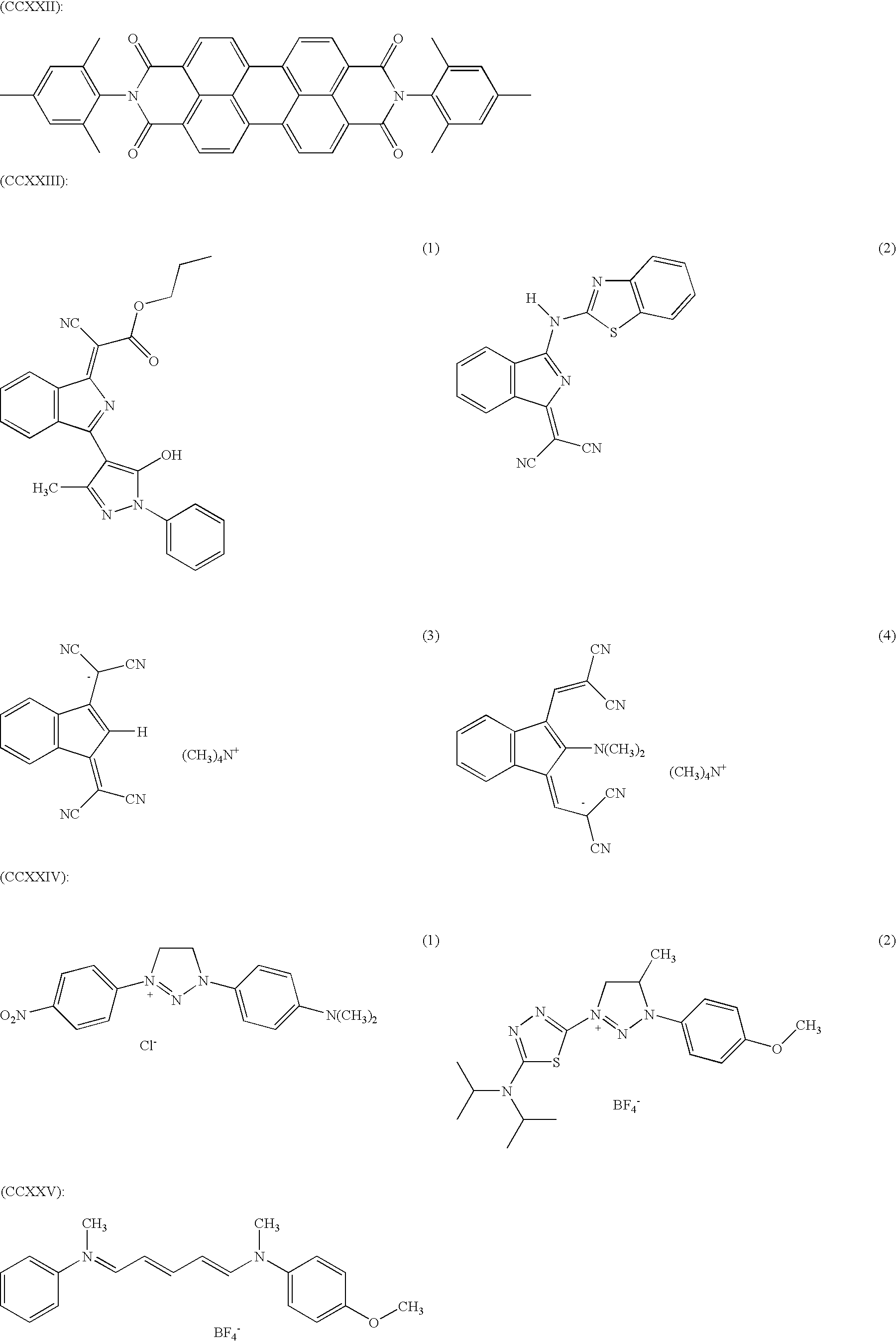

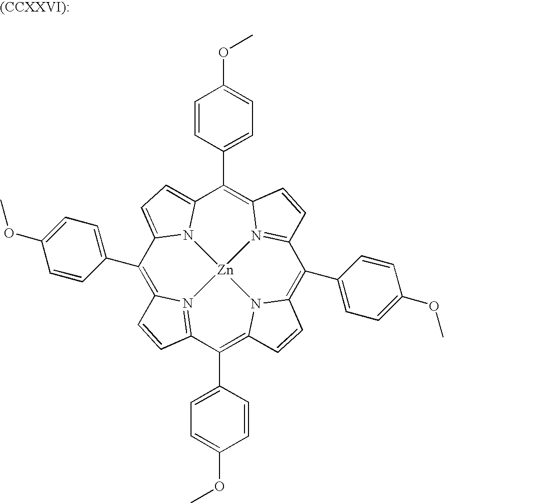

The light-absorbing groups of monomers used for preparing the polymeric networks and thus also the light-absorbing groups of the polymeric network itself are derived from light-absorbent compounds.

Preferred light-absorbent compounds having an absorption maximum λₘₐₓ₃ in the range from 630 to 820 nm (corresponds also to the monomer bearing these groups) are compounds of the following formulae:

Corresponding optical data-stores having polymeric networks based on corresponding monomers containing light-absorbing groups derived from these compounds in the information layer can be read and written on by means of red or infrared light, in particular red or infrared laser light: 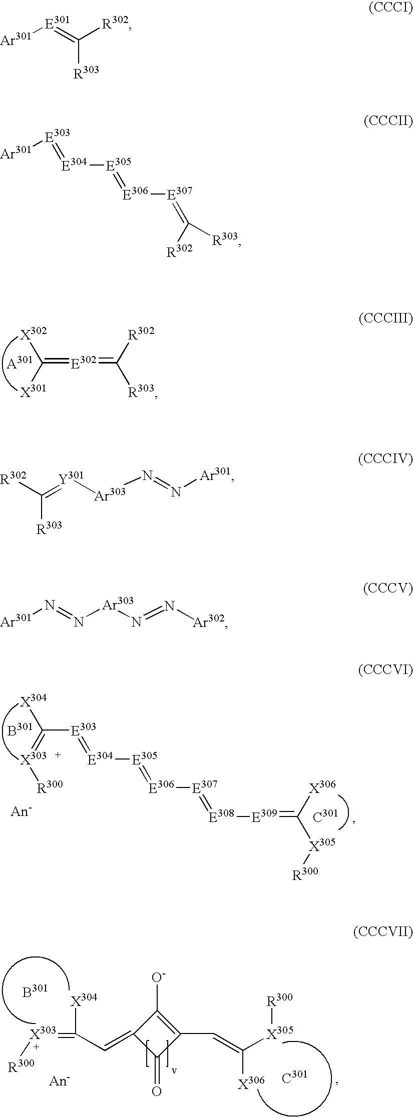 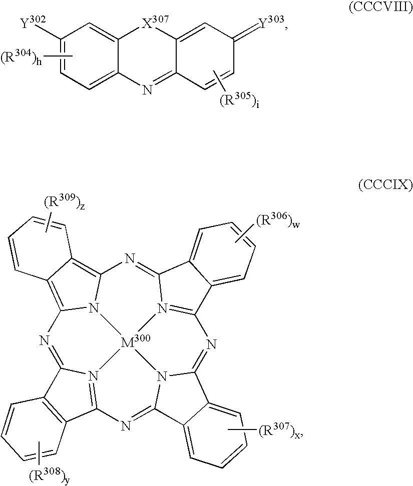
where
Ar³⁰¹ and Ar³⁰² are each, independently of one another, C₆-C₁₀-aryl or the radical of a five- or six-membered aromatic, pseudoaromatic or partially hydrogenated heterocyclic ring which may be benzo- or naphtho-fused and/or substituted by nonionic radicals or sulpho,
Ar³⁰³ is the bifunctional radical of a C₆-C₁₀-aromatic or the bifunctional radical of a five- or six-membered aromatic, pseudoaromatic or partially hydrogenated heterocyclic ring, each of which may be benzo- or naphtho-fused and/or substituted by nonionic radicals or sulpho, where two such bifunctional radicals may be connected via a bifunctional bridge,
E³⁰¹ is N, C—Ar³⁰² or N⁺—Ar³⁰²An⁻,
An⁻ is an anion,
R³⁰² and R³⁰³ are each, independently of one another, cyano, carboxyl, C₁-C₁₆-alkoxycarbonyl, aminocarbonyl or C₁-C₁₆-alkanoyl, or R³⁰³ is Ar³⁰² or R³⁰²; R³⁰³ together with the carbon atom connecting them form a five- or six-membered carbocyclic or aromatic, pseudoaromatic or partially hydrogenated heterocyclic ring which may be benzo- or naphtho-fused and/or substituted by nonionic or ionic radicals,
E³⁰³ to E³⁰⁹ are each, independently of one another, C—R³¹⁰ or N, where the radicals R³¹⁰ of two elements E³⁰³ to E³⁰⁹ may together form a 2- to 4-membered bridge which may contain heteroatoms and/or be substituted by nonionic radicals and/or be benzo-fused, and E³⁰⁵-E³⁰⁶ and/or E³⁰⁷-E³⁰⁸ may be a direct bond,
R³¹⁰ is hydrogen, C₁-C₁₆-alkyl, cyano, carboxyl, C₁-C₁₆-alkoxycarbonyl, C₁-C₁₆-alkanoyl, Ar³⁰², —CH═CH—Ar³⁰², —(CH═CH)₂—Ar³⁰² or a radical of the formula 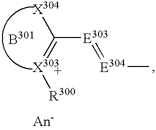
X³⁰¹, X³⁰², X³⁰⁴ and X³⁰⁶ are each, independently of one another, O, S or N—R³⁰⁰ and X³⁰², X³⁰⁴ and X³⁰⁶ may also be CR³⁰⁰R³⁰⁰,
A³⁰¹, B³⁰¹ and C³⁰¹ are each, independently of one another, a five- or six-membered aromatic, pseudoaromatic or partially hydrogenated heterocyclic ring which may be benzo- or naphtho-fused and/or substituted by nonionic radicals,
X³⁰³ and X³⁰⁵ are each, independently of one another N, or (X³⁰³)⁺—R³⁰⁰ is O⁺ or S⁺ and/or X³⁰⁵—R³⁰⁰ is O or S,
R³⁰⁰ is hydrogen, C₁-C₁₆-alkyl or C₇-C₁₆-aralkyl or forms a ring to E³⁰², E³⁰³ or 307,
E³⁰² is ═CH═CH—, ═N—CH═, ═N—N═ or a bivalent radical of the formula 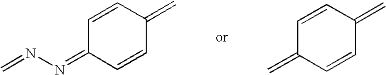
   where the six-membered ring may be substituted by nonionic radicals and/or be benzo-fused,
Y³⁰¹ is N or C—R³⁰¹,
R³⁰¹ is hydrogen, C₁-C₁₆-alkyl, cyano, carboxyl, C₁-C₁₆-alkoxycarbonyl, C₁-C₁₆-alkanoyl or Ar³⁰² or is a bridge to R³⁰² or Ar³⁰³,
v is 1 or 2,
X³⁰⁷ is O, S or N—R³¹¹,
R³¹¹ and R³¹² are each, independently of one another, hydrogen, C₁-C₁₆-alkyl, C₇-C₁₆-aralkyl or C₆-C₁₀-aryl,
Y³⁰² is NR³¹¹R³¹²,
Y³⁰³ is CR³⁰²R³⁰³,
R³⁰⁴ and R³⁰⁵ are each, independently of one another, hydrogen, C₁-C₁₆-alkyl, C₁-C₁₆-alkoxy, C₆-C₁₀-aryloxy or two adjacent radicals R³⁰⁴ or R³⁰⁵ form a —CH═CH—CH═CH— bridge,
h and i are each, independently of one another, an integer from 0 to 3,
M³⁰⁰ is 2H atoms or an at least divalent metal or nonmetal, where M may bear further, preferably 2, substituents or ligands R³¹³ and/or R³¹⁴,
R³⁰⁶ to R³⁰⁹ are each, independently of one another, C₁-C₁₆-alkyl, C₁-C₁₆-alkoxy, C₁-C₁₆-alkylthio, C₆-C₁₀-aryloxy, halogen, COOH, —CO—OR³¹¹, —CO—NR³¹¹R³¹², —SO₃H, —SO₂—NR³¹¹R³¹², or two adjacent radicals R³⁰⁶, R³⁰⁷, R³⁰⁸ or R³⁰⁹ form a —CH═CH—CH═CH— bridge,
w to z are each, independently of one another, an integer from 0 to 4, where when w, x, y or z>1, R³⁰⁶, R³⁰⁷, R³⁰⁸ or R³⁰⁹ may have different meanings,
R³¹³ and R³¹⁴ are each, independently of one another, C₁-C₁₆-alkoxy, C₆-C₁₀-aryloxy, hydroxy, halogen, cyano, thiocyanato, C₁-C₁₂-alkylisonitrilo, C₆-C₁₀-aryl, C₁-C₁₆-alkyl, C₁-C₁₂-alkyl-CO—O—, C₁-C₁₂-alkyl-SO₂—O—, C₆-C₁₀-aryl-CO—O—, C₆-C₁₀-aryl-SO₂—O—, tri-C₁-C₁₂-alkylsiloxy or NR³¹¹R³¹²,
   where the linkage to the bridges B and from B¹ to B⁵ is via the radicals R³⁰⁰ to R³¹⁴ or via the nonionic radicals by which Ar³⁰¹ to Ar³⁰³ and the rings A³⁰¹ to C³⁰¹ may be substituted. In this case, these radicals represent a direct bond.

In the case of the phthalocyanines of the formula (CCCIX), the corresponding monoaza to tetraaza derivatives and their quaternary salts are also encompassed.

Nonionic radicals are, for example, C₁-C₄-alkyl, C₁-C₄-alkoxy, halogen, cyano, nitro, C₁-C₄-alkoxycarbonyl, C₁-C₄-alkylthio, C₁-C₄-alkanoylamino, benzoylamino, mono- or di-C₁-C₄-alkylamino.

Alkyl, alkoxy, aryl and heterocyclic radicals may bear further radicals such as alkyl, halogen, nitro, cyano, COOH, CO—NH₂, alkoxy, trialkylsilyl, trialkylsiloxy, phenyl or SO₃H, the alkyl and alkoxy radicals can be linear or branched, the alkyl radicals may be partially halogenated or perhalogenated, the alkyl and alkoxy radicals may be ethoxylated or propoxylated or silylated, adjacent alkyl and/or alkoxy radicals on aryl or heterocyclic radicals may together form a three- or four-membered bridge and the heterocyclic radicals may be benzo-fused and/or quaternized.

Particular preference is given to light-absorbent compounds of the formulae (CCCI) to (CCCIX),
Ar³⁰¹ and Ar³⁰² are each, independently of one another, phenyl, naphthyl, benzothiazol-2-yl, benzoxazol-2-yl, benzimidazol-2-yl, thiazol-2-yl, isothiazol-3-yl, imidazol-2-yl, 1,3,4-thiadiazol-2-yl, 1,3,4-triazol-2-yl, 2- or 4-pyridyl, 2- or 4-quinolyl, pyrrol-2- or -3-yl, thiophen-2- or -3-yl, furan-2- or -3-yl, indol-2- or -3-yl, benzothien-2-yl, benzofuran-2-yl, 1,2-dithiol-3-yl or 3,3-dimethylindolen-2-yl, each of which may be substituted by methyl, ethyl, propyl, butyl, methoxy, ethoxy, propoxy, butoxy, hydroxy, chlorine, bromine, iodine, cyano, nitro, methoxycarbonyl, ethoxycarbonyl, methylthio, acetylamino, propionylamino, butanoylamino, benzoylamino, amino, dimethylamino, diethylamino, dipropylamino, dibutylamino, pyrrolidino, piperidino, morpholino, COOH or SO₃H, and Ar³⁰¹ may also be a ring of the formula 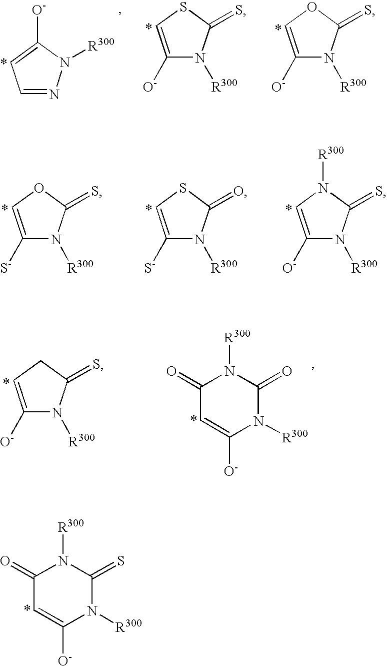
each of which may be benzo- or naphtho-fused and/or substituted by nonionic radicals, where the asterisk (*) indicates the ring atom from which the single bond extends,
Ar³⁰³ is phenylene, naphthylene, thiazole-2,5-diyl, thiophene-2,5-diyl or furan-2,5-diyl, each of which may be substituted by methyl, ethyl, propyl, butyl, methoxy, ethoxy, propoxy, butoxy, hydroxy, chlorine, bromine, iodine, cyano, nitro, methoxycarbonyl, ethoxycarbonyl, methylthio, acetylamino, propionylamino, butanoylamino or benzoylamino,
E³⁰¹ is N, C—Ar³⁰² or N⁺—Ar³⁰²An⁻,
An⁻ is an anion,
R³⁰² and R³⁰³ are each, independently of one another, cyano, carboxyl, methoxycarbonyl, ethoxycarbonyl, propoxycarbonyl, butoxycarbonyl, methoxyethoxycarbonyl, acetyl, propionyl or butanoyl, or R³⁰³ is Ar³⁰² or R³⁰²; R³⁰³ together with the carbon atom connecting them form a ring of the formula 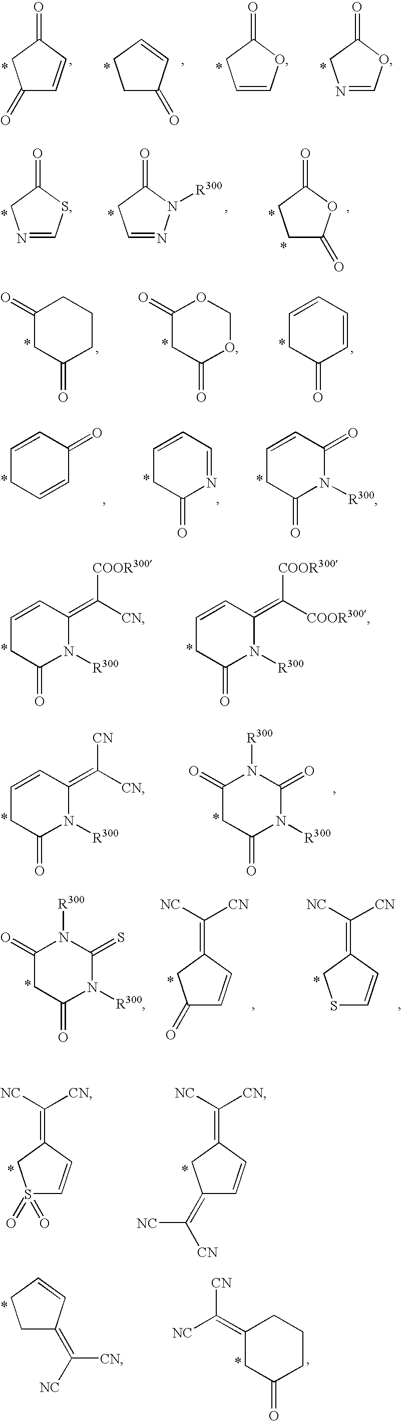 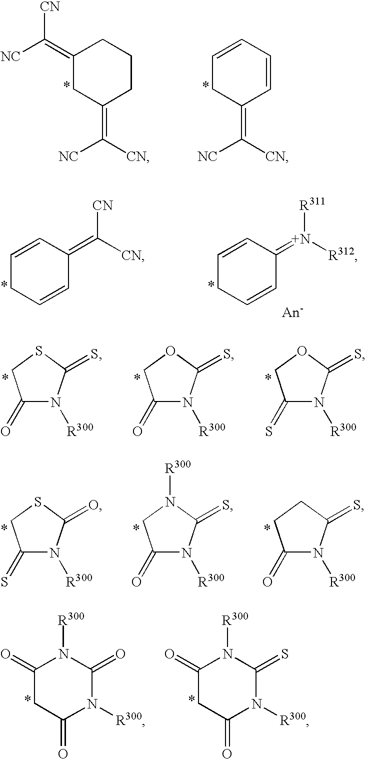
each of which may be benzo- or naphtho-fused and/or substituted by nonionic or ionic radicals, where the asterisk (*) indicates the ring atom from which the double bond extends,
E³⁰³ to E³⁰⁹ are each, independently of one another, C—R³¹⁰ or N, where two adjacent elements E³⁰³ to E³⁰⁹ may form a bivalent group of the formula 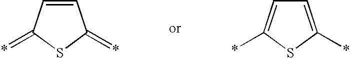
   or three adjacent elements E³⁰³ to E³⁰⁹ may form a bivalent group of the formula 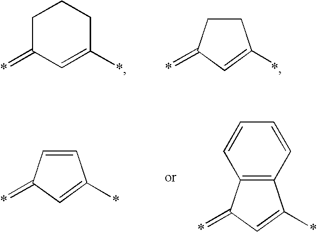
   or five adjacent elements E³⁰³ to E³⁰⁹ may form a bivalent group of the formula 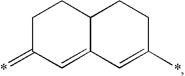
where in each case the asterisked (*) bonds represent single or double bonds to the next element E, to Ar³⁰¹, CR³⁰²R³⁰³ or to a ring B³⁰¹ or C³⁰¹ and the rings may be substituted by methyl, methoxy, chlorine, cyano or phenyl, and E³⁰⁵=E³⁰⁶ and/or E³⁰⁷=E³⁰⁸ may represent a direct bond,
R³¹⁰ is hydrogen, methyl, ethyl, cyano, chlorine, phenyl or a radical of the formula 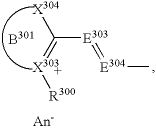
A³⁰¹ is benzothiazol-2-ylidene, benzoxazol-2-ylidene, benzimidazol-2-ylidene, thiazol-2-ylidene, isothiazol-3-ylidene, imidazol-2-ylidene, 1,3,4-thiadiazol-2-ylidene, 1,3,4-triazol-2-ylidene, pyridin-2- or -4-ylidene, quinolin-2- or -4-ylidene, pyrrol-2- or -3-ylidene, thien-2- or -3-ylidene, furan-2- or -3-ylidene, indol-2- or -3-ylidene, benzothien-2-ylidene, benzofuran-2-ylidene, 1,3-dithiol-2-ylidene, benzo-1,3-dithiol-2-ylidene, 1,2-dithiol-3-ylidene or 3,3-dimethylindolen-2-ylidene, each of which may be substituted by methyl, ethyl, propyl, butyl, methoxy, ethoxy, propoxy, butoxy, chlorine, bromine, iodine, cyano, nitro, methoxycarbonyl, ethoxycarbonyl, methylthio, acetylamino, propionylamino, butanoylamino or benzoylamino,
B³⁰¹ is benzothiazol-2-yl, benzoxazol-2-yl, benzimidazol-2-yl, thiazol-2-yl, isothiazol-3-yl, imidazol-2-yl, 1,3,4-thiadiazol-2-yl, 1,3,4-triazol-2-yl, 2- or 4-pyridyl, 2- or 4-quinolyl, pyrrylium-2- or -4-yl, thiopyrrylium-2- or -4-yl, indol-3-yl, benzo[c,d]indol-2-yl or 3,3-dimethylindolen-2-yl, each of which may be substituted by methyl, ethyl, propyl, butyl, methoxy, ethoxy, propoxy, butoxy, chlorine, bromine, iodine, cyano, nitro, methoxycarbonyl, ethoxycarbonyl, methylthio, acetylamino, propionylamino, butanoylamino or benzylamino,
C³⁰¹ is benzothiazol-2-ylidene, benzoxazol-2-ylidene, benzimidazol-2-ylidene, thiazol-2-ylidene, isothiazol-3-ylidene, imidazol-2-ylidene, 1,3,4-thiadiazol-2-ylidene, 1,3,4-triazol-2-ylidene, pyridin-2- or -4-ylidene, quinolin-2- or -4-ylidene, dehydropyran-2- or -4-ylidene, thiopyran-2- or -4-ylidene, indol-3-yl, benzo[c,d]indol-2-ylidene or 3,3-dimethylindolen-2-ylidene, each of which may be substituted by methyl, ethyl, propyl, butyl, methoxy, ethoxy, propoxy, butoxy, chlorine, bromine, iodine, cyano, nitro, methoxycarbonyl, ethoxycarbonyl, methylthio, acetylamino, propionylamino, butanoylamino or benzoylamino, where
   X³⁰¹, X³⁰², X³⁰⁴ and X³⁰⁶ are each, independently of one another, O, S and N—R³⁰⁰ and X³⁰², X³⁰⁴ and X³⁰⁶ may also be CR³⁰⁰R³⁰⁰,
   X³⁰³ and X³⁰⁵ are each, independently of one another, N or (X³⁰³)⁺—R³⁰⁰ is O⁺ or S⁺ and/or X³⁰⁵—R³⁰⁰ is O or S, and
   An⁻ is an anion,
R³⁰⁰ is hydrogen, methyl, ethyl, propyl, butyl or benzyl,
R^{300′} is methyl, ethyl, propyl, butyl or benzyl,
E³⁰² is a bivalent radical of the formula 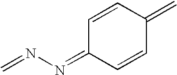
where the six-membered ring may be substituted by methyl, ethyl, methoxy, ethoxy, propoxy, butoxy, acetamino, propionylamino or methylsulphonylamino and/or be benzo-fused,
Y³⁰¹ is N or C—R^{301′},
R³⁰¹ is hydrogen, methyl, ethyl, cyano, carboxyl, methoxycarbonyl, ethoxycarbonyl, acetyl or propionyl,
v is 1 or 2,
X³⁰⁷ is O, S or N—R³¹¹,
R³¹¹ and R³¹² are each, independently of one another, hydrogen, methyl, ethyl, propyl, butyl, pentyl, hexyl, benzyl, phenyl, each of which may be substituted by one or more of the radicals methoxy, ethoxy, propoxy, chlorine, bromine, dimethylamino or diethylamino,
Y³⁰² is NR³¹¹R³¹²,
Y³⁰³ is CR³⁰²R³⁰³,
R³⁰⁴ and R³⁰⁵ are each, independently of one another, hydrogen, methyl, ethyl, propyl, butyl, methoxy, ethoxy or phenoxy or two adjacent radicals R³⁰⁴ or R³⁰⁵ form a —CH═CH—CH═CH— bridge,
M³⁰⁰ is 2H atoms, Cu^{II}, Co^{II}, Co^{III}, Ni^{II}, Zn, Mg, Cr, Ca, Ba, In, Be, Cd, Pb, Ru, Be, Al, Pd^{II}, Pt^{II}, Al, Fe^{II}, Fe^{III}, Mn^{II}, V^{IV}, Ge, Sn, Ti or Si, where when M is Co^{III}, Fe^{II}, Fe^{III}, Al, In, Ge, Ti, V^{IV} or Si it bears one or two further substituents or ligands R³¹³ and/or R³¹⁴ which are arranged axially relative to the plane of the phthalocyanine ring,
R³⁰⁶ to R³⁰⁹ are each, independently of one another, methyl, ethyl, propyl, butyl, pentyl, hexyl, methoxy, ethoxy, propoxy, butoxy, pentoxy, hexoxy, phenoxy, chlorine, bromine, —SO₃H or SO₂NR³¹¹R³¹², or two adjacent radicals R³⁰⁶, R³⁰⁷, R³⁰⁸ or R³⁰⁹ form a —CH═CH—CH═CH— bridge,
w to z are each independently of one another, an integer from 0 to 4, where when w, x, y or z>1, R³⁰⁶, R³⁰⁷, R³⁰⁸ or R³⁰⁹ may have different meanings,
R³¹³ and R³¹⁴ are each, independently of one another, hydroxy, fluorine, chlorine, bromine, cyano, ═O, methoxy, ethoxy, propoxy, butoxy, pentoxy, hexoxy, phenoxy, pyrazolo, imidazolo or NR³¹¹R³¹², each of which may be substituted by one or more of the radicals methoxy, ethoxy, propoxy, chlorine, bromine, dimethylamino or diethylamino,
   where the linkage to the bridges B and from B¹ to B⁵ is via the radicals R³⁰⁰ to R³¹⁴ or via the nonionic radicals by which Ar³⁰¹ to Ar³⁰³ and the rings A³⁰¹ to C³⁰¹ may be substituted. In this case, these radicals represent a direct bond.

The following examples are for illustrative purposes:

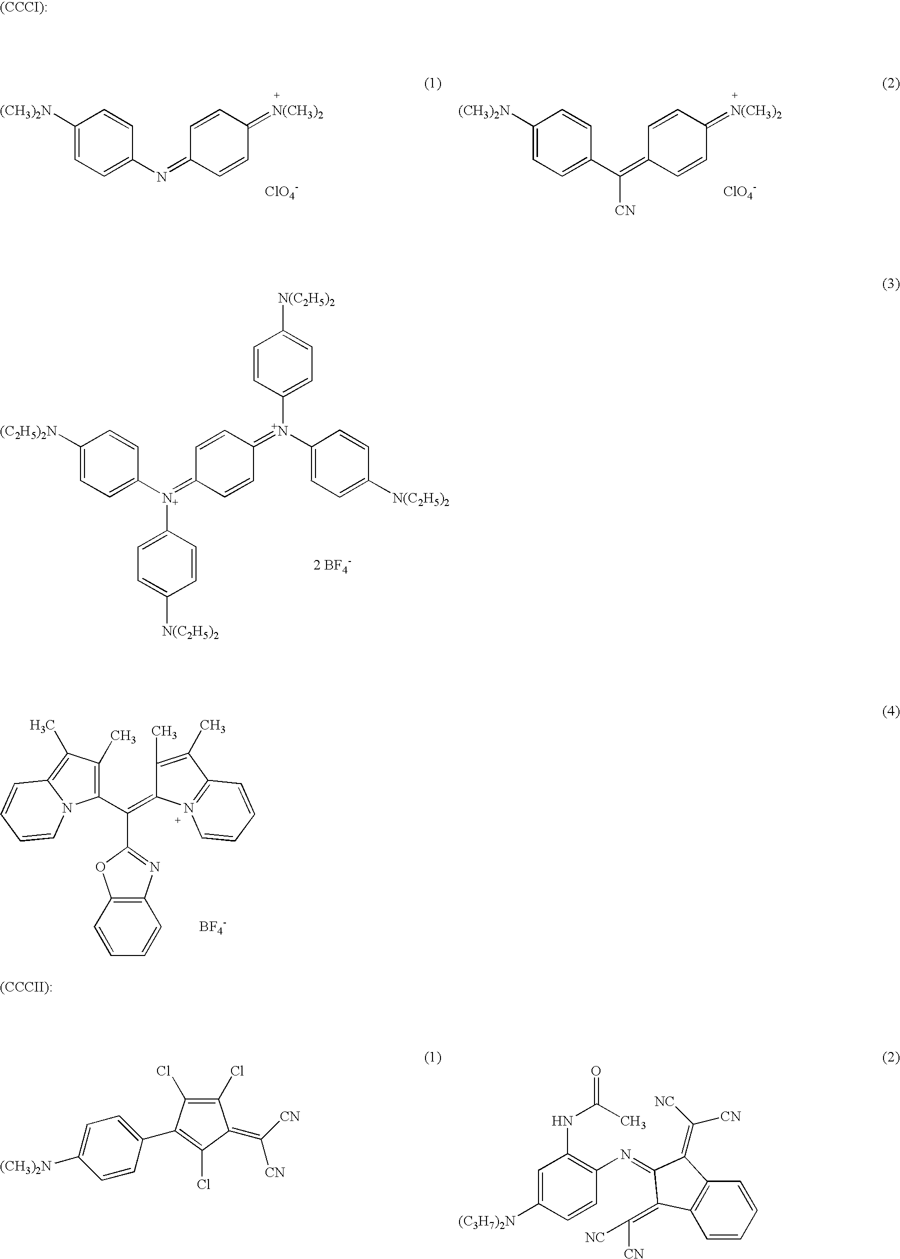

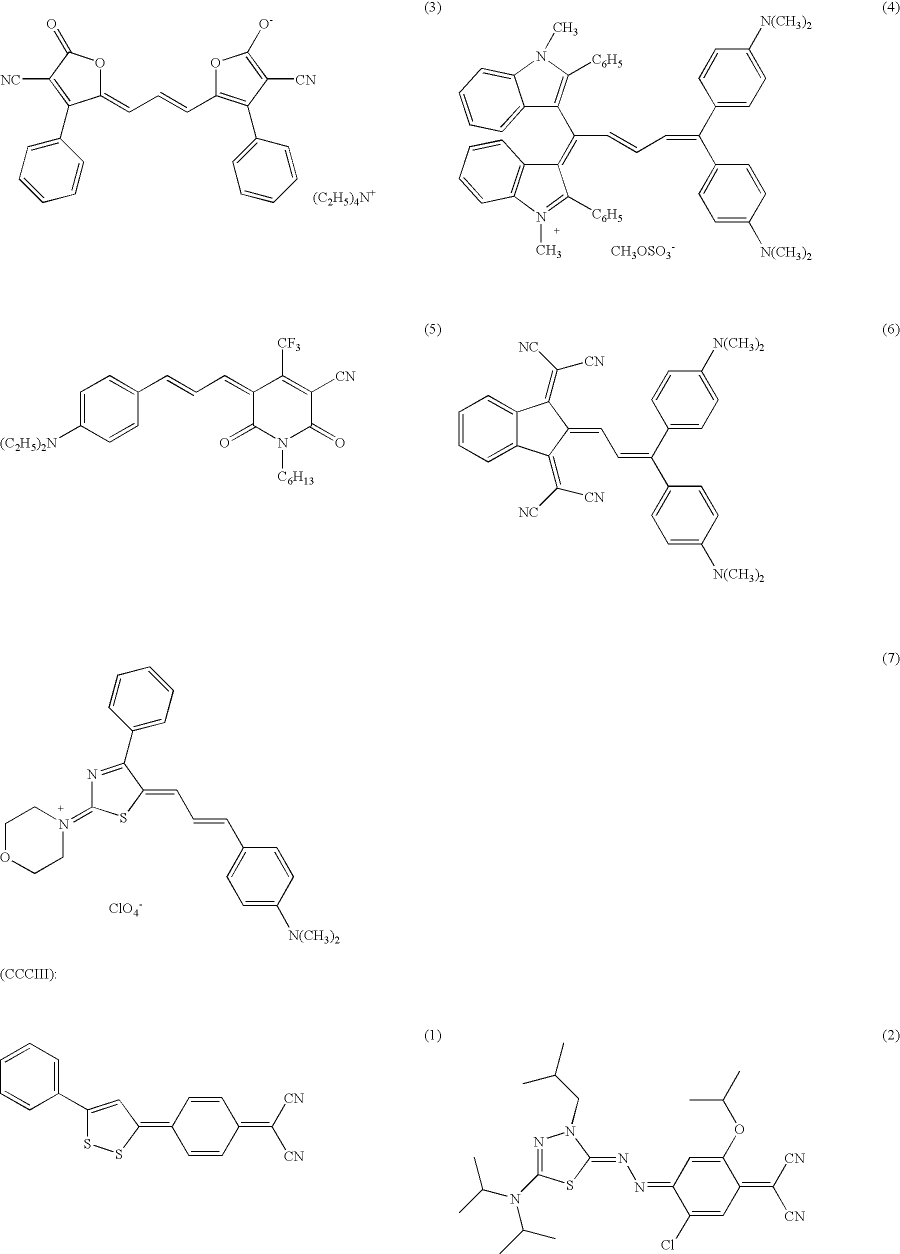

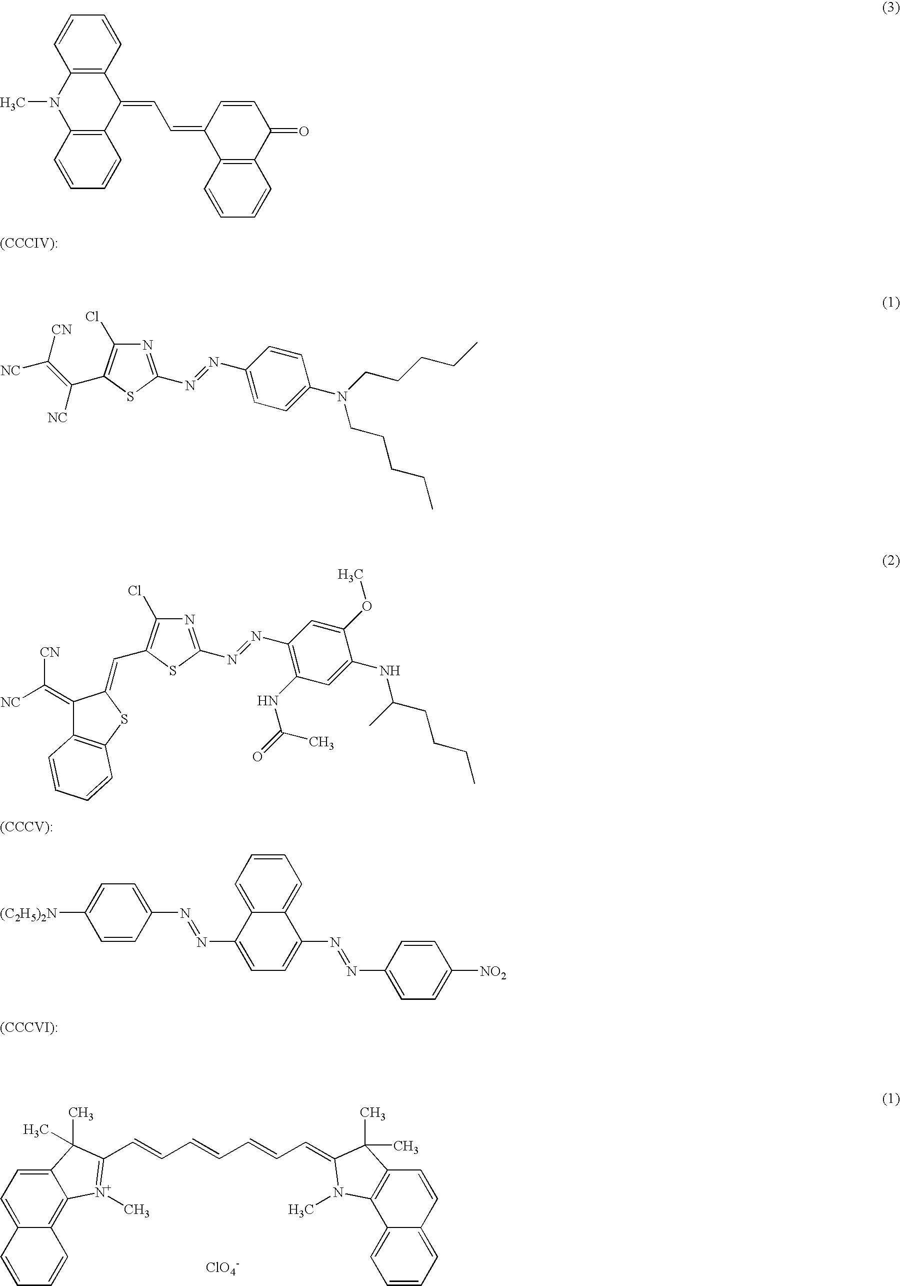

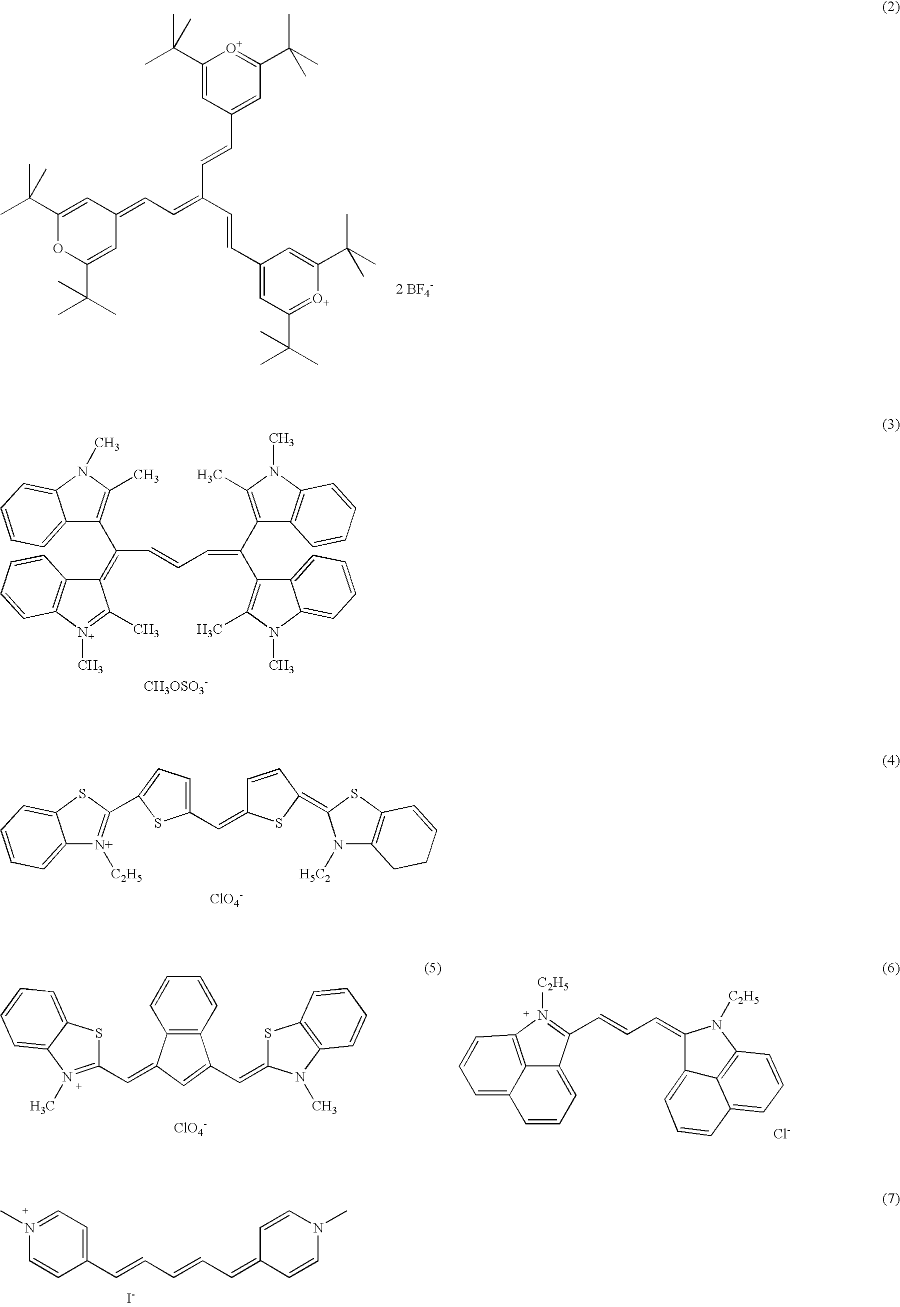

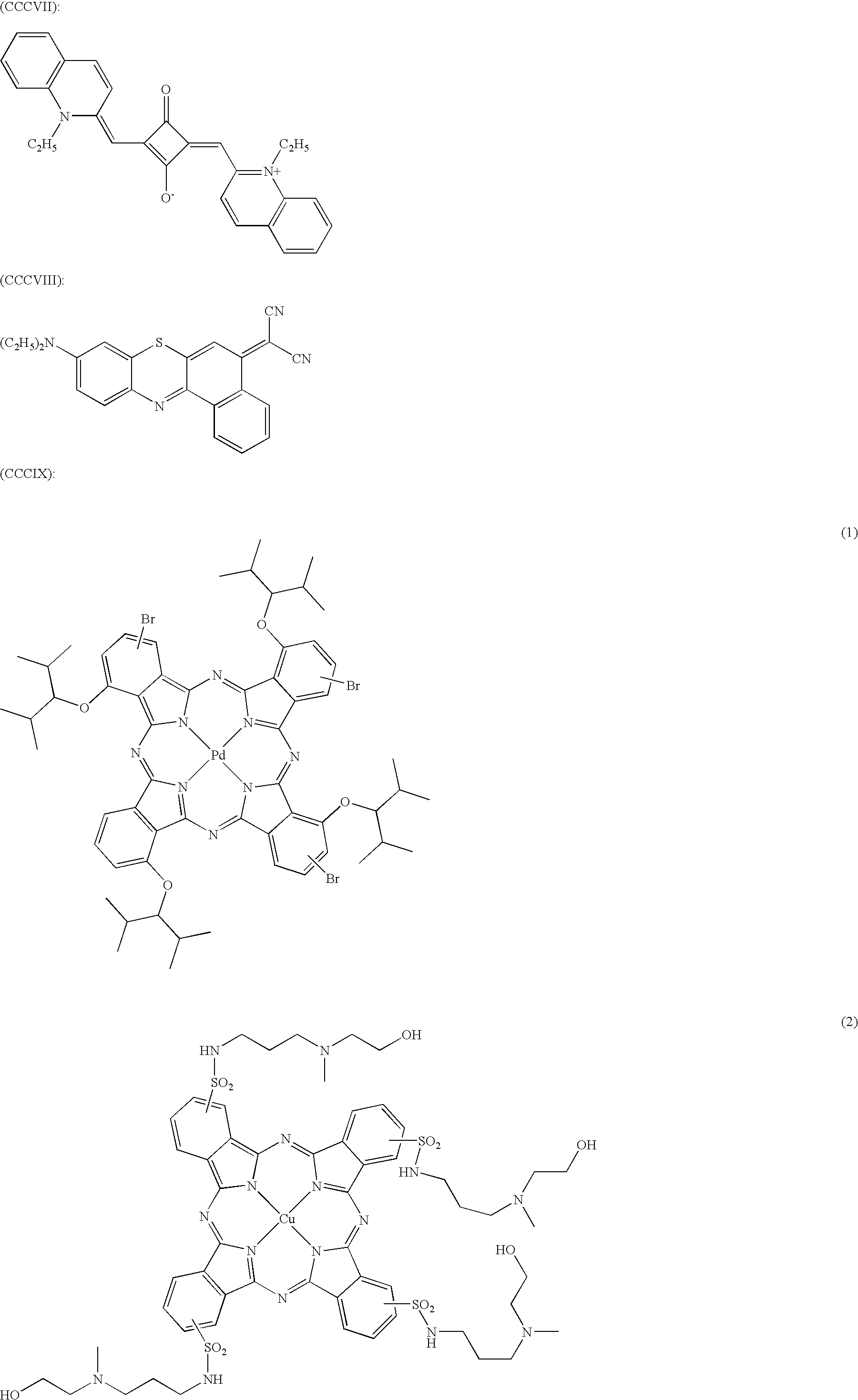

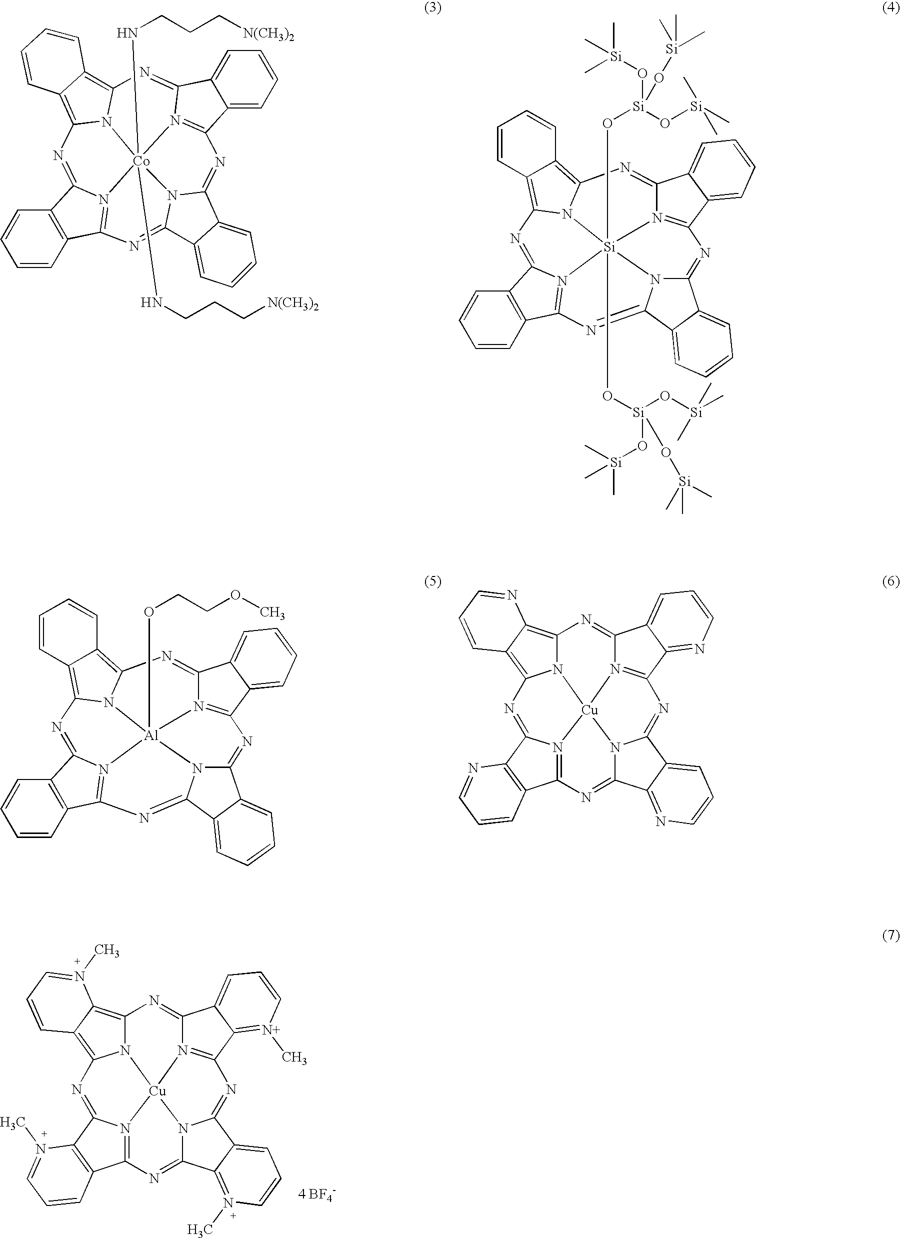

In a preferred embodiment, the monomers used for preparing the polymeric networks according to the invention, for example those of the component A) or B), have at least one functional group K—B of the formula (M1) 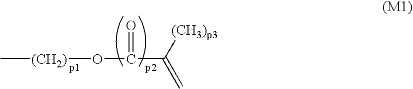
where
p1 is from 1 to 6, in particular 2 or 3,
p2 is 0 or 1 and
p3 is 0 or 1; in particular, (M1) is a radical of the formula 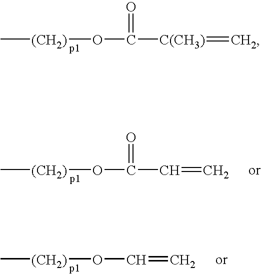
at least one functional group of the formula 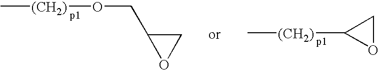
where p1 is as defined above
or
at least two functional groups K—B of the formula (M2) 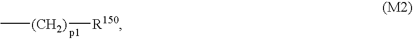
where
p1 is as defined above and
R¹⁵⁰ is 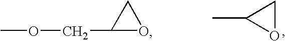
—OH or NH₂,
and at least one light-absorbing group.

Possible light-absorbing groups are, in particular, groups which together with the functional group or groups form a monomer having physical properties, for example absorption maxima, as described at the outset.

The light-absorbing groups are particularly preferably derived from compounds of the class of merocyanine dyes and azo dyes.

Corresponding monomers having at least one functional group of the formula (M1) are likewise subject-matter of the present invention.

The monomers can be prepared by methods known to those skilled in the art.

Monomers such as those of type P (M2) are suitable for polyadditions. Preferred addition partners are polyisocyanates. Particular preference is given to aromatic or aliphatic polyisocyanates.

Suitable polyisocyanated are known per se. They are aliphatic, aromatic and heterocyclic polyisocyanates as described, for example, by W. Sirfken in Justus Liebigs Annalen der Chemie, 562, pages 75 to 136; for example ethylene diisocyanate, tetramethylene 1,4-diisocyanate, hexamethylene 1,6-diisocyanate, dodecamethylene 1,12-diisocyanate, cyclobutane 1,3-diisocyanate, cyclohexane 1,3- and 1,4-diisocyanate, and also any mixtures of these isomers; 1-isocyanato-3,3,5-trimethyl-5-isocyanatomethylcyclohexane (DE-A 1 202 785; U.S. Pat. No. 3,401,190), hexahydrotolylene 2,4- and 2,6-diisocyanate, hexahydrophenylene 1,3- and/or 1,4-diisocyanate, perhydrodiphenylmethane 2,4′- and/or 4,4′-diisocyanate, phenylene 1,3- and 1,4-diisocyanate, tolylene 2,4- and 2,6-diisocyanate, and also any mixtures of these isomers, the isomeric diphenylmethane diisocyanates, tetramethylxylylene diisocyanate. It is possible to use any mixtures of the abovementioned isocyanates.

Preference is given to using 1-isocyanato-3,5,5-trimethyl-5-isocyanatomethylcyclohexane, perhydrodiphenylmethane 4,4′- and/or 2,4′-diisocyanate, the isomeric tolylene diisocyanates and diphenylmethane diisocyanates and hexamethylene diisocyanate.

Furthermore, it is possible to use polyisocyanates which are derived from aliphatic or aromatic diisocyanates by biuret formation, allophanate formation, trimerisation, dimerisation or urethane formation with short-chain polyols having an OH functionality of >2. Such isocyanates can accordingly contain biuret, allophanate, triazinetrione, uretdione and urethane structural elements in addition to the NCO groups. It is also possible to use unsymmetrical trimers.

Examples of such polyisocyanates are: trisurethane derived from 1 mol of trimethylolpropane and 2 mol of tolylene diisocyanate; 1,3,5-tris(6-isocyanatohexyl)triazinetrione; 1,3-bis(6-isocyanatohexyl)diazacyclobutanedione; mixed trimer derived from 2 mol of tolylene diisocyanate and 1 mol of hexamethylene diisocyanate; biuret of hexamethylene diisocyanate; trimer of isophorone diisocyanate; the allophanate obtainable by reacting 3 mol of hexamethylene diisocyanate with one mol of n-butanol; 1,3-bis(6-isocyanatohexyl)-4-(6-isocyanatohexyl)imino-1,3-diaza-5-oxacyclohexane-2,6-dione.

The polyisocyanates can also be used as mixtures.

Preference is given to using corresponding products of the aliphatic type; particular preference is given to allophanates, biurets, trimers and mixtures of trimers with uretdiones based on hexamethylene diisocyanate.

Particularly preferred monomers are those of the following formulae (Samples 1 to 42).

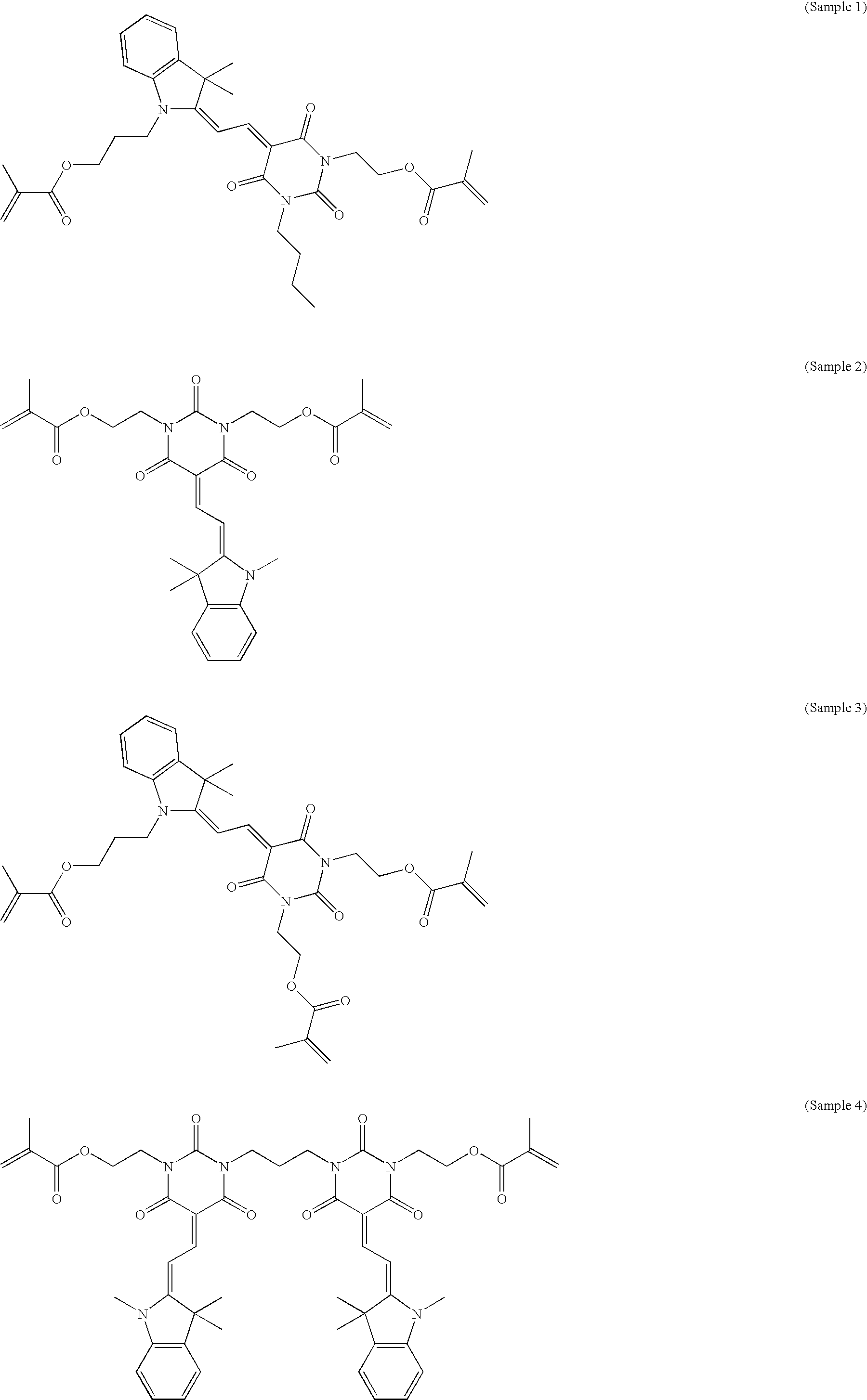

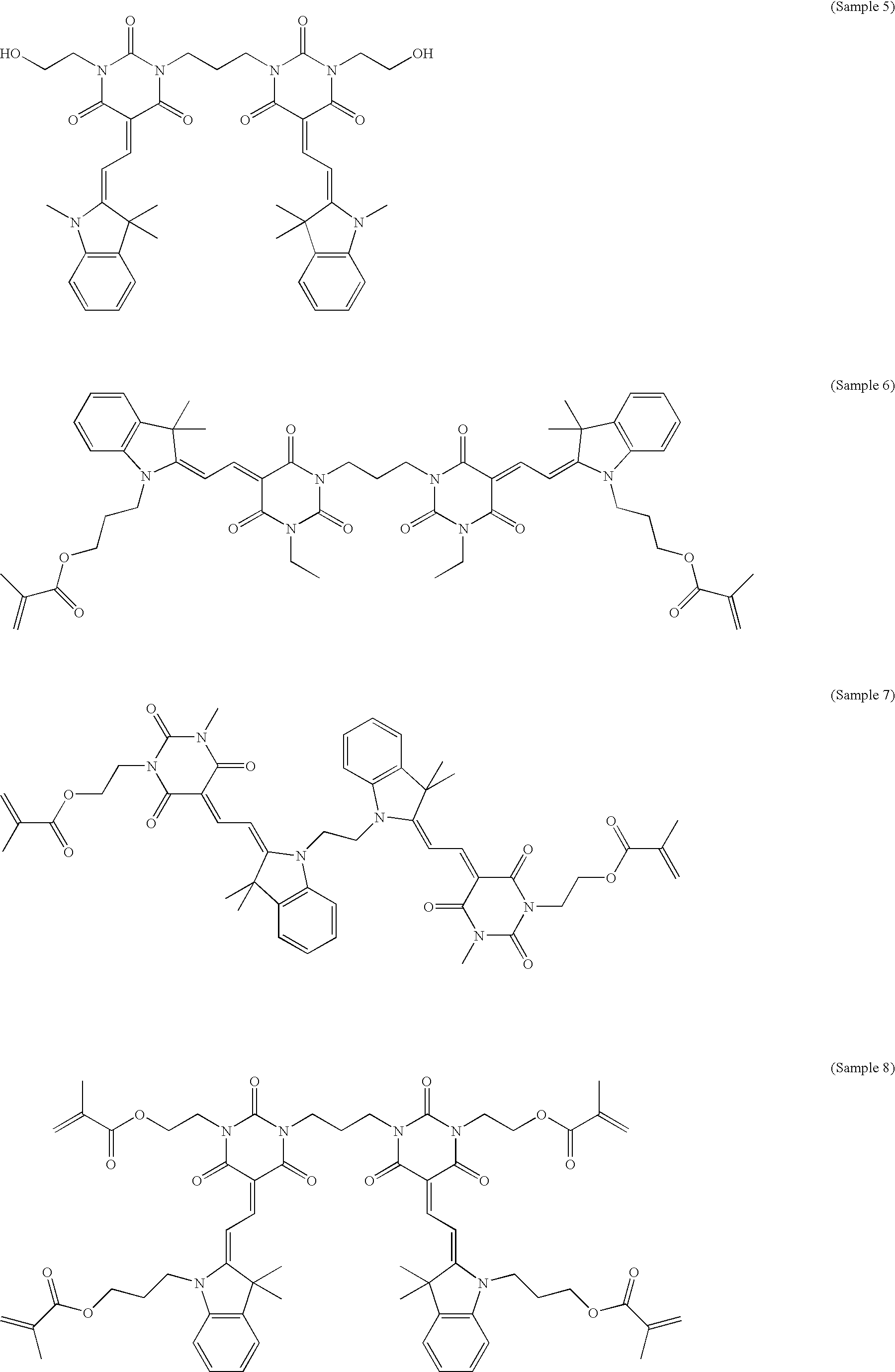

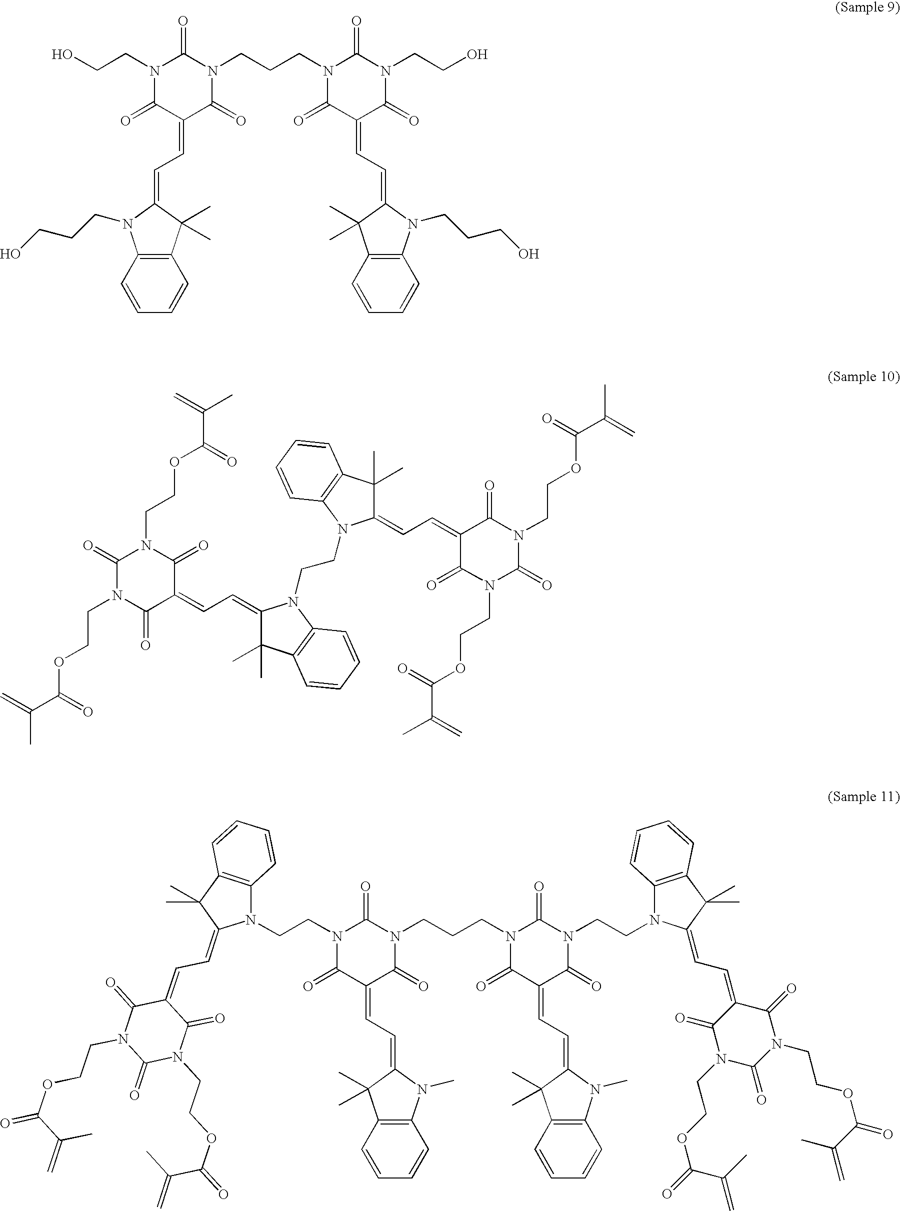

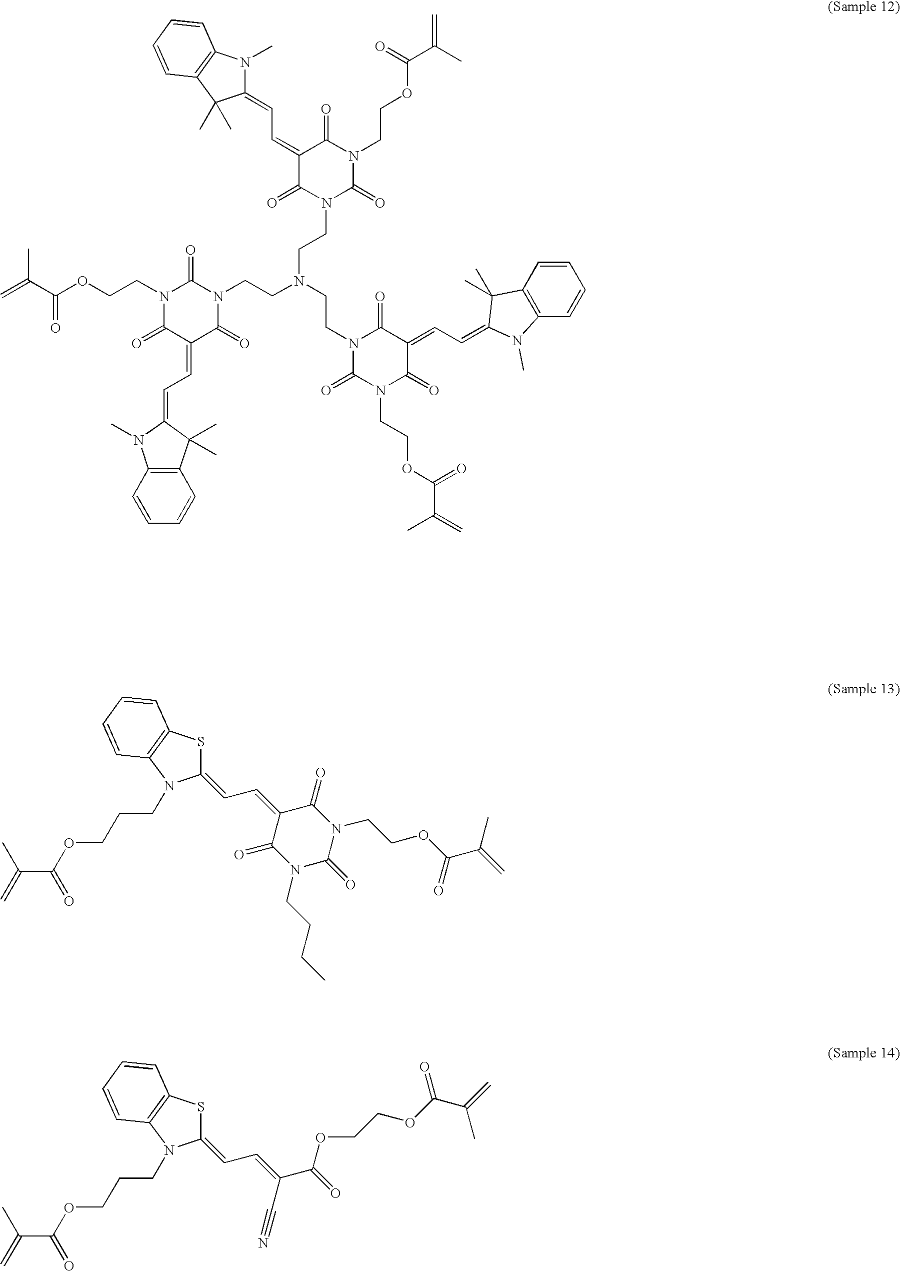

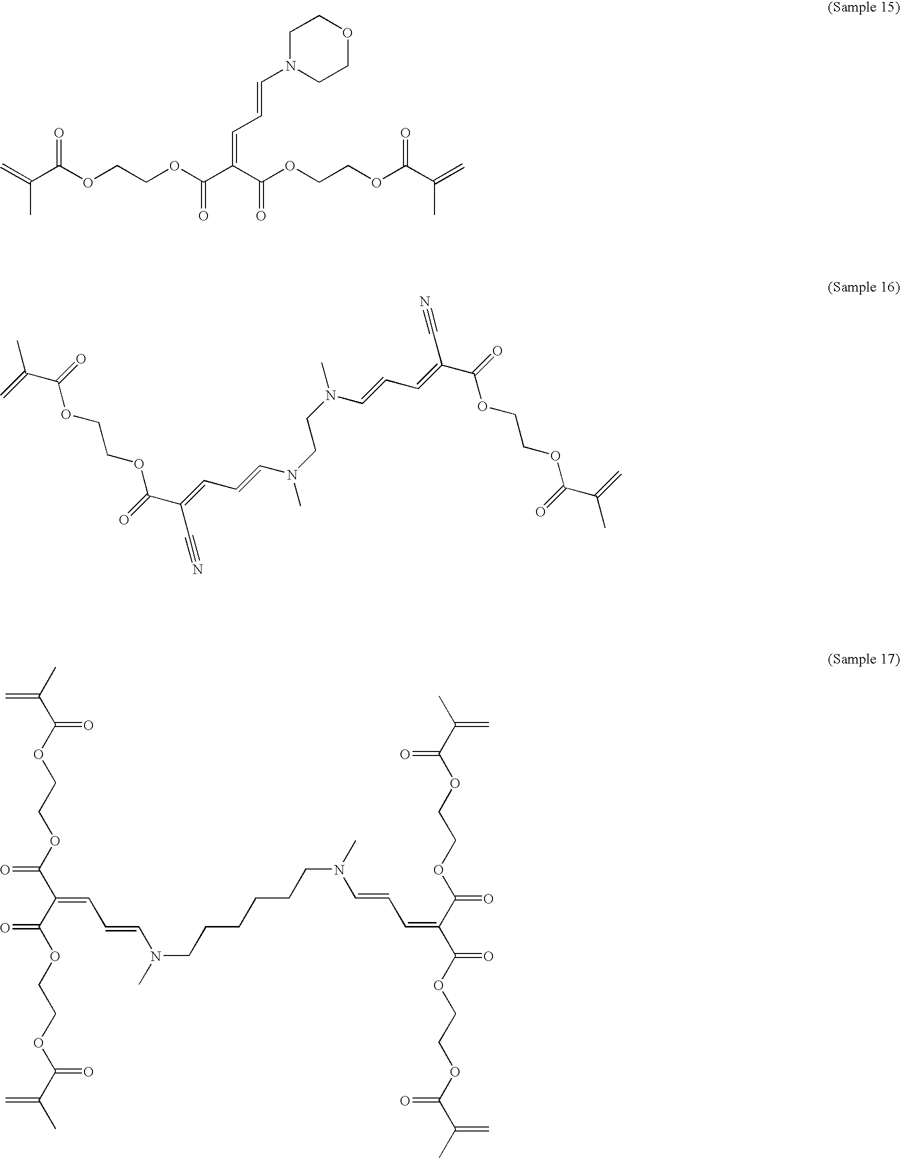

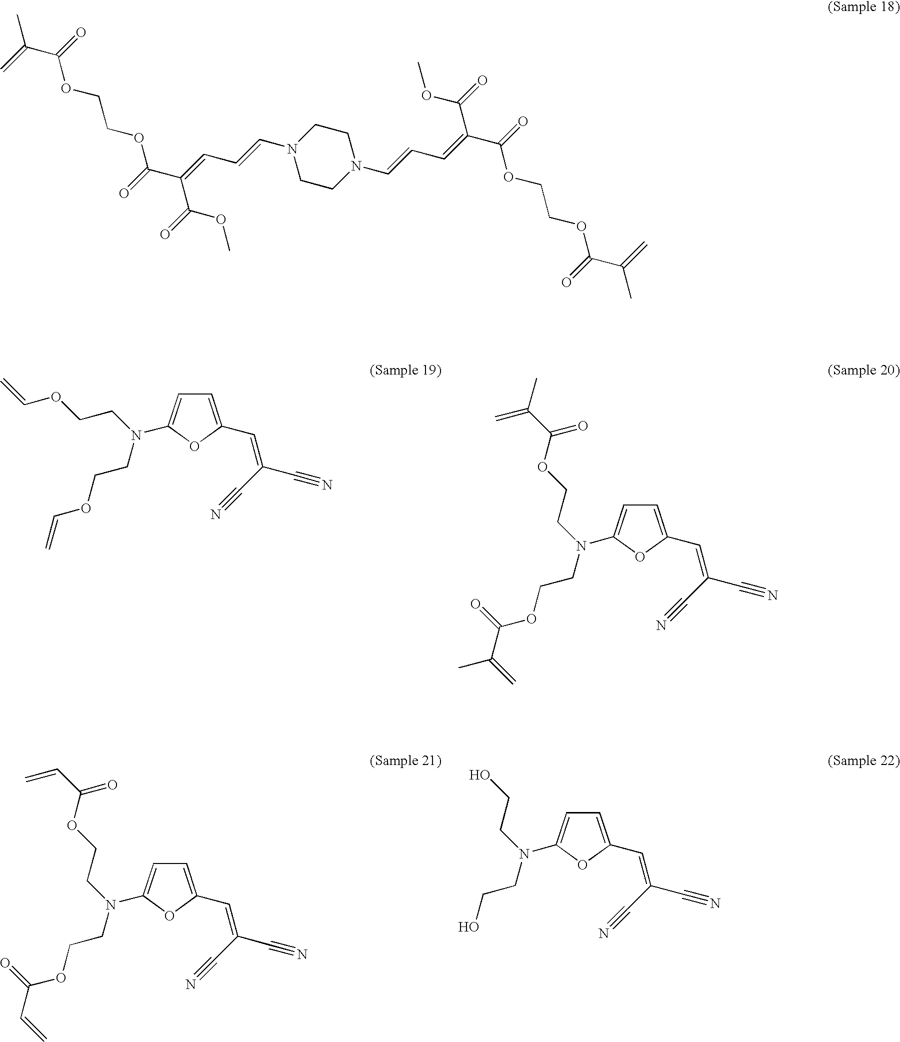

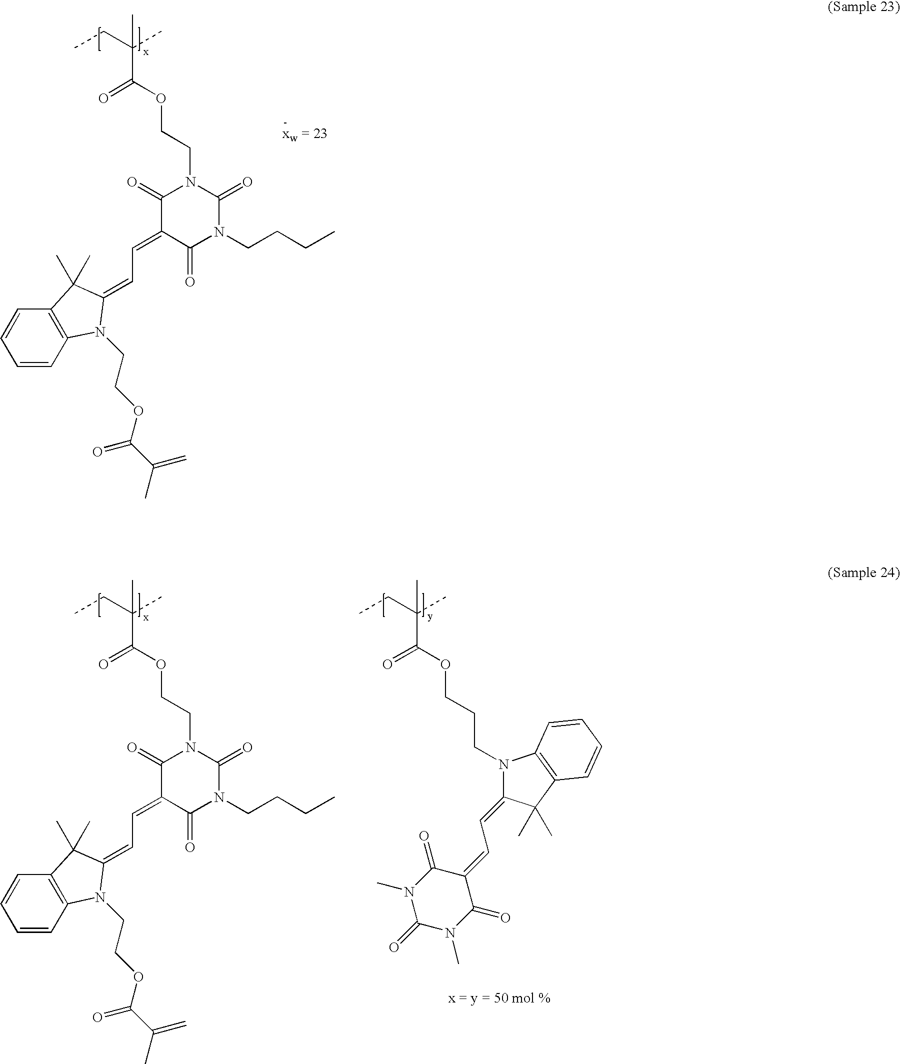

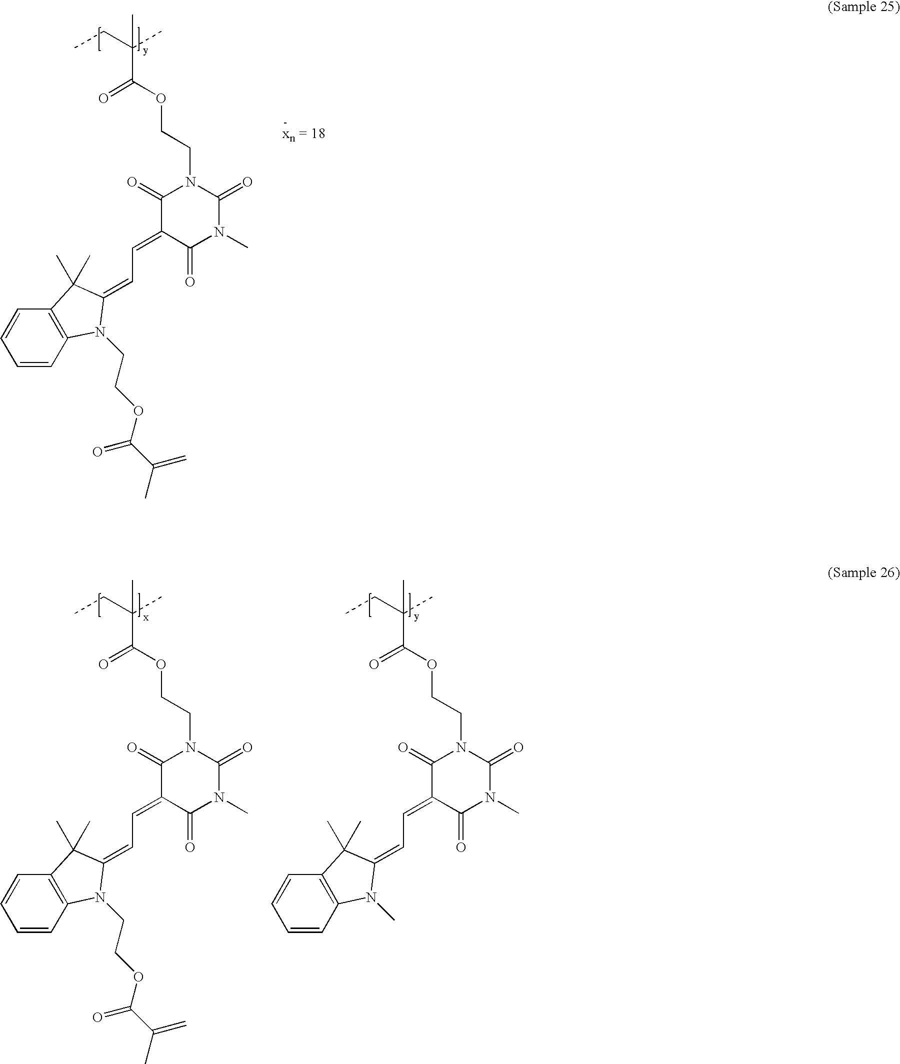

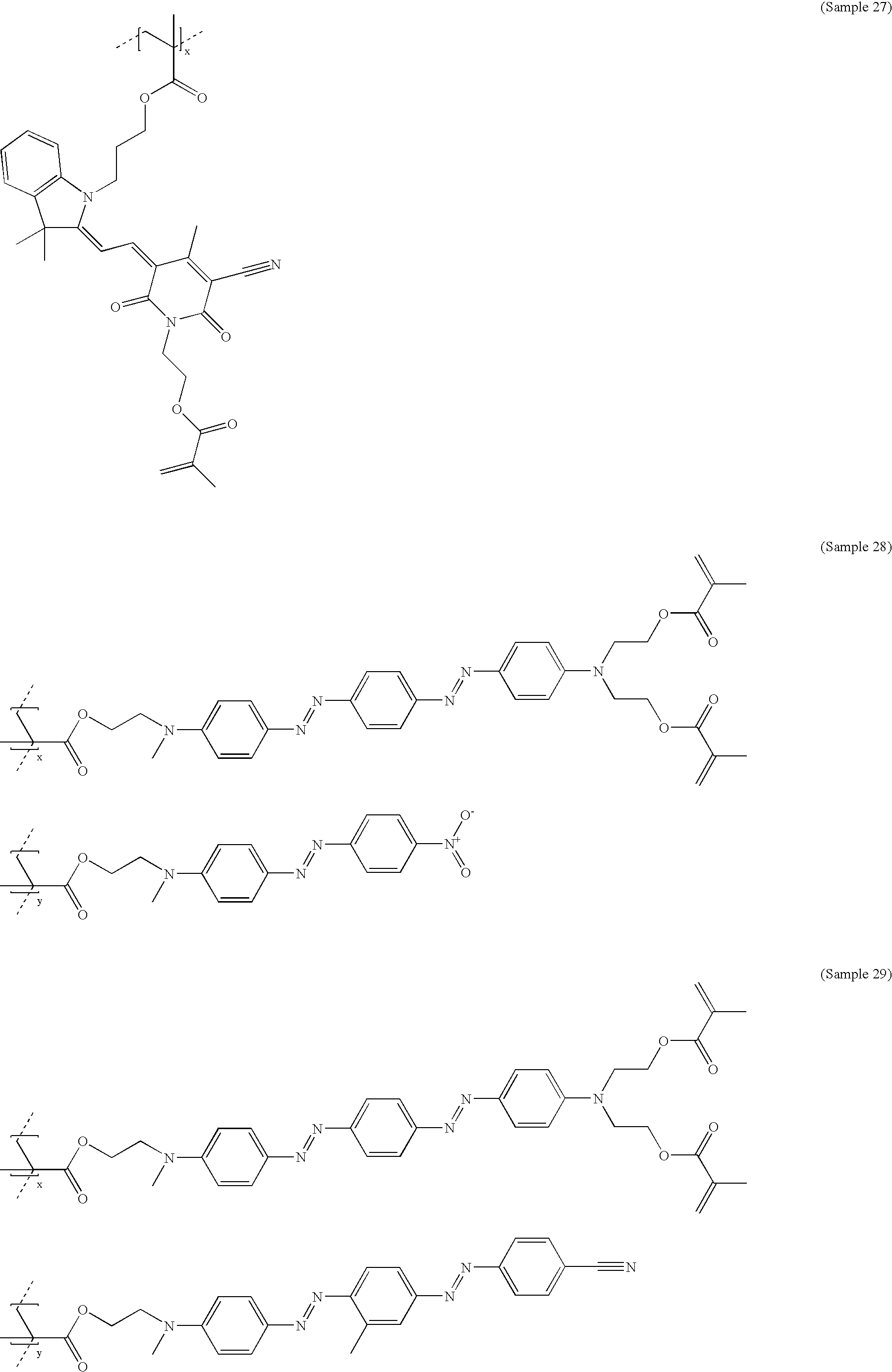

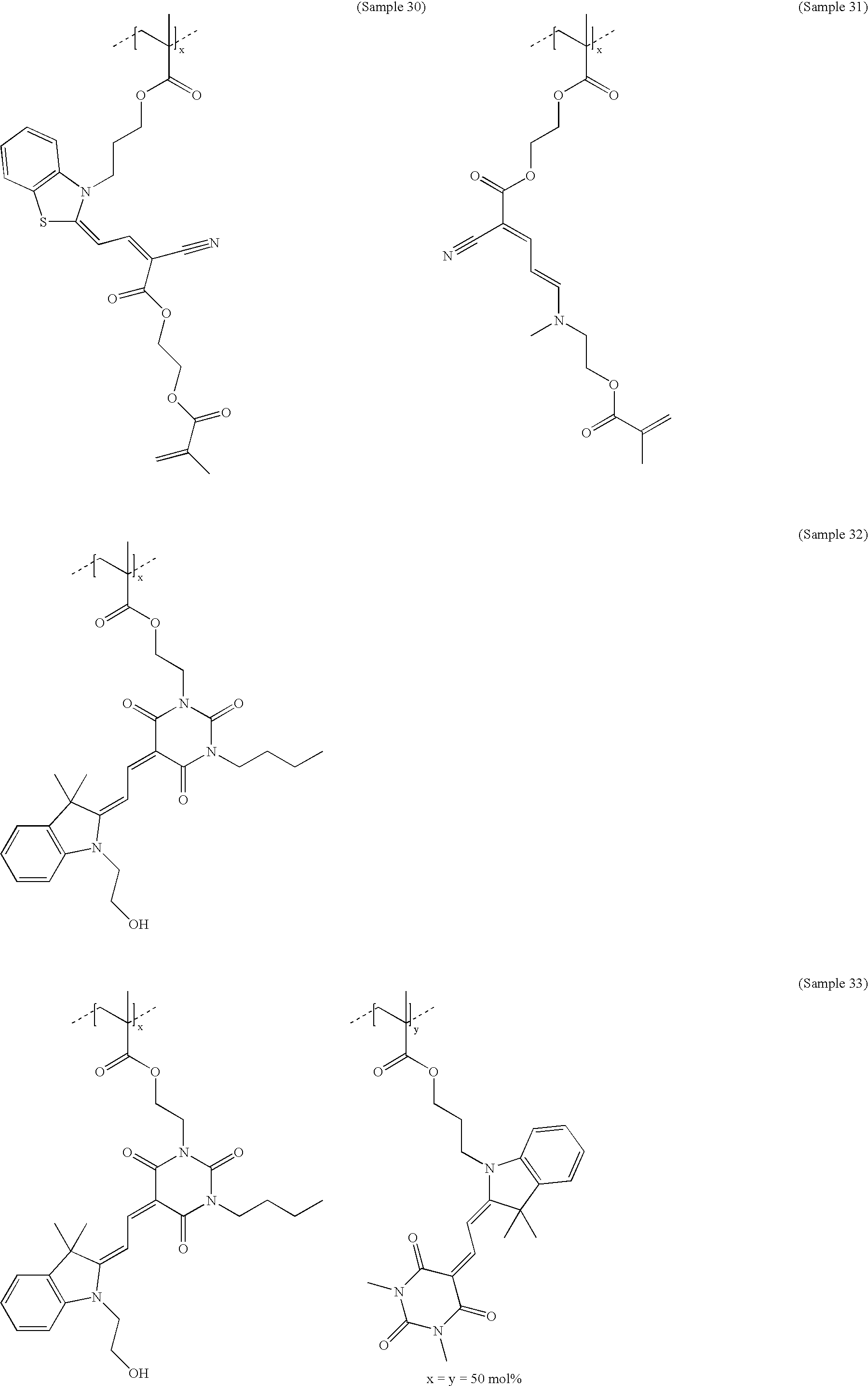

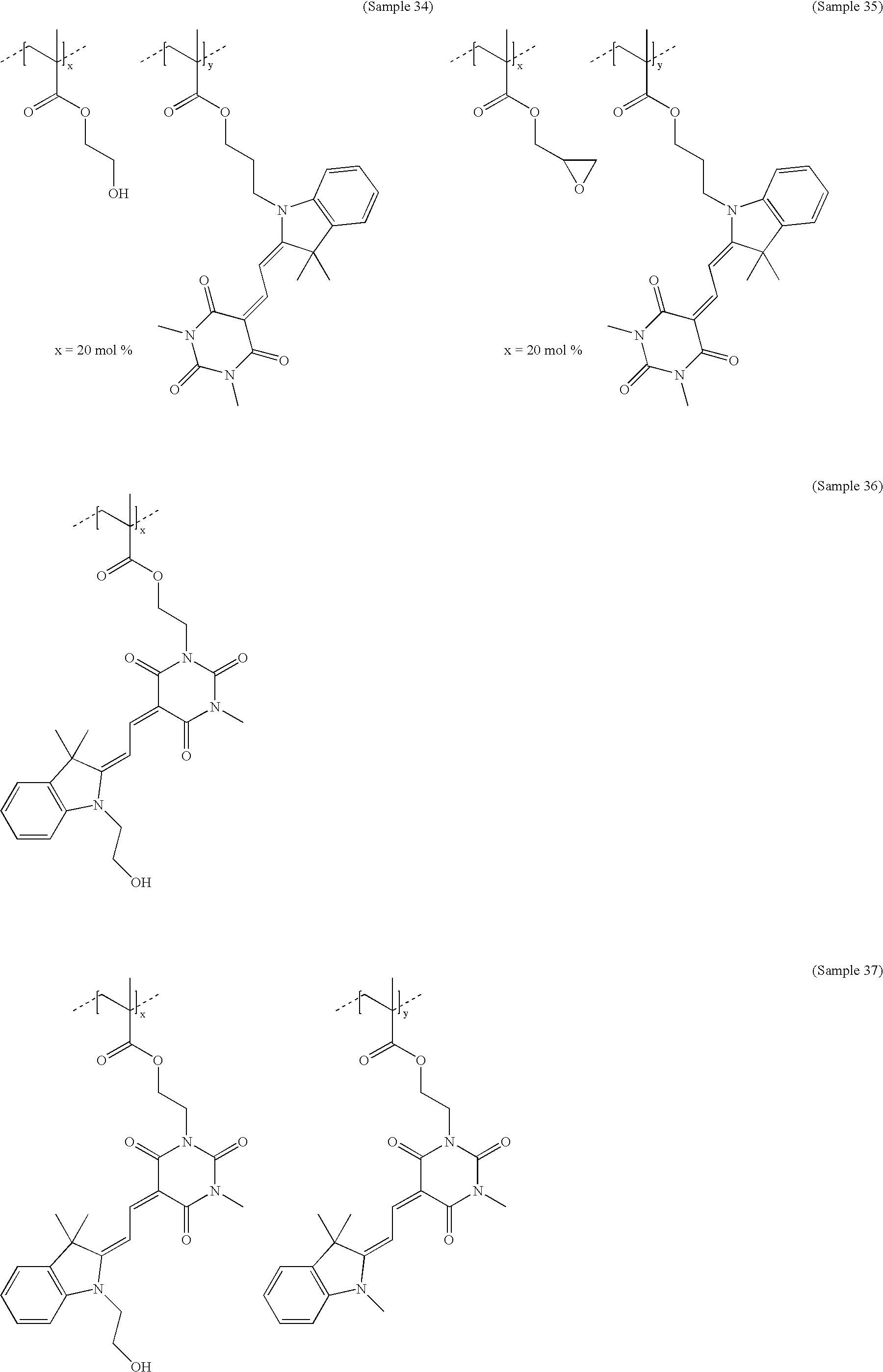

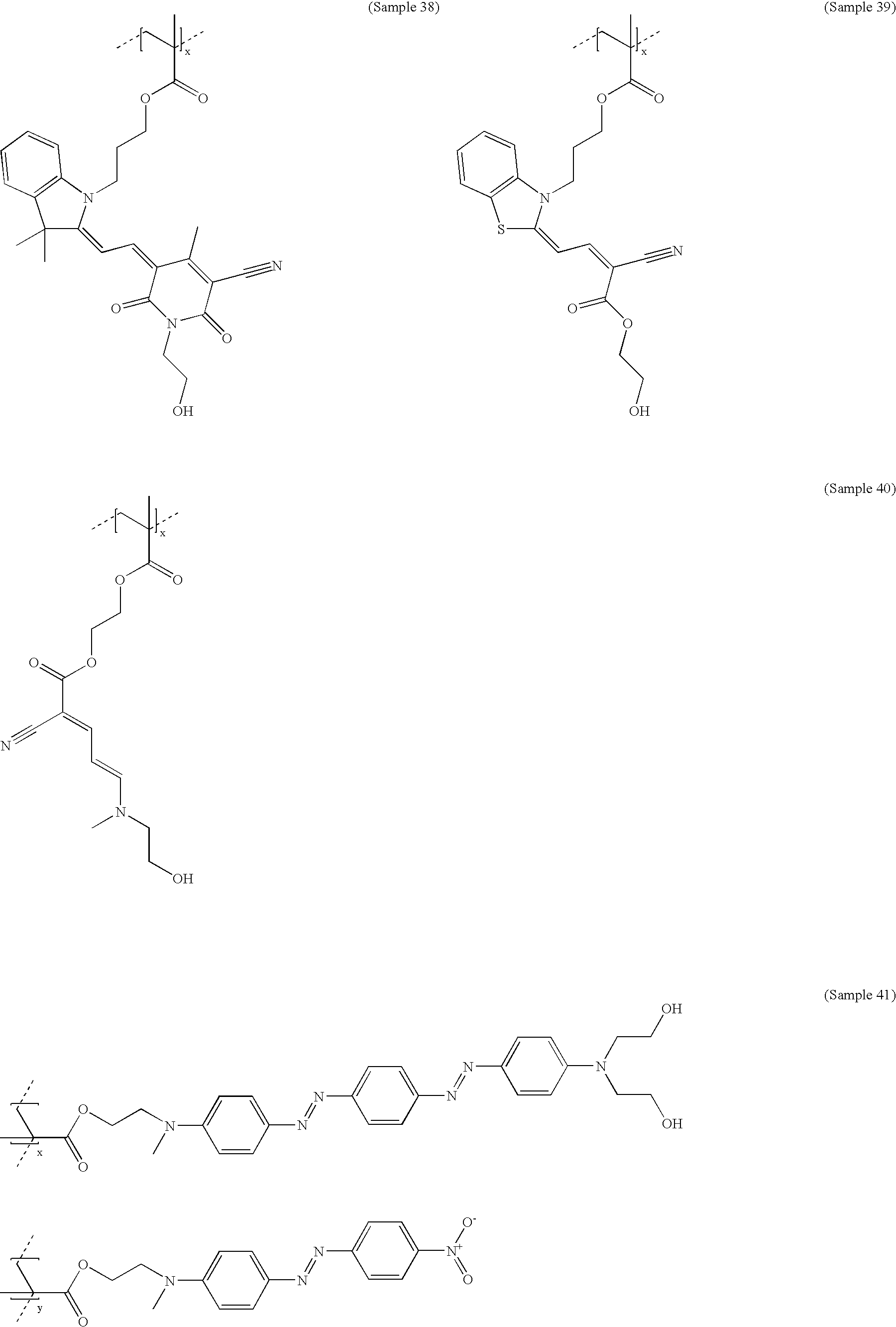

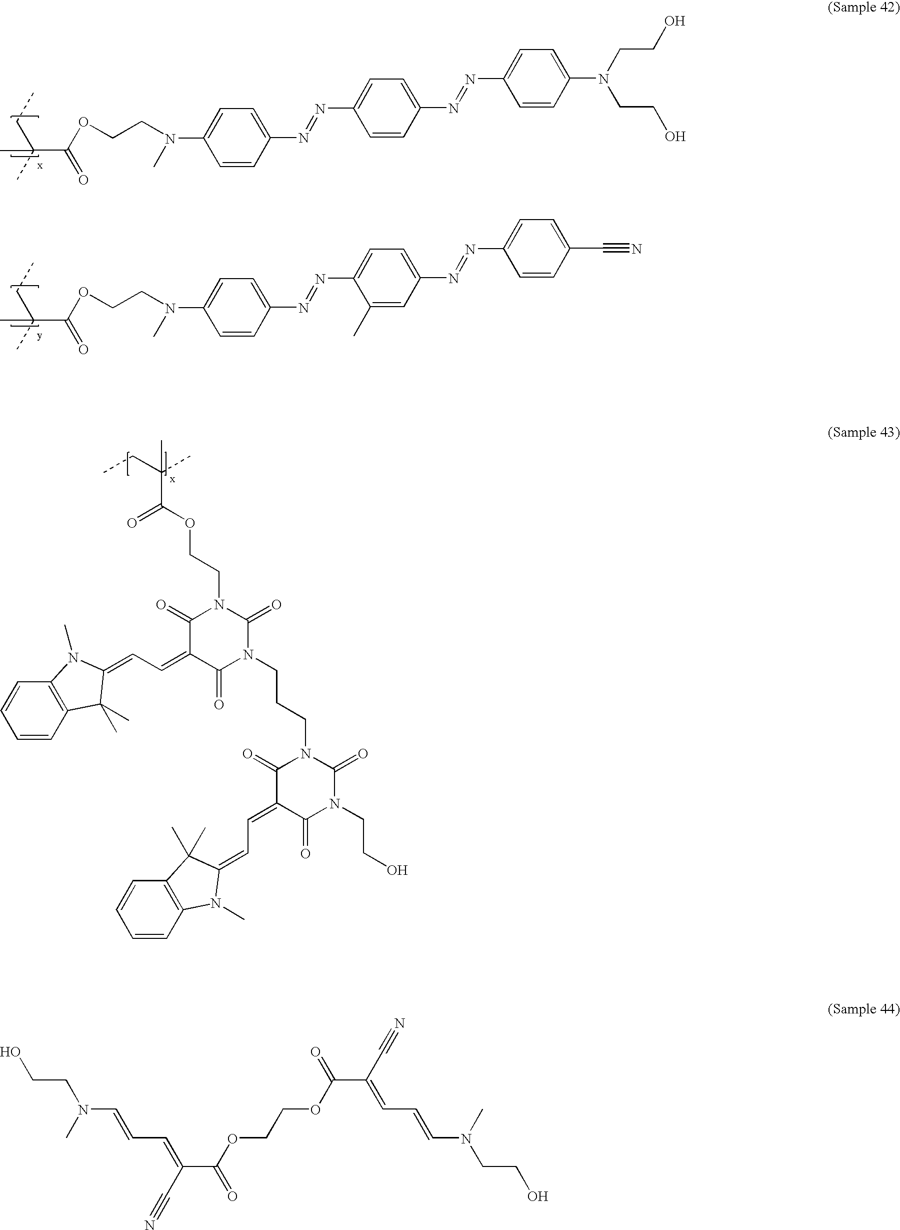

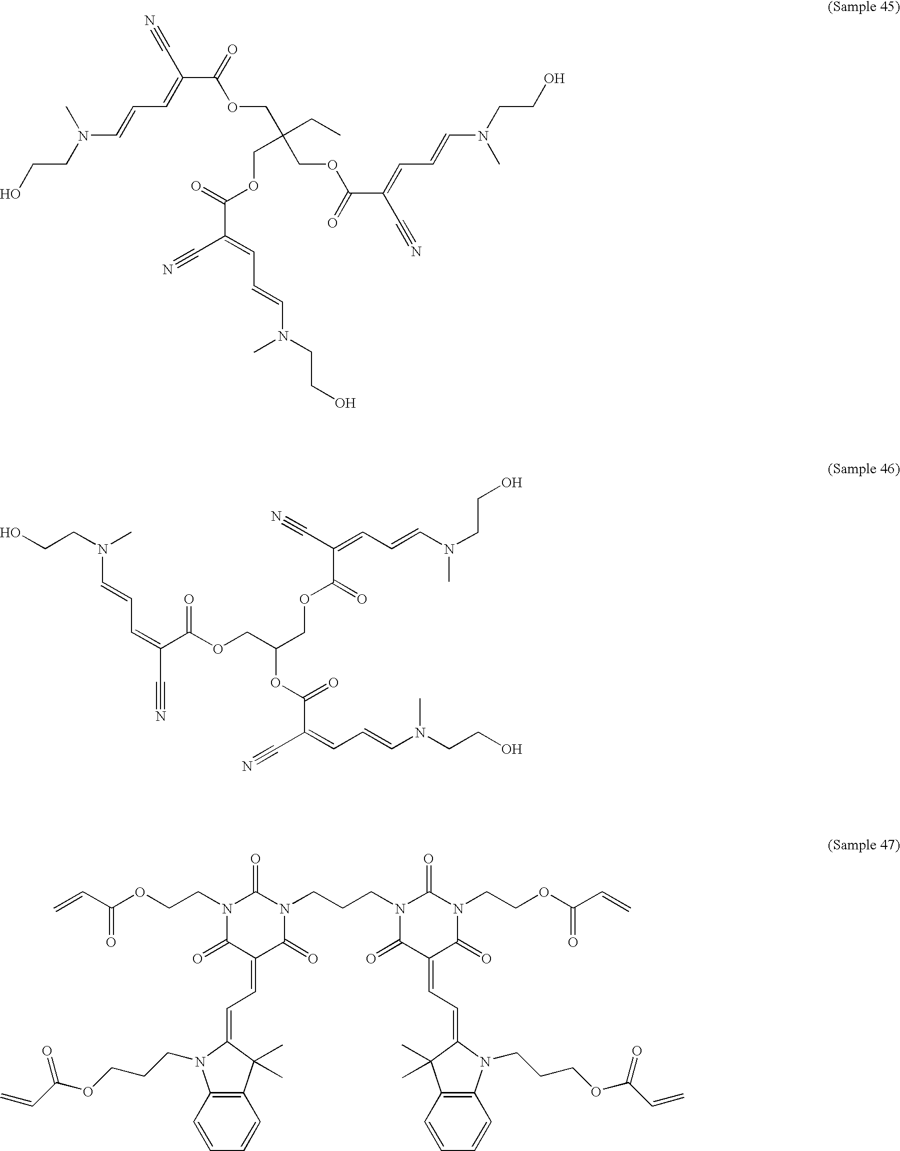

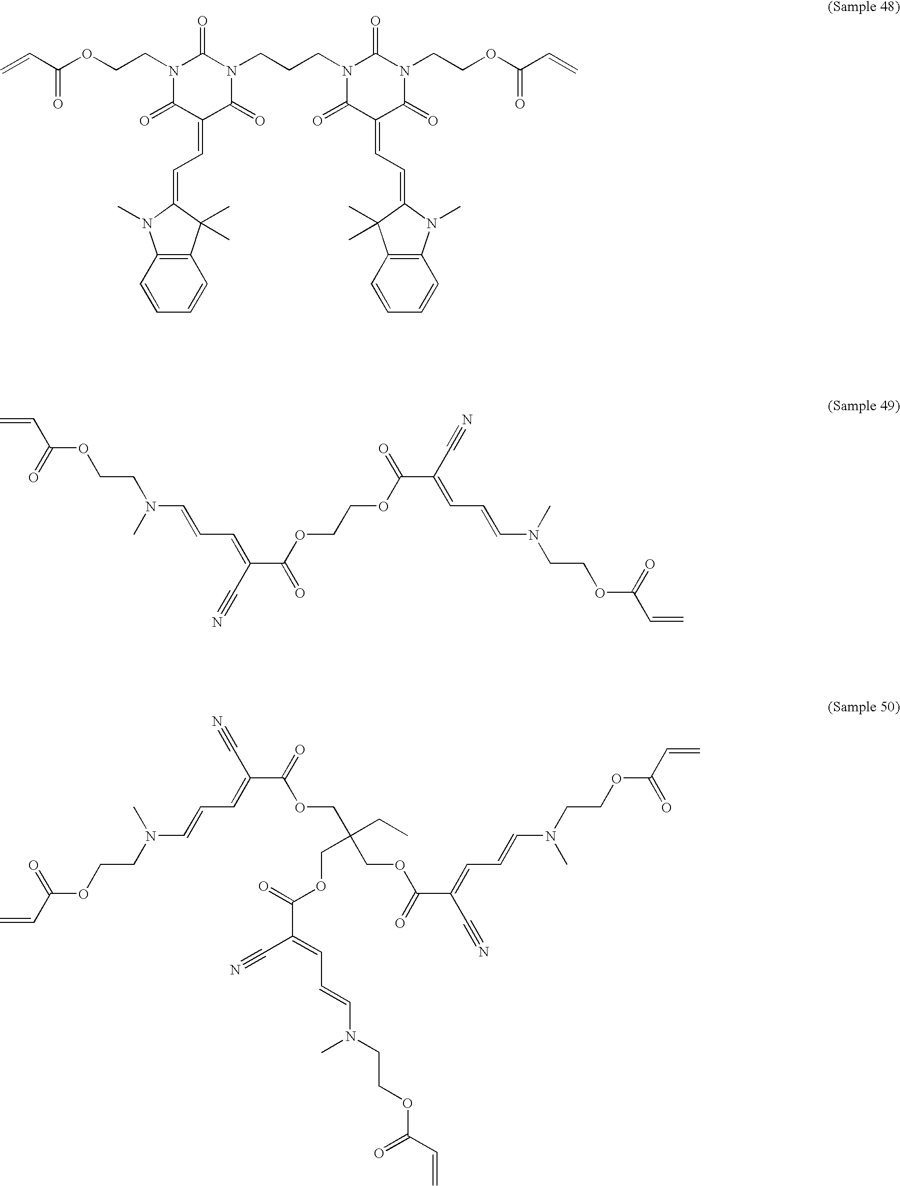

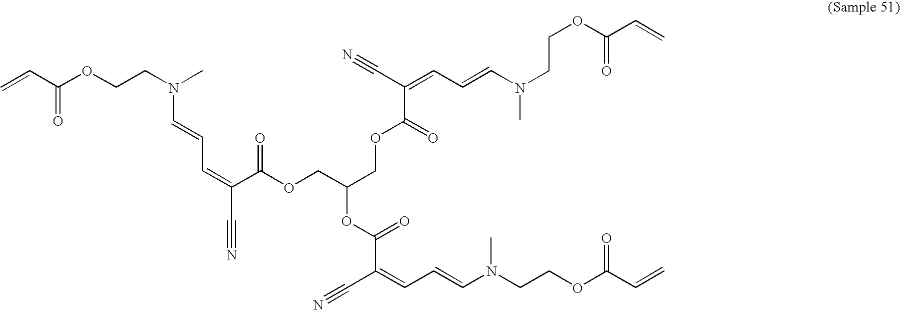

The absorption spectra are preferably measured in solution.

The invention further provides a process for producing the optical data carriers, characterized in that a solution comprising

a) the monomers on which the polymeric network is based, in particular

A) polyfunctional monomers and, if desired

B) monofunctional monomers,

where at least 50% by weight of the monomers bear the radical of a light-absorbent compound,

b) if desired, a preferably organic solvent,

c) if desired, polymerization initiators and

d) if desired, further additives such as quenchers or sensitizers,

is applied to a substrate, the polymerization is initiated and solvent which is preferably used is removed during or after the polymerization and this procedure is, if desired, repeated a number of times.

In addition, the invention provides the solution (hereinafter also referred to as composition), which is preferably used for producing the optical data store and comprises the monomer on which the polymeric network is based, if appropriate polymerization initiators, if appropriate further additives and at least one organic solvent.

If solvents are used, preferred solvents are, for example, solvents or solvent mixtures which, firstly, have a sufficient solvent capacity for the monomers or their mixtures with additives and/or binders used for the coating procedure and, secondly, have a minimal influence on the substrate. Suitable solvents which have little influence on the substrate (preferably polycarbonate) are, for example, alcohols, ethers, hydrocarbons, halogenated hydrocarbons, cellosolves, ketones. Examples of such solvents are methanol, ethanol, propanol, 2,2,3,3-tetrafluoropropanol, butanol, diacetone alcohol, benzyl alcohol, tetrachloroethane, dichloromethane, diethyl ether, dipropyl ether, dibutyl ether, methyl tert-butyl ether, methylcellosolve, ethylcellosolve, 1-methyl-2-propanol, methyl ethyl ketone, 4-hydroxy-4-methyl-2-pentanone, hexane, cyclohexane, ethylcyclohexane, octane, benzene, toluene, xylene. Preferred solvents are hydrocarbons and alcohols since they have the smallest influence on the substrate.

As polymerization initiators, it is possible to use, for example, initiators which liberate free radicals as a result of heating, e.g. azobisisobutyronitrile or benzoyl peroxide. Preferred temperatures for activating these initiators are from 30 to 130° C., preferably from 40 to 70° C.

Initiators which liberate free radicals as a result of illumination are preferably ones which can be activated photochemically at a wavelength of λ=250-650 nm, preferably 350-550 nm. This activation is preferably carried out at temperatures of from 10 to 130° C., preferably from 20 to 60° C. Preference is given to working in the absence of water and air. Preferred photochemical initiators are, for example, 2,2′-dimethoxy-1,2-diphenylmenthan-1-one; 2-methyl-1-[4-(methylthio)phenyl]-2-morpholinopropan-1-one; 2-benzyl-2-dimethylamino-1-(4-morpholinophenyl)butan-1-one; 1-hydroxycyclohexyl phenyl ketone; 2-hydroxy-2-methyl-1-phenylpropan-1-one or titanocene dichloride. Preference is also given to cationic polymerization initiators which are activated by illumination with light having a wavelength λ=250-650 nm, preferably λ=300-400 nm, e.g. diaryliodonium, triarylsulphonium, dialkylphenacylsulphonium and dialkyl-4-hydroxyphenylsulphonium salts of anions such as CF₃SO₃, BF₄, PF₆, AsF₆ or ClO₄.

The invention further provides a process for producing the optical data store of the invention, characterized in that at least one polymer layer comprising a crosslinked polymer based on the monomers on which the polymeric network is based, in particular

A) polyfunctional monomers and, if desired,

B) monofunctional monomers,

where at least 50% by weight of the monomers bear a radical of a light-absorbent compound,

is applied as information layer to a substrate.

The invention further provides polymer layers made up of at least one crosslinked polymer based on

A) a polyfunctional monomer and, if desired

B) monofunctional monomers,

where at least 50% by weight of the monomers bear a radical of a light-absorbent compound.

The crosslinked polymers used for the polymer layers of the invention correspond to the above-defined preferred polymeric networks.

The polymer layers preferably have a thickness of from 10 to 1000 nm.

The invention further provides a process for producing the polymer layers of the invention, characterized in that the monomers on which the polymeric network is based, in particular the solution of the invention, is applied to a suitable support which can be detached again, the polymerization is initiated and solvent which is preferably used is removed during or after the polymerization and the steps of application of the solution, polymerization and, if applicable, removal of the solvent are repeated a number of times if appropriate, thus applying the second and any further layer to the last layer, and the support which can be detached again is subsequently removed again.

Such polymer layers can then be used for producing optical data carriers.

The polymeric networks described or the monomer having light-absorbing groups on which these are based guarantee a sufficiently high absorption for thermal degradation of the information layer on pointwise illumination with focused light when the light wavelength is preferably in the range from 360 to 460 nm, from 600 to 680 nm or from 750 to 820 nm. The contrast between written and unwritten points on the data carrier is achieved by the reflectivity change of the amplitude and also the phase of the incident light due to the changed optical properties of the information layer after the thermal degradation.

The invention further provides a write-once optical data carrier comprising a preferably transparent substrate to whose surface at least one light-writable information layer, if desired a reflection layer and/or if desired a protective layer have been applied, which can be written on and read by means of blue, red or infrared light, preferably laser light, where the information layer comprises a polymeric network having covalently bound chromophoric centres.

Alternatively, the structure of the optical data carrier can:
comprise a preferably transparent substrate to whose surface at least one light-writable information layer, if desired a reflection layer and if desired an adhesive layer and a further preferably transparent substrate have been applied.
comprise a preferably transparent substrate to whose surface a reflection layer if desired, at least one light-writable information layer, if desired an adhesive layer and a transparent covering layer have been applied.

Apart from the information layer, further layers such as metal layers, dielectric layers and protective layers may be present in the optical data store. Metals and dielectric layers serve, inter alia, to adjust the reflectivity and the heat absorption/retention. Metals can be, depending on the laser wavelength, gold, silver, aluminium, etc. Examples of dielectric layers are silicon dioxide and silicon nitride. Metal layers and dielectric layers are preferably characterized in that they are applied by sputtering or vapour deposition and have thicknesses in the range from 1 nm to 150 nm, preferably from 1 nm to 100 nm. Protective layers are, for example, dielectric layers, photocurable surface coatings, (pressure-sensitive) adhesive layers and protective films.

Pressure-sensitive adhesive layers consist mainly of acrylic adhesives. Nitto Denko DA-8320 or DA-8310, disclosed in the patent JP-A 11-273147, can, for example, be used for this purpose.

The optical data carrier has, for example, the following layer structure (cf. FIG. 1): a transparent substrate (1), if desired a protective layer (2), an information layer (3), if desired a protective layer (4), if desired an adhesive layer (5), a covering layer (6).

The structure of the optical data carrier preferably:
comprises a preferably transparent substrate (1) to whose surface at least one light-writable information layer (3) which can be written on by means of light, preferably laser light, if desired a protective coating (4), if desired an adhesive layer (5) and a transparent covering layer (6) have been applied.
comprises a preferably transparent substrate (1) to whose surface a protective layer (2), at least one information layer (3) which can be written on by means of light, preferably laser light, if desired an adhesive layer (5) and a transparent covering layer (6) have been applied.
comprises a preferably transparent substrate (1) to whose surface a protective layer (2) if desired, at least one information layer (3) which can be written on by means of light, preferably laser light, if desired a protective layer (4), if desired an adhesive layer (5) and a transparent covering layer (6) have been applied.
comprises a preferably transparent substrate (1) to whose surface at least one information layer (3) which can be written on by means of light, preferably laser light, if desired an adhesive layer (5) and a transparent covering layer (6) have been applied.

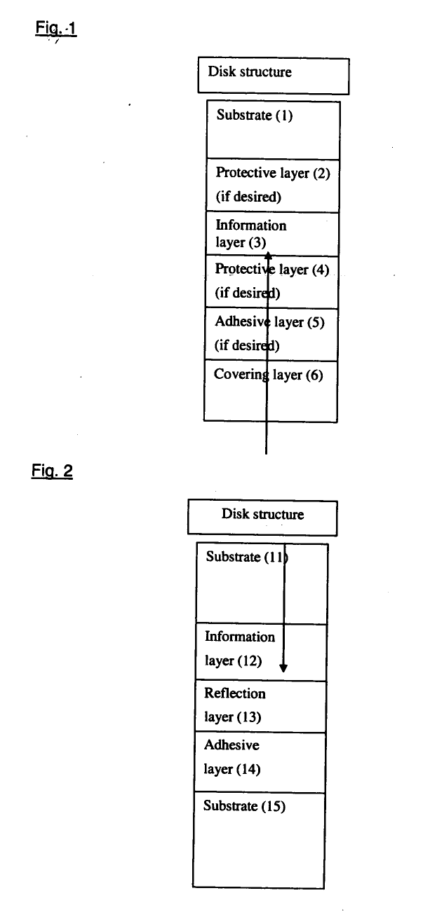

Alternatively, the optical data carrier has, for example, the following layer structure (cf. FIG. 2): a preferably transparent substrate (11), an information layer (12), if desired a reflection layer (13), if desired an adhesive layer (14), a further preferably transparent substrate (15).

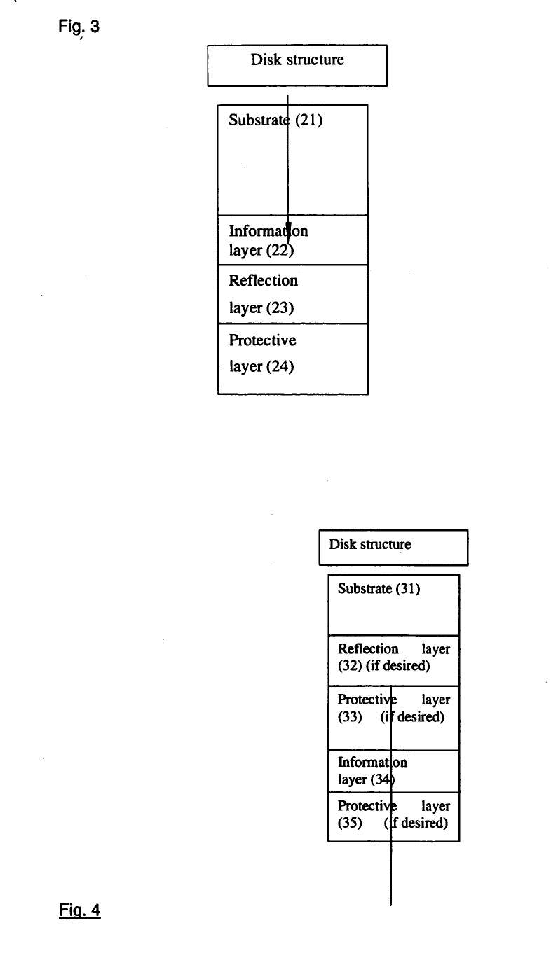

Alternatively, the optical data carrier has, for example, the following layer structure (cf. FIG. 3): a preferably transparent substrate (21), an information layer (22), if desired a reflection layer (23), a protective layer (24).

Alternatively, the optical data carrier has, for example, the following layer structure (cf. FIG. 4): a preferably transparent substrate (31), if desired a reflection layer (32), an information layer (33), a protective layer (34).

The invention further provides optical data carriers according to the invention which have been written on by means of blue, red or infrared light, in particular laser light.

The invention further provides the optical data stores according to the invention after they have been written on once by means of blue, red or infrared light, in particular laser light.

Furthermore, the invention provides for the use of light-absorbent compounds which are incorporated in a polymeric network and have at least one absorption maximum in the range from 340 to 820 nm in the information layer of optical data carriers which have been written on once. The preferred ranges for the light-absorbent compounds, for the information layers produced therefrom and also for the optical data carriers also apply to use according to the invention.

The information layer can comprise not only the polymeric network comprising covalently bound light-absorbent compounds but also initiators, stabilizers, diluents and sensitizers and also further constituents, and also light-absorbent compounds which are not covalently bound or residual monomers which have not taken part in the crosslinking reaction.

The substrates for producing the optical data stores can have been produced from optically transparent plastics which, if necessary, have been subjected to surface treatment. Preference is given to plastics such as polycarbonates or polyacrylates and also polycycloolefins or polyolefins. The light-absorbent compound can also be used in a low concentration for protecting the polymer substrate and stabilizing it towards light.

The reflection layer can be produced from any metal or metal alloy which is customarily used for writable optical data carriers. Suitable metals and metal alloys can be applied by vapour deposition and sputtering and comprise, for example, gold, silver, copper, aluminium and their alloys among one another or with other metals.

The protective surface coating composition over the reflection layer can consist of UV-curable resins.

An intermediate layer which protects the reflection layer against oxidation can likewise be present.

Mixtures of the abovementioned curable monomers bearing light-absorbing groups can likewise be used.

The invention further provides a process for producing the optical data carriers of the invention, which is characterized in that a preferably transparent substrate which may, if desired, have previously been provided with a reflection layer is coated with the monomers bearing light-absorbing groups, if desired in combination with suitable initiators (preferably photoinitiators) and additives and, if desired, suitable solvents, cured (preferably by illumination with light having a wavelength λ=250-650 nm at temperatures in the range from 10 to 130° C.) and provided, if desired, with a reflection layer, further intermediate layers and, if desired, a protective layer or a further substrate or a covering layer. The crosslinking of the monomers can occur, instead of directly after they have been applied, also after one of the various downstream steps in the formation of the optical data carrier.

For polymeric networks which are obtained via polyaddition, curing the monomers is preferably effected by mixing the monomers to be subjected to polyaddition, if desired together with suitable catalysts and/or additives, applying the mixture to the substrate, preferably by spin coating, and carrying out the polyaddition at a temperature of from 10 to 130° C.

Coating of the substrate with the monomers to be polymerized, if desired in combination with initiators, additives and/or solvents, is preferably carried out by spin coating.

For the coating procedure, the monomers are preferably dissolved, with or without initiators and additives, in a suitable solvent or solvent mixture so that the monomers are present in an amount of 100 parts by weight or less, for example from 10 to 2 parts by weight, per 100 parts by weight of solvent.

Solvents or solvent mixtures for applying the curable monomers of the polymeric network or mixtures thereof with initiators, additives and/or auxiliaries are selected, firstly, according to their solvent capacity for the light-absorbent compound and the other additives and, secondly, on the basis of a minimal influence on the substrate. Suitable solvents which have little influence on the substrate are, for example, alcohols, ethers, hydrocarbons, halogenated hydrocarbons, cellosolves, ketones. Examples of such solvents are methanol, ethanol, propanol, 2,2,3,3-tetrafluoropropanol, butanol, diacetone alcohol, benzyl alcohol, tetrachloroethane, dichloromethane, diethyl ether, dipropyl ether, dibutyl ether, methyl tert-butyl ether, methylcellosolve, ethylcellosolve, 1-methyl-2-propanol, methyl ethyl ketone, 4-hydroxy-4-methyl-2-pentanone, hexane, cyclohexane, ethylcyclohexane, octane, benzene, toluene, xylene. Preferred solvents are hydrocarbons and alcohols since they have the least influence on the substrate.

Suitable additives for the writable information layer are stabilizers, diluents and sensitizers.

The coating which has preferably been produced by spin coating is then cured.

A preferred method of curing the information layers is chain polymerization (very particular preference is given to free-radical polymerization) of the curable monomers under the action of polymerization initiators, preferably under the action of polymerization initiators which liberate free radicals as a result of heating, e.g. azobisisobutyronitrile, 2,2′-azobis(2,4-dimethylvaleronitrile), dimethyl 2,2′-azobisisobutyrate, 2,2′-azobis(4-methoxy-2,4-dimethylvaleronitrile), 2,2′-azobis(2-methylbutyronitrile) or benzoyl peroxide, at elevated temperatures, generally from 30 to 130° C., preferably from 40 to 70° C.

A further preferred curing method is photopolymerization under the action of polymerization initiators which liberate free radicals on illumination with light having a wavelength λ=250-650 nm, preferably λ=300-550 nm, e.g. benzophenone; 2,2′-dimethoxy-1,2-diphenylmentan-1-one; 2-methyl-1[4-(methylthio)phenyl]-2-morpholinopropan-1-one; 2-benzyl-2-dimethylamino-1-(4-morpholinophenyl)butan-1-one; 1-hydroxycyclohexyl phenyl ketone; 2-hydroxy-2-methyl-1-phenylpropan-1-one, bis(2,6-dimethoxybenzoyl)-2,4,4-trimethylpentylphosphine oxide; 2,4,6-trimethylbenzoyldiphenylphosphine oxide; 1-[4-(2-hydroxyethoxy)phenyl]-2-hydroxy-2-methyl-1-propan-1-one; bis(2,4,6-trimethylbenzoyl)phenyl-phosphine oxide; azobisisobutyronitrile or titanocene dichloride, at room temperature or at elevated temperatures, generally from 10 to 130° C., preferably from 20 to 80° C.

Both methods are preferably carried out with exclusion of air and water. Preference is given to a nitrogen atmosphere. The concentration of initiators is preferably in the range from 0.1 to 20% by weight, preferably from 1 to 10% by weight.

The polymerization can also be carried out using a mixture of two or more thermal initiators and photoinitiators.

After curing, the information layer can no longer be removed by means of the abovementioned solvents.

Curing to form the polymeric network does not necessarily have to be complete. It is also possible, for example, to attain degrees of curing of only 30% or more by means of shorter curing times. Preference is given to a degree of curing of at least 30%, which corresponds to a content of uncrosslinked functional groups of not more than 70%. Preference is given to a degree of curing of more than 35%, in particular more than 40%.

In the case of an incompletely cured polymeric network, substantial amounts of uncrosslinked monomer can remain in the information layer. These can, but do not have to, be washed out by means of solvents.

Preference is therefore also given to optical data stores whose information layer comprises not only the polymeric network but also the corresponding monomers.

The writable information layer is then preferably metallized (reflection layer) by sputtering or vapour deposition under reduced pressure and, if appropriate, subsequently provided with a protective surface coating (protective layer) or a further substrate or a covering layer. Multilayer arrangements with a partially transparent reflection layer are also possible.

The following examples illustrate the subject matter of the invention:

### EXAMPLES

### Example 1

1.1

79 g 3-bromo-1-propanol are dissolved in 190 ml of dioxane at room temperature (RT). 69 g of triethylamine and 1 g of hydroquinone are added to this solution, and a solution of 77 g of methacryloyl chloride in 190 ml of dioxane is slowly added dropwise. The reaction mixture is stirred for another 2 hours. The precipitate is filtered off and washed with dioxane. The filtrate is evaporated on a rotary evaporator (bath: 40° C.). Purification is carried out chromatographically on aluminium oxide using toluene as eluant. During evaporation of the solution, 0.1 g of hydroquinone is added. The yield of the product: 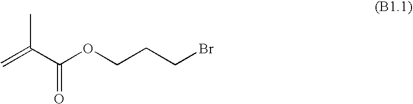
is 77.9 g.
1.1.1

200 g of 2-bromoethanol and 168 g of 3,4-dihydro-2H-pyran are dissolved in 800 ml of n-heptane at RT. 0.5 g of phosphorus oxychloride is added to this solution. The reaction mixture is stirred at 40° C. for 1 hour and at room temperature for 12 hours, thoroughly washed with NaHCO₃ solution and with water in a separating funnel, dried over MgSO₄ and filtered through an 8 cm thick aluminium oxide layer. The collected filtrate is evaporated on a rotary evaporator. The yield of the product: 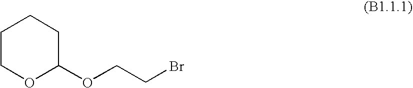
is 278 g.
1.2

46 g of 2,3,3-trimethylindolenine and 75 g of B.1.1 are stirred at 100° C. for 20 hours. The reaction mixture is cooled. The product is brought to precipitation by addition of toluene, briefly boiled in toluene while stirring, cooled, filtered, washed twice on the filter with cold toluene and dried under reduced pressure. The yield of the product: 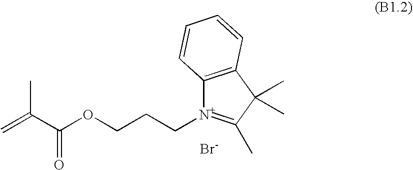
is 43 g.
1.2.1

Repeating the procedure using the substances B1.1.1 and 2,3,3-trimethylindolenine gives the product 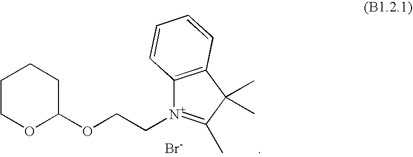
1.3

98 g of 2-methylbenzothiazole and 170 g of B1.1 are stirred at 130° C. for 72 hours. Workup is carried out in a manner analogous to B.1.2. The yield of the product: 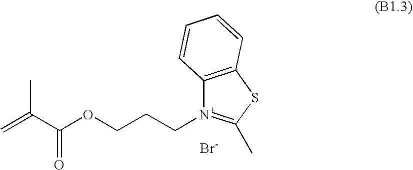
is 128 g.
1.4

45 g of N,N′-diphenylformamidine are dissolved in 500 ml of dichloromethane. A suspension of 17.8 g (0.05 mol) of substance B1.3 in 300 ml of dichloromethane is added to this solution. The reaction mixture is stirred at RT for 3 hours, filtered through a fluted filter paper and evaporated to 200 ml on a rotary evaporator. 1000 ml of diethyl ether are added to this solution while stirring. The precipitate is filtered off, washed adequately with diethyl ether on the filter and dried. The yield of the product: 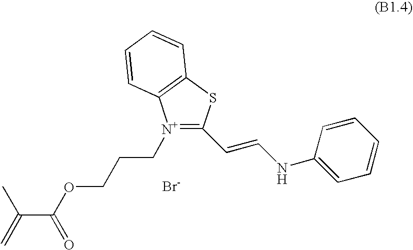
is 24.6 g.
1.5

64.8 g of propargyl alcohol and 100.8 g of morpholine are dissolved in 840 ml of carbon tetrachloride at room temperature. 574 g of active manganese(IV) oxide are added at a little at a time while stirring. The reaction mixture is stirred at room temperature for 12 hours. The precipitate is filtered off and washed adequately on the filter with methylene chloride. The filtrate is evaporated on a rotary evaporator. The substance 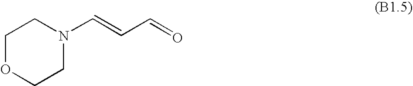
crystallizes out and can be used without additional purification for the further syntheses. The yield is 139 g

M.p. 62-64° C.

Elemental analysis: C₇H₁₁NO₂ (141.17)

Calc.: C, 59.56; H, 7.85; N, 9.92.

Found: C, 58.50; H, 7.90; N, 9.90.

### Example 2

2.1

22.8 g of butylamine are dissolved in 50 ml of diethyl ether and added slowly to a solution of 48.4 g of 2-isocyanatoethyl methacrylate in 160 ml of diethyl ether while cooling in an ice bath. Colourless crystals precipitate. The mixture is stirred for another 10 minutes, the crystals are filtered off and are washed with diethyl ether on the filter. The yield of the product: 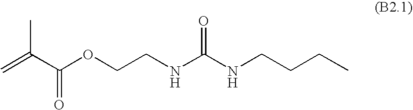
is 65 g.

M.p. 63° C.

Elemental analysis: C₁₁H₂₀N₂O₃ (284.31)

Calc.: C, 57.87; H, 8.83; N, 12.27.

Found: C, 58.00; H, 8.90; N, 12.30.

2.1.1

Repeating the procedure using 13 g of 1,3-diaminopropane and 25 g of ethyl isocyanate gives 34 g of the product:

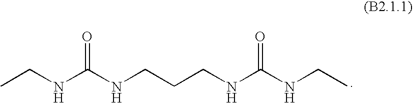

M.p. 205° C.

Elemental analysis: C₉H₂₀N₄O₂ (216.29)

Calc.: C, 49.98; H, 9.32; N, 25.90.

Found: C, 50.00; H, 8.90; N, 25.90.

2.1.2

Repeating the procedure using 13 g of 1,3-diaminopropane and 54.6 g of 2-isocyanatoethyl methacrylate gives 62 g of the product:

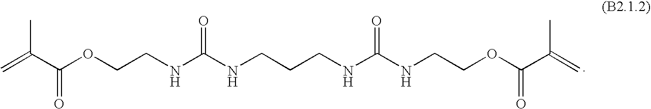

M.p. 127° C.

2.1.3

6.2 g of methylamine in 100 ml of 2M THF solution are cooled to −30° C. and added a little at a time to a solution of 31.0 g of 2-isocyanatoethyl methacrylate in 150 ml of THF at such a rate that the temperature does not exceed −20° C. The reaction mixture is then allowed to warm to room temperature over a period of 20-30 minutes and is evaporated completely on a rotary evaporator. The substance crystallizes out from the remaining melt, is brought onto the filter by means of toluene and washed on the filter with toluene. Colourless crystals are dried at 40° C. under reduced pressure. The yield of the product: 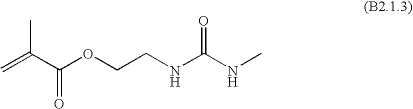
is 30.9 g.

M.p. 69° C.

Elemental analysis: C₈H₁₄N₂O₃ (186.21)

Calc.: C, 51.60; H, 7.58; N, 15.04.

Found: C, 51.90; H, 7.50; N, 15.00.

2.1.4

Repeating the procedure using 17.2 g of tris-(2-aminoethyl)amine and 54.6 g of 2-isocyanatoethyl methacrylate gives 61.7 g of the product:

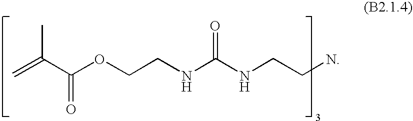

M.p. 122° C.

Elemental analysis: C₂₇H₄₅N₇O₉ (611.70)

Calc.: C, 53.60; H, 7.40; N, 15.70.

Found: C, 53.02; H, 7.42; N, 16.03.

2.2

24 g of sodium carbonate are stirred into 36 g of 2-isocyanatoethyl methacrylate with exclusion of moisture. 37.5 g of 2-aminoethyl methacrylate hydrochloride are added to this suspension. The mixture is stirred at 90° C. for 1 hour. 200 ml of dioxane are subsequently added. The solution is freed of the precipitate by filtration and then evaporated on a rotary evaporator. The residue is purified chromatographically on silica gel using toluene/ethyl acetate=1:2 as eluant. The yield of the product: 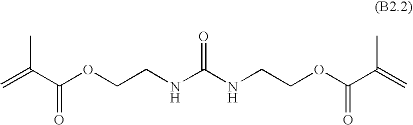
is 18.5 g.

M.p. 65° C.

Elemental analysis: C₁₃H₂₀N₂O₅ (284.31)

Calc.: C, 54.92; H, 7.09; N, 9.85.

Found: C, 54.30; H, 7.10; N, 9.60.

2.3

30 g of the substance B2.1 are dissolved in 60 ml of dioxane. While stirring and cooling, 18.5 g of malonyl dichloride in 40 ml of dioxane are added. The reaction mixture is stirred at 90° C. for 1 hour. Dioxane is taken off on a rotary evaporator. 45 g of oily product: 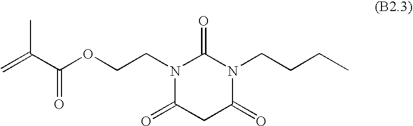
are used further without additional purification.
2.3.1

Repeating the procedure using 15 g of B2.1.1 and 19 g of malonyl dichloride gives 32 g of the oily crude product: 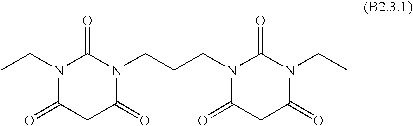
which is used further without additional purification.
2.3.2

Repeating the procedure using 30 g of B2.1.3 and 22.7 g of malonyl dichloride gives 41 g of the oily crude product: 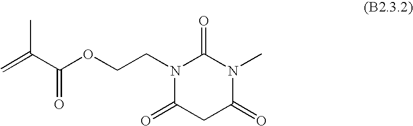
which is used further without additional purification.
2.4

9.6 g of the substance B2.2 are dissolved in 20 ml of dioxane. While stirring and cooling, 4.76 g of malonyl dichloride in 15 ml of dioxane are added. The reaction mixture is stirred at 90° C. for 1 hour. Dioxane is taken off on a rotary evaporator. 16 g of oily product: 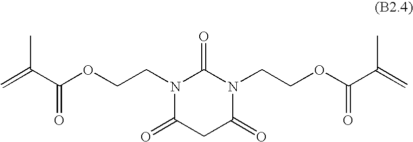
are used further without additional purification.
2.4.1

Repeating the procedure using 30 g of B2.1.2 and 22 g of malonyl dichloride gives 50 g of the oily crude product: 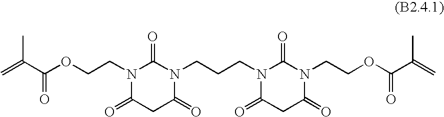
which is used further without additional purification.
2.4.2

Repeating the procedure using 20 g of B2.1.4 and 13.8 g of malonyl dichloride gives 27 g of the oily crude product: 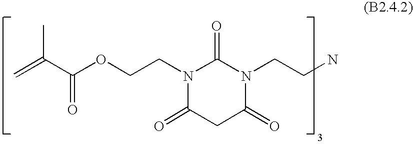
which is used further without additional purification.
2.5

113.2 g of ethyl cyanoacetate, 186.2 g of ethylene glycol and 10 g of toluene-4-sulphonic acid monohydrate are rotated on a rotary evaporator at 90° C. for 30 minutes under atmospheric pressure. At 100 mbar (and later at 90 mbar), 45 g of ethanol are then slowly distilled off. The reaction mixture is transferred to an apparatus for vacuum distillation. 118 g of excess ethylene glycol are distilled off at 65° C. (0.2 mbar). The main fraction goes over at 145-147° C. (0.27-0.30 mbar). The yield of the product: 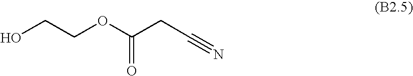
is 43.2 g.

Elemental analysis: C₅H₇NO₃ (129.12)

Calc.: C, 46.51; H, 5.46; N, 10.85.

Found: C, 47.00; H, 5.60; N, 10.70.

2.5.1

The product B2.5.1 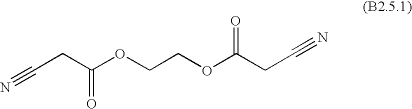
is prepared by a method analogous to that of DE-A-10115227. Purification is carried out chromatographically on silica gel using the solvent mixture toluene/ethyl acetate=2:1
2.5.2

The product B2.5.2 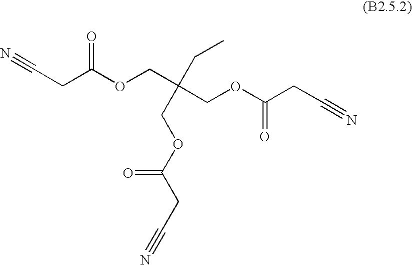
is prepared by a method analogous to that of DE-A-10115227. Purification is carried out chromatographically on silica gel using the solvent mixture toluene/ethyl acetate=1:1
2.5.3

The product B2.5.3 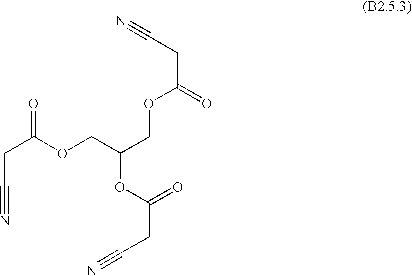
is prepared by a method analogous to that of DE-A-10115227. Purification is carried out chromatographically on silica gel using the solvent mixture toluene/ethyl acetate=1:1
2.6

41.3 g of B2.5 are dissolved in 130 ml of dioxane at RT. 35 g of triethylamine and 1 g of hydroquinone are added to this solution, and a solution of 30.3 g of methacryloyl chloride in 90 ml of dioxane is slowly added dropwise. The reaction mixture is stirred for another 2 hours. The precipitate is filtered off and washed with dioxane. The filtrate is evaporated on a rotary evaporator (bath: 40° C.). Purification is carried out chromatographically on silica gel using toluene/ethyl acetate=2:1 as eluant. 0.1 g of hydroquinone is added during evaporation of the solution. The yield of the product: 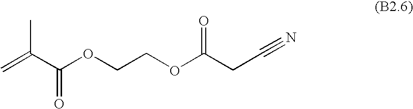
is 16 g.

Elemental analysis: C₉H₁₁NO₄ (197.19)

Calc.: C, 54.82; H, 5.62.

Found: C, 55.00; H, 5.60.

2.7

Repeating the procedure using 123 g of 2-hydroxyethyl methacrylate and 60 g of malonyl dichloride gives 105 g of the liquid product 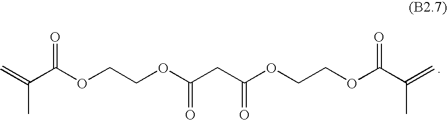
2.8

The product 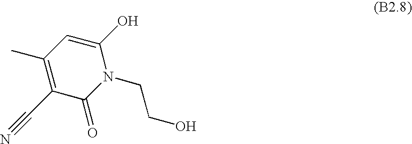
is prepared in a manner analogous to a known method (Chich Chien Chen, Ing Jing Wang, Dyes and Pigments, v.15, pp. 69-82, 1991).
2.9

141 g of 1,1,3,3-tetraethoxypropane are added slowly to a solution of 119 g of aniline in 830 ml of 2N hydrochloric acid at 40-50° C. while stirring vigorously. The reaction mixture is stirred under reflux for 5 hours and then cooled. The precipitate is filtered off and dissolved in 600 ml of a methanol/water mixture (1:1). The solution is made alkaline by means of 15% NaOH. The precipitate is filtered off, washed with water on the filter and dried under reduced pressure. The yield of the product: 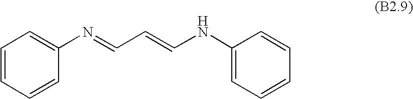
is 100 g.

### Example 3

3.1

38.0 g of B2.3 and 14.1 g of DMF together with 66 ml of acetic anhydride are placed in a reaction vessel and the mixture is stirred at 90° C. for 1 hour. The resulting solution is cooled to 50° C. 47.0 g of B1.2 and immediately afterwards 16.2 g (0.160 mol) of triethylamine are added to this solution. The reaction mixture is stirred at 90° C. for 1 hour. The reaction mixture is cooled to room temperature. The precipitate is filtered off, washed adequately on the filter with small portions of acetic anhydride and discarded. The filtrate is evaporated on a rotary evaporator. Final purification is carried out chromatographically on silica gel using the solvent mixture toluene/ethyl acetate=1:2. After removal of the solvent on a rotary evaporator, the substance is crystallized by addition of methanol. The crystals are filtered off, washed adequately with methanol on the filter and dried under reduced pressure. The yield of the product: 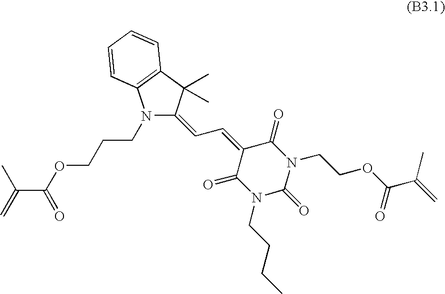
is 26 g.

M.p. 103° C.

UV-VIS spectrum (DMF): λₘₐₓ=468 nm; ε=89000 l*cm⁻¹*mol⁻¹

Elemental analysis: C₃₃H₄₁N₃O₇ (591.71)

Calc.: C, 66.99; H, 6.98; N, 7.10.

Found: C, 66.80; H, 7.10; N, 7.10.

3.2

Repeating the procedure using the substances B2.3 and B1.3 gives the product

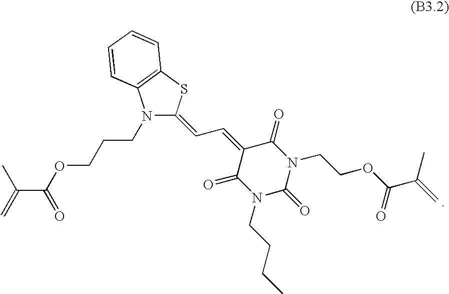

M.p. 152° C.

UV-VIS spectrum (DMF): λₘₐₓ=481 nm; ε=106000 l*cm⁻¹*mol⁻¹

Elemental analysis: C₃₀H₃₅N₃O₇S (581.69)

Calc.: C, 61.95; H, 6.06; N, 7.22.

Found: C, 61.40; H, 6.10; N, 7.30.

3.3

Repeating the procedure using the substances B2.4 and B1.2 gives the product

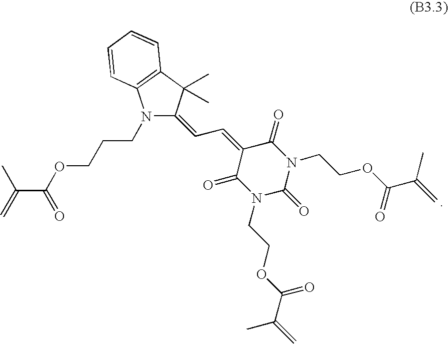

M.p. 121° C.

UV-VIS spectrum (DMF): λₘₐₓ=468 nm; ε=89500 l*cm⁻¹*mol⁻¹

Elemental analysis: C₃₅H₄₁N₃O₉ (647.73)

Calc.: C, 64.90; H, 6.38; N, 6.49.

Found: C, 64.30; H, 6.40; N, 6.40.

3.4

Repeating the procedure using the substances B2.3.1 and B1.2 gives the product

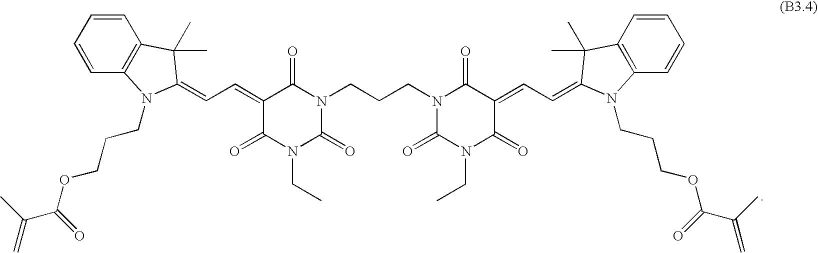

M.p. 134° C.

UV-VIS spectrum (DMF): λₘₐₓ=471 nm; ε=158000 l*cm⁻¹*mol⁻¹

Elemental analysis: C₅₃H₆₂N₆O₁₀ (943.12)

Calc.: C, 67.50; H, 6.63; N, 8.91.

Found: C, 67.00; H, 6.90; N, 8.90.

3.5

Repeating the procedure using the substances B2.4.1 and B1.2 gives the product

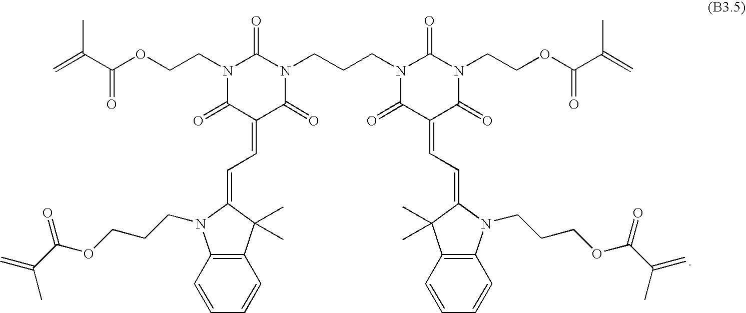

M.p. 117° C.

UV-VIS spectrum (DMF): λₘₐₓ=472 nm; ε=151000 l*cm⁻¹*mol⁻¹

Elemental analysis: C₆₁H₇₀N₆O₁₄ (1111.27)

Calc.: C, 65.93; H, 6.35; N, 7.56.

Found: C, 65.00; H, 6.30; N, 7.40.

3.6

Repeating the procedure using the substances B1.2 and N,N-dimethylbarbituric acid gives the product

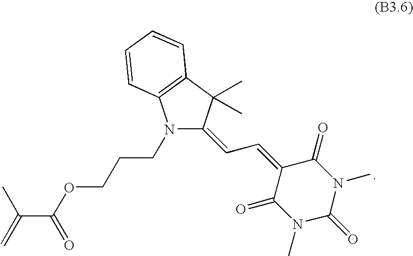

M.p. 238° C.

UV-VIS spectrum (DMF): λₘₐₓ=467 nm; ε=87000 l*cm⁻¹*mol⁻¹

Elemental analysis: C₂₅H₂₉N₃O₅ (451.53)

Calc.: C, 66.50; H, 6.47; N, 9.31.

Found: C, 66.50; H, 6.70; N, 9.40.

3.7

Repeating the procedure using the substances B2.3 and B1.2.1 gives the oily product 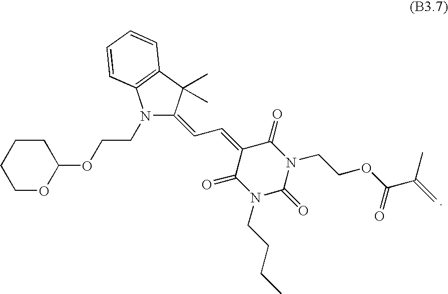
3.7.1

Repeating the procedure using the substances B2.3.2 and B1.2.1 gives the product

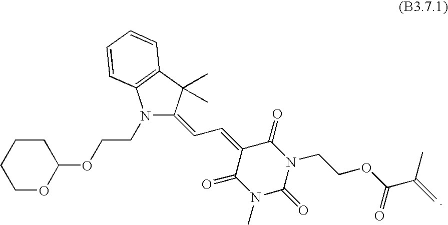

M.p. 189° C.

3.8

8.2 g of B3.7 and 6.6 g p-toluenesulphonic acid monohydrate are stirred in 50 ml of methanol under reflux for 1 hour. The cooled solution is diluted with a large volume of chloroform, shaken twice with NaHCO₃ solution and twice with water in a separating funnel, dried over MgSO₄ and evaporated on a rotary evaporator. Final purification is carried out chromatographically on silica gel using the solvent mixture toluene/ethyl acetate=1:2. The yield of the product: 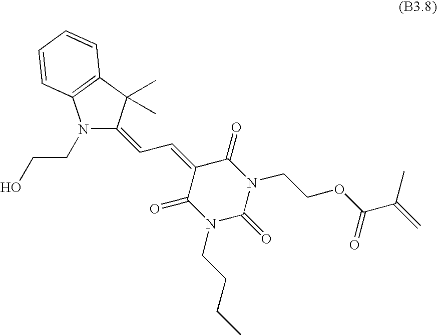
is 2.5 g.

M.p. 94° C.

UV-VIS spectrum (DMF): λₘₐₓ=470 nm; ε=84000 l*cm⁻¹*mol⁻¹

¹H NMR (400 MHz; DMSO-d₆/TMS) δ=5.07 t, 1H(OH)

Elemental analysis: C₂₈H₃₅N₃O₆ (509.61)

Calc.: C, 65.99; H, 6.92; N, 8.25.

Found: C, 65.80; H, 7.20; N, 7.90.

3.8.1

Repeating the procedure using the substance B3.7.1 gives the product:

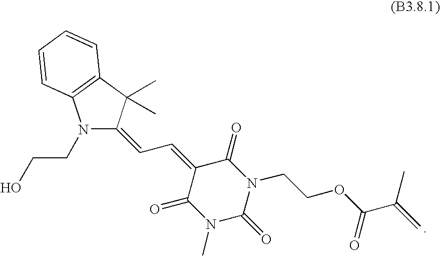

M.p. 184° C.

Elemental analysis: C₂₅H₂₉N₃O₆ (467.53)

Calc.: C, 64.23; H, 6.25; N, 8.99.

Found: C, 64.60; H, 6.30; N, 8.50.

3.9

18.0 g of B2.4 and 10.3 g of (1,3,3-trimethylindolin-2-ylidene)acetaldehyde together with 30 ml of acetic anhydride are placed in a reaction vessel and the mixture is stirred at 90° C. for 1 hour. The resulting solution is cooled and evaporated on a rotary evaporator. Final purification is carried out chromatographically on silica gel using the solvent mixture toluene/ethyl acetate=1:2. After removal of the solvent on a rotary evaporator, the substance is crystallized by addition of methanol. The crystals are filtered off, washed adequately with methanol on the filter and dried under reduced pressure. The yield of the product: 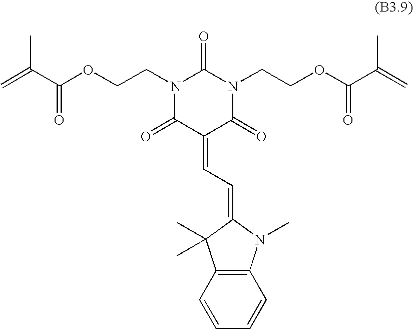
is 9.5 g.

M.p. 149° C.

UV-VIS spectrum (DMF): λₘₐₓ=467 nm; ε=89000 l*cm⁻¹*mol⁻¹

Elemental analysis: C₂₉H₃₃N₃O₇ (535.60)

Calc.: C, 65.03; H, 6.21; N, 7.85.

Found: C, 64.50; H, 6.00; N, 7.70.

3.10

Repeating the procedure using the substances B2.4.1 and (1,3,3-trimethylindolin-2-ylidene)acetaldehyde gives the product

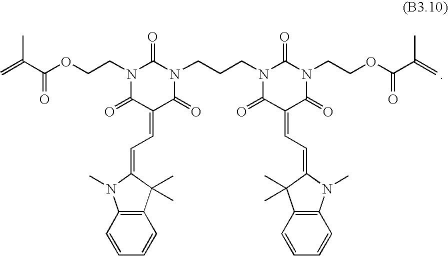

M.p. 178° C.

UV-VIS spectrum (DMF): λₘₐₓ=471 nm; ε=161000 l*cm⁻¹*mol⁻¹

Elemental analysis: C₄₉H₅₄N₆O₁₀ (887.01)

Calc.: C, 66.35; H, 6.14; N, 9.47.

Found: C, 65.80; H, 6.10; N, 9.30.

3.10.1

Repeating the procedure using the substances B2.4.2 and (1,3,3-trimethylindolin-2-ylidene)acetaldehyde gives the product

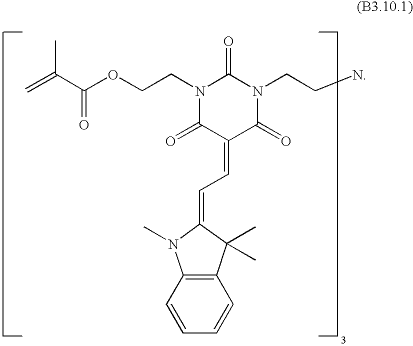

M.p. 137° C.

UV-VIS spectrum (DMF): λₘₐₓ=469 nm; ε=207000 l*cm⁻¹*mol⁻¹

3.11

Repeating the procedure using the substances B2.3.2 and (1,3,3-trimethylindolin-2-ylidene)acetaldehyde gives the product

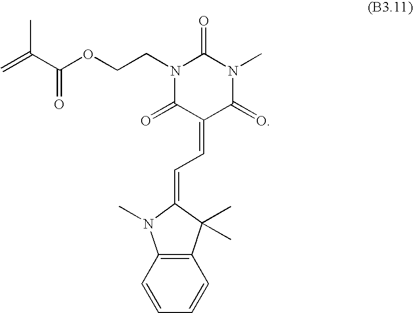

M.p. 189° C.

UV-VIS spectrum (DMF): λₘₐₓ=467 nm; ε=89000 l*cm⁻¹*mol⁻¹

Elemental analysis: C₂₄H₂₇N₃O₅ (437.50)

Calc.: C, 65.89; H, 6.22; N, 9.60.

Found: C, 65.80; H, 6.20; N, 9.50.

3.12

16 g of B2.6 and 79 g of triethylamine are added to a solution of 24.8 g of B1.4 in 270 ml of acetonitrile. The reaction mixture is stirred under reflux for 1 hour, then cooled and evaporated on a rotary evaporator. Final purification is carried out chromatographically on silica gel using the solvent mixture toluene/ethyl acetate=2:1. After removal of the solvent on a rotary evaporator, the substance is crystallized by addition of methanol. The crystals are filtered off, washed adequately with methanol on the filter and dried under reduced pressure. The yield of the product: 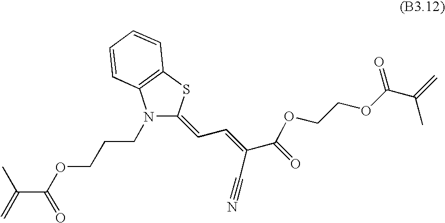
is 9 g.

M.p. 90° C.

UV-VIS spectrum (DMF): λₘₐₓ=455 nm; ε=62000 l*cm⁻¹*mol⁻¹

Elemental analysis: C₂₅H₂₆N₂O₆S (482.56)

Calc.: C, 62.23; H, 5.43; N, 5.81.

Found: C, 62.70; H, 5.50; N, 6.30.

3.12.1

Repeating the procedure using the substances B1.4 and B2.5 gives the product

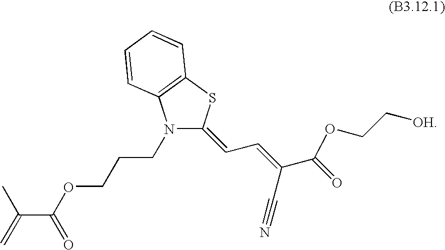

Purification is carried out chromatographically on silica gel using the solvent mixture toluene/ethyl acetate=1:2.

M.p. 129° C.

UV-VIS spectrum (DMF): λₘₐₓ=454 nm; ε2=81000 l*cm⁻¹*mol⁻¹

Elemental analysis: C₂₁H₂₂N₂O₅S (414.48)

Calc.: C, 60.85; H, 5.35; N, 6.76.

Found: C, 60.80; H, 5.30; N, 6.70.

3.13

11.7 ml of piperidine and 6.8 ml of acetic acid are dissolved in 285 ml of toluene. After 10 minutes, 62 g of 2.7 and 33.3 g of 1.5 are added to this mixture. The reaction mixture is stirred at 90° C. for 2 hours. The solvent is taken off on a rotary evaporator. Final purification is carried out chromatographically on silica gel using the solvent mixture toluene/ethyl acetate=1:2. The yield of the product: 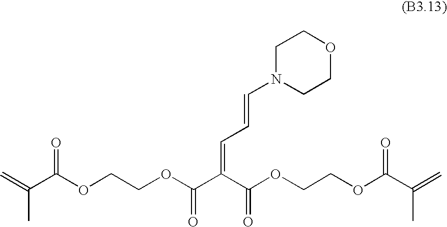
is 14 g.

M.p. 56° C.

UV-VIS spectrum (DMF): λₘₐₓ=374 nm; ε=42200 l*cm⁻¹*mol⁻¹

Elemental analysis: C₂₂H₂₉NO₉ (451.48)

Calc.: C, 58.53; H, 6.47; N, 3.10.

Found: C, 59.40; H, 6.60; N, 2.90.

3.14

1.94 g of B2.8 are dissolved in 20 ml of ethanol. 1.48 g of triethyl orthoformate and 3.66 g of B1.2 are added. 1.5 g of triethylamine are added and the reaction mixture is stirred under reflux for 1.5 hours. The solvent is taken off on a rotary evaporator, and the residue is purified by chromatography on silica gel using ethyl acetate as eluant. The yield of the product: 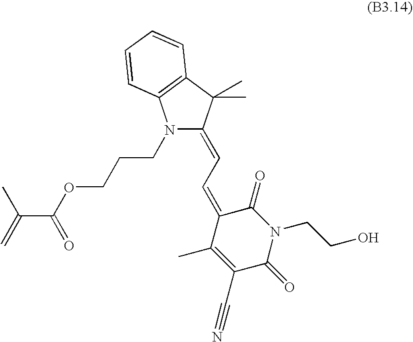
is 1.95 g.

M.p. 190° C.

UV-VIS spectrum (DMF): λₘₐₓ=524 nm; ε114000 l*cm⁻¹*mol⁻¹

3.15

15.0 g of B2.9 and 13.3 g of B2.6 together with 45 ml of acetic anhydride are placed in a reaction vessel and stirred at 110° C. for 1 hour. The resulting solution is cooled and evaporated on a rotary evaporator. Final purification is carried out chromatographically on silica gel using the solvent mixture toluene/ethyl acetate=1:2. After removal of the solvent on a rotary evaporator, the substance is crystallized by addition of methanol. The crystals are filtered off, washed with cold methanol on the filter and dried under reduced pressure. The yield of the product: 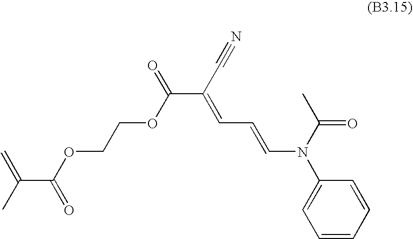
is 12 g.

M.p. 171° C.

3.15.1

22.1 g of B2.9 together with 60 ml of acetic anhydride are placed in a reaction vessel. 9.5 g of B2.5.1 are added while stirring. The reaction mixture is heated at 50° C. for 1 minute, cooled immediately and left at room temperature for 1 hour. The product 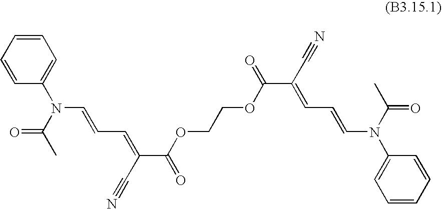
is filtered off, washed with a small amount of acetic anhydride on the filter and dried under reduced pressure. The yield is 20 g.
3.15.2

Repeating the procedure using the substance B2.5.2 gives the product 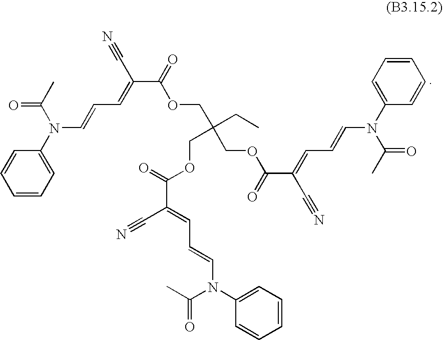
3.15.3

Repeating the procedure using the substance B2.5.3 gives the product 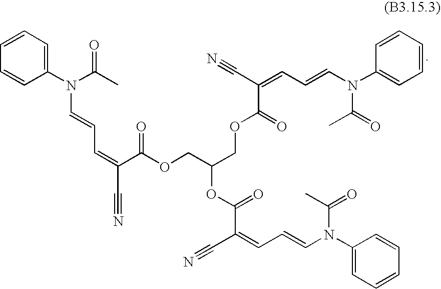
3.16

2.04 g of 2-(methylamino)ethanol are added to a solution of 10 g of B3.15 in 12.5 ml of acetonitrile. The reaction mixture is stirred under reflux for 1 hour, cooled and evaporated on a rotary evaporator. Final purification is carried out chromatographically on silica gel using the solvent mixture toluene/ethyl acetate=1:2. The yield of the product: 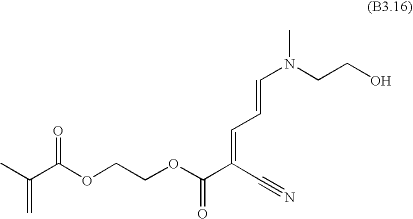
is 4.8 g.

M.p. 114° C.

UV-VIS spectrum (DMF): λₘₐₓ=382 nm; ε=64000 l*cm⁻¹*mol⁻¹

Elemental analysis: C₁₅H₂₀N₂O₅ (308.34)

Calc.: C, 58.43; H, 6.54; N, 9.09.

Found: C, 58.40; H, 6.50; N, 8.80.

3.16.1

11.44 g of 2-(methylamino)ethanol are added to a suspension of 20 g of B3.15.1 in 20 ml of acetonitrile while stirring. The reaction mixture is briefly heated to 80° C. (until B3.15.1 has reacted and dissolved) and then stirred at room temperature for 2 hours. The product 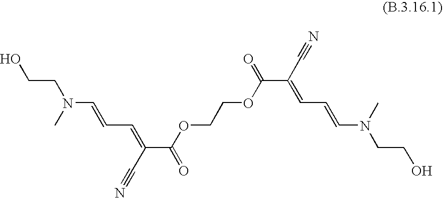
precipitates, is filtered off, washed with a little acetonitrile on the filter and dried. The yield is 10.2 g.

M.p. 216° C.

3.16.2

Repeating the procedure using the substance B3.15.2 gives the product 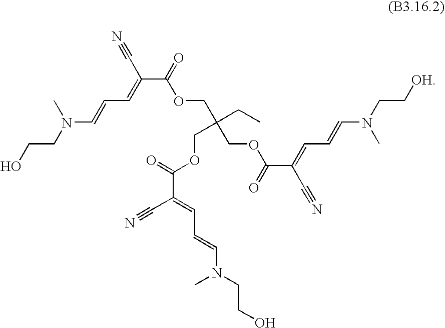
3.16.3

Repeating the procedure using the substance B3.15.3 gives the product

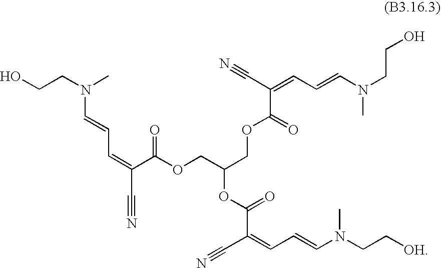

M.p. 200° C.

3.17

8.41 g of diethanolamine and 3 g of acetic acid are dissolved in a mixture of 65 ml of toluene and 30 ml of methanol. After 10 minutes, 8.75 g of 5-bromo-2-furaldehyde and 3.3 g of malononitrile are added to this mixture. The reaction mixture is stirred at 90° C. for 30 minutes, cooled and evaporated on a rotary evaporator. Purification is carried out chromatographically on silica gel using the solvent mixture toluene/methanol=2:1. The crystals of the product 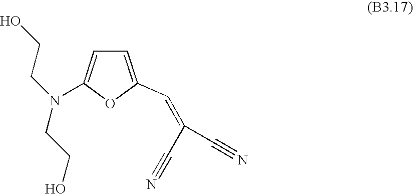
are boiled in 100 ml of the 1:1 mixture of toluene/ethyl acetate, filtered off and dried under reduced pressure. The yield of the product is 3.3 g.

M.p. 137° C.

3.18

0.55 g of 3.17 and 0.55 g of triethylamine are dissolved in 10 ml of dioxane. A solution of 0.66 g of acryloyl chloride in 2 ml of dioxane is added to this solution. The reaction mixture is stirred at 70° C. for 30 minutes. The precipitate is filtered off, washed with dioxane and discarded. The filtrate is evaporated on a rotary evaporator. Purification is carried out on silica gel using toluene/ethyl acetate=1:2 as eluant. The yield of the product: 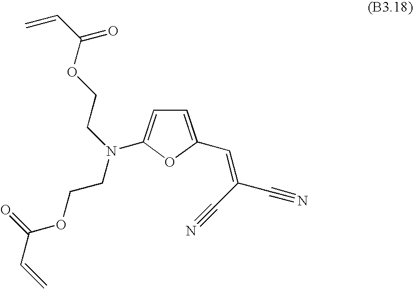
is 0.13 g.

M.p. 70° C.

UV-VIS spectrum (DMF): λₘₐₓ=462 nm; ε=58800 l*cm⁻¹*mol⁻¹

3.19

Using a method analogous to that for the product B3.18, 5 g of B3.17 gives 2.2 g of the product

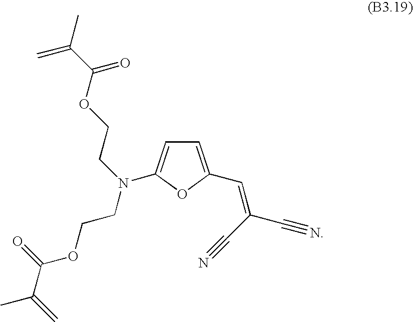

M.p. 95° C.

UV-VIS spectrum (DMF): λₘₐₓ=462 nm; ε=78000 l*cm⁻¹*mol⁻¹

3.20

3.1 g of 2-aminoethyl vinyl ether and 23.4 g of 2-chloroethyl vinyl ether are stirred under reflux (bath temperature: 120° C.) for 3 hours. Excess 2 chloroethyl vinyl ether is taken off on a rotary evaporator. The residue is used further without additional purification. Using a method analogous to that for B3.17, 12.6 g of this viscous liquid give 1.73 g of the product:

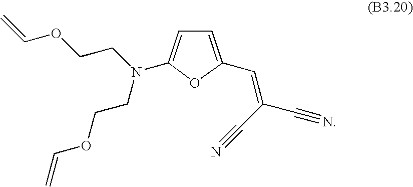

M.p. 111° C.

UV-VIS spectrum (DMF): λₘₐₓ=464 nm; ε=69000 l*cm⁻¹*mol⁻¹

3.21

19.9 g of B3.10 are dissolved in a solvent mixture of 40 ml of dioxane, 20 ml of methanol and 4 ml of water. 4.53 g of a 30% strength solution of sodium methoxide in methanol are added. The reaction mixture is stirred at room temperature for 1.5 hours and then added to 700 ml of 10% strength sodium chloride solution. The precipitate is collected on a filter and dried. Final purification is carried out chromatographically on silica gel using the solvent mixture toluene/methanol=4:1. The yield of the product: 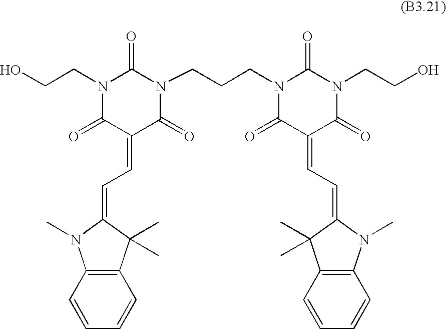
is 10.8 g

M.p. 210° C.

3.22

Repeating the procedure using the substance B3.5 gives the product

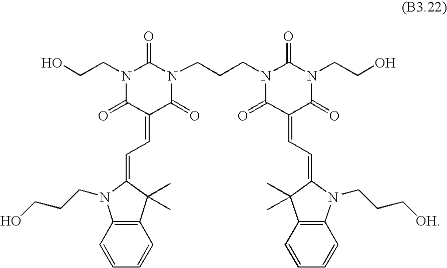

M.p. 225° C.

3.23

4.0 g of B3.22 and 2.6 g of acryloyl chloride are dissolved in 10 ml of N-methyl-2-pyrrolidone. 2.9 g of triethylamine are added dropwise to this solution while stirring with external cooling. The reaction mixture is stirred at RT for 4 hours and then poured into water. The resulting precipitate is filtered off and dried under reduced pressure. Purification is carried out chromatographically on silica gel using the solvent mixture toluene/ethyl acetate=1:2. The yield of the product: 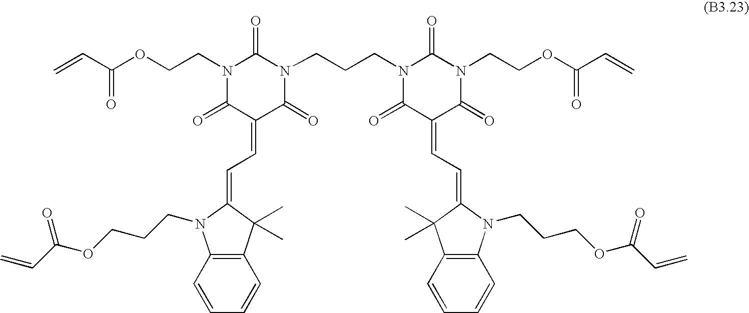
is 2.8 g

M.p. 85° C.

3.24

Repeating the procedure using the substance B3.21 gives the product

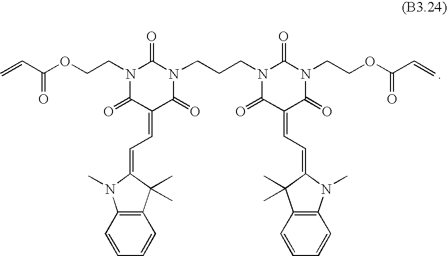

M.p. 142° C.

UV-VIS spectrum (DMF): λₘₐₓ=471 nm; ε=201000 l*cm⁻¹*mol⁻¹

3.25

An analogous procedure is used to prepare the product 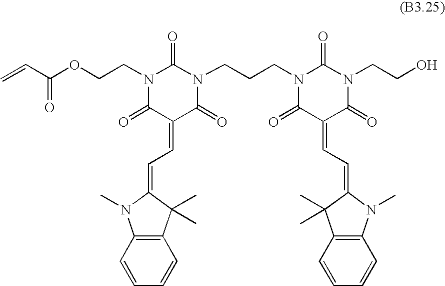
from the substance B3.21.

M.p. 152° C.

3.26

Repeating the procedure using the substance B3.21 and methacryloyl chloride gives the product

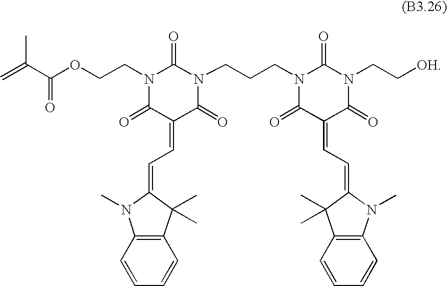

M.p. 190° C.

3.27

Repeating the procedure using the substance B3.16.1 gives the product 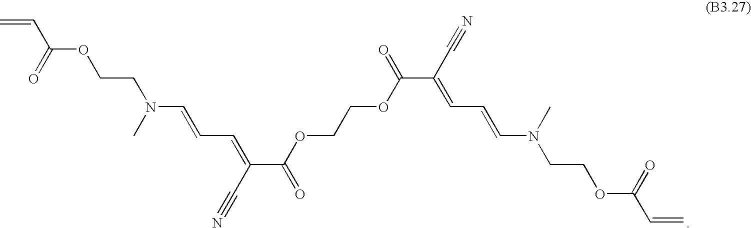
(B3.27).

M.p. 177° C.

UV-VIS spectrum (DMF): λₘₐₓ=382 nm; ε=104000 l*cm⁻¹*mol⁻¹

3.28

Repeating the procedure using the substance B3.16.2 gives the product

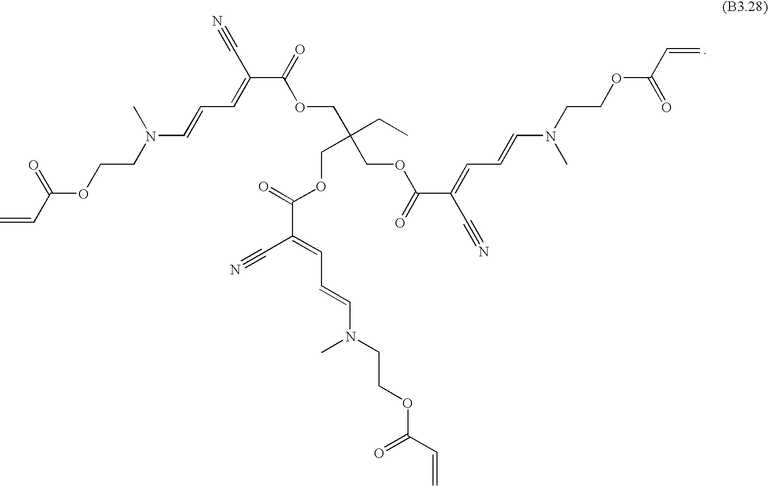

Glass transition temperature: 46° C.

UV-VIS spectrum (DMF): λₘₐₓ=384 nm; ε=177000 l*cm⁻¹*mol⁻¹

3.29

Repeating the procedure using the substance B3.16.3 gives the product

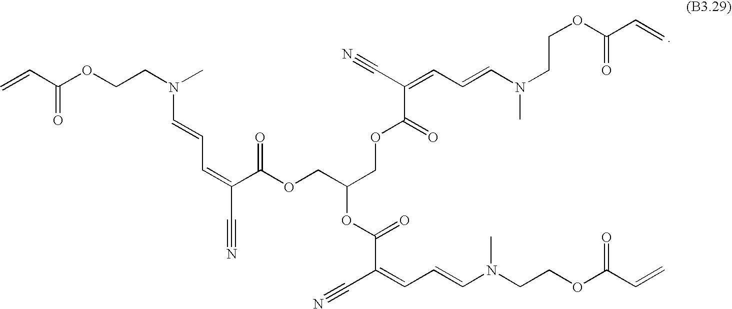

Glass transition temperature: 24° C.

### Example 4

4.1

4.51 g of monomer B3.6 and 0.325 g of 2-hydroxyethyl methacrylate are dissolved in 45 ml of DMF. The solution is purged with argon for 30 minutes. 0.242 g of 2,2′-azobisisobutyronitrile is added to this solution.

The reaction mixture is stirred at 70° C. under the argon atmosphere for 24 hours, then cooled to room temperature and filtered. The filtrate is evaporated on a rotary evaporator. The polymer is purified by boiling three times in methanol and dried under a high vacuum. The yield of the product: 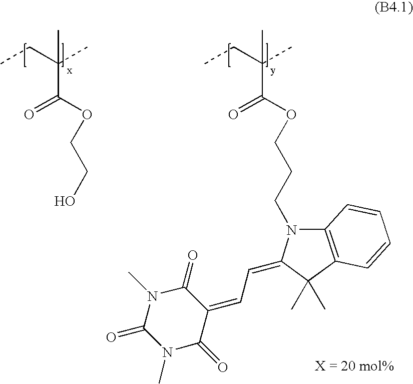
is 3.86 g.
4.2

Using an analogous method, the copolymer 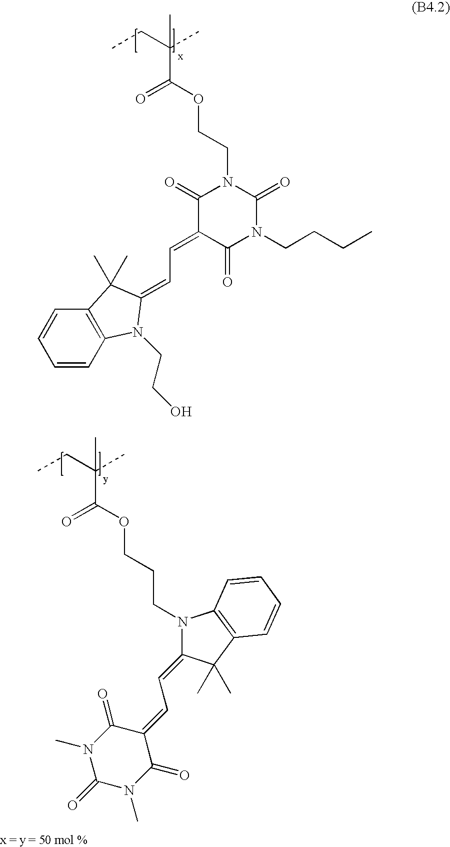
is prepared from the monomers B3.8 und B3.6.

¹H NMR (400 MHz; DMSO-d₆/TMS) δ=5.02 br. (OH)

Molar mass M_{w}=1.15×10⁴; D=M_{w}/Mₙ=2.27 (GPC, DMAA; 60° C., PMMA calibration)

4.2.1

Using an analogous method, the copolymer 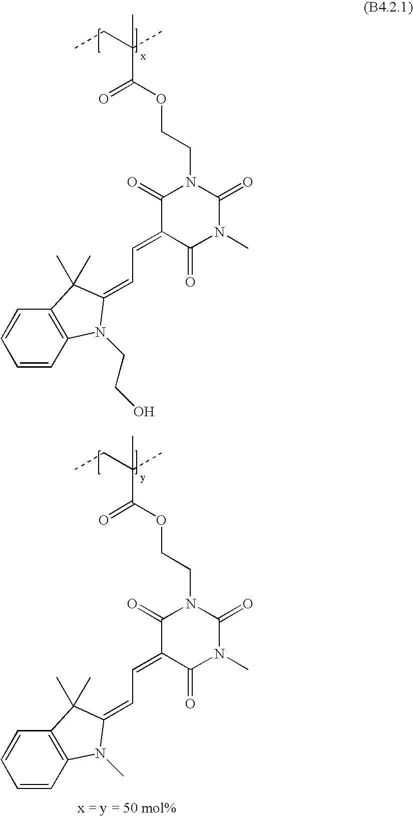
is prepared from the monomers B3.8.1 und B3.11.

Molar mass Mₙ=9.57×10³; D=M_{w}/Mₙ=4.74 (GPC, DMAA; 60° C., PMMA calibration)

4.2.2

Using an analogous method, the copolymer 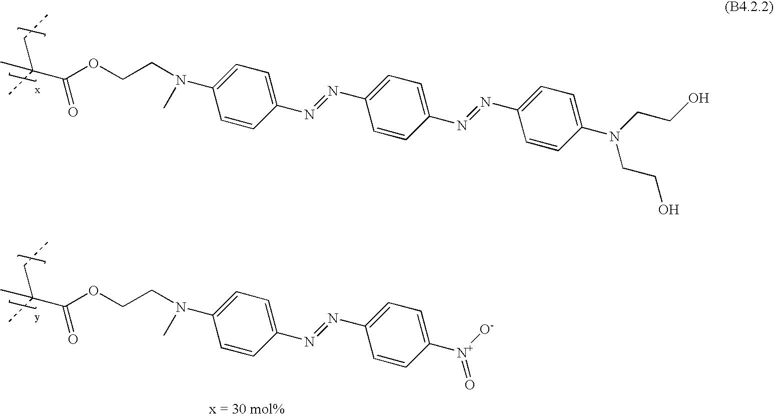
is synthesized from the corresponding monomeric methacrylates prepared as described in WO 9851721.

Molar mass M_{w}=13.4×10⁴; D=M_{w}/Mₙ=2.76 (GPC, DMAA; 60° C., PMMA calibration)

4.3

Using an analogous method, the homopolymer 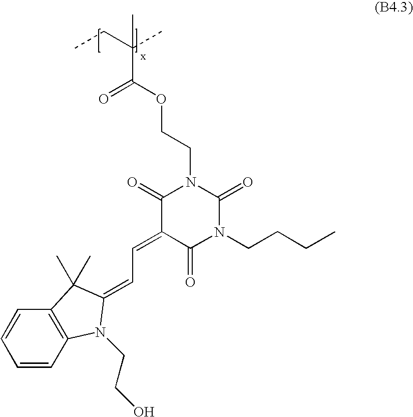
is prepared from the monomer B3.8.

Molar mass M_{w}=1.16×10⁴; D=M_{w}/Mₙ=1.94 (GPC, DMAA; 60° C., PMMA calibration)

4.3.1

Using an analogous method, the homopolymer 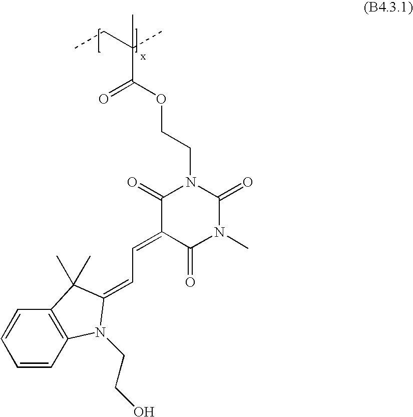
is prepared from the monomer B3.8.1.

Molar mass M_{w}=8.42×10³; D=M_{w}/Mₙ=8.96 (GPC, DMAA; 60° C., PMMA calibration)

4.3.2

Using an analogous method, the homopolymer 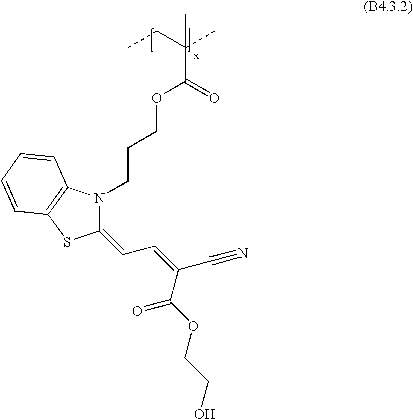
is prepared from the monomer B3.12.1.

¹H NMR (400 MHz; DMSO-d₆/TMS) δ=4.72 br. (OH)

Molar mass M_{w}=3.9×10⁴; D=M_{w}/Mₙ=3.41 (GPC, DMAA; 60° C., PMMA calibration)

4.3.3

Using an analogous method, the homopolymer 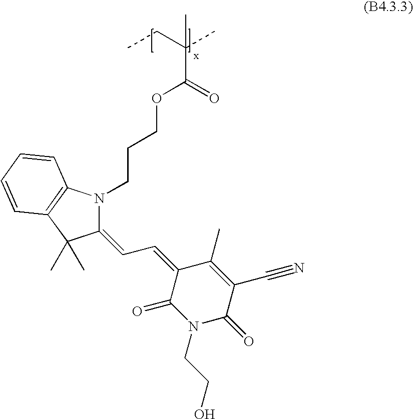
is prepared from the monomer B3.12.1.

¹H NMR (400 MHz; DMSO-d₆/TMS) δ=4.62 br. (OH)

4.3.4

Using an analogous method, the homopolymer 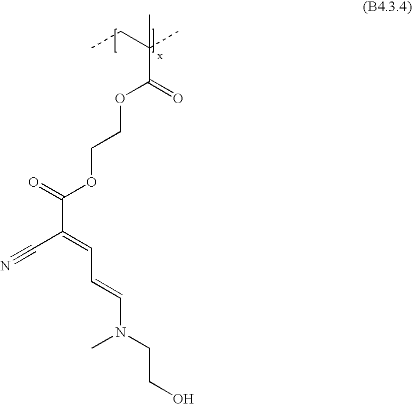
is prepared from the monomer B3.16.

¹H NMR (400 MHz; DMSO-d₆/TMS) δ=4.85 (OH)

Molar mass M_{w}=2.7×10⁴; D=M_{w}/Mₙ=2.88 (GPC, DMAA; 60° C., PS calibration)

4.3.5

Using an analogous method, the homopolymer 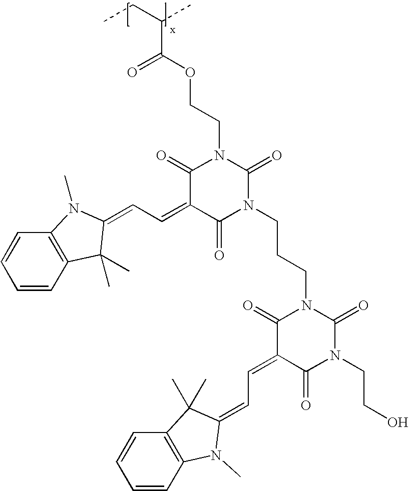
is prepared from the monomer B3.25.

Molar mass M_{w}=4.3×10³; D=M_{w}/Mₙ=1.54 (GPC, DMAA, 60° C., PMMA calibration);

Glass transition temperature: 177° C.

4.4

2.0 g of the polymer B4.2 are dissolved in 10 ml of anhydrous THF. 2.1 g of triethylamine are added. A solution of 2.2 g of methacryloyl chloride in 5 ml of THF is slowly added dropwise to this solution. The reaction mixture is stirred at room temperature for another 2 hours and evaporated on a rotary evaporator. The residue is stirred firstly with water and then with methanol a number of times at room temperature, filtered and dried at room temperature in a high vacuum. The yield of the product: 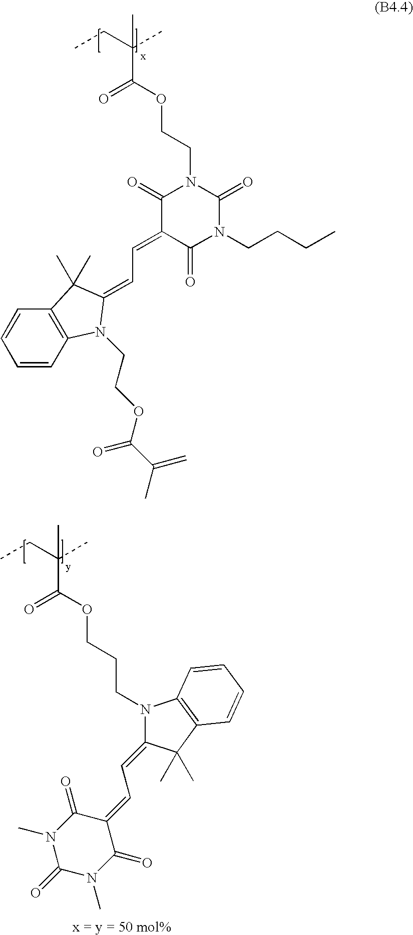
is 0.88 g.

¹H NMR (400 MHz; DMSO-d₆/TMS) δ=5.45 br., 5.78 br. (═CH₂)

4.4.1

Using an analogous method, the copolymer 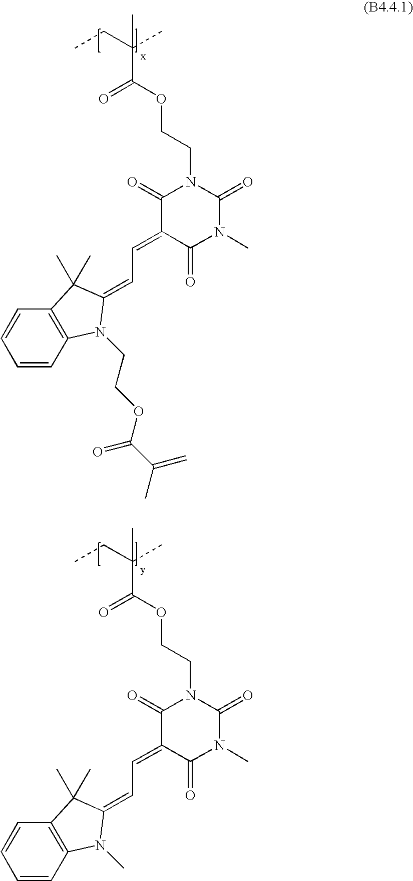
is prepared from the copolymer B4.2.1.
4.4.2

Using an analogous method, the copolymer 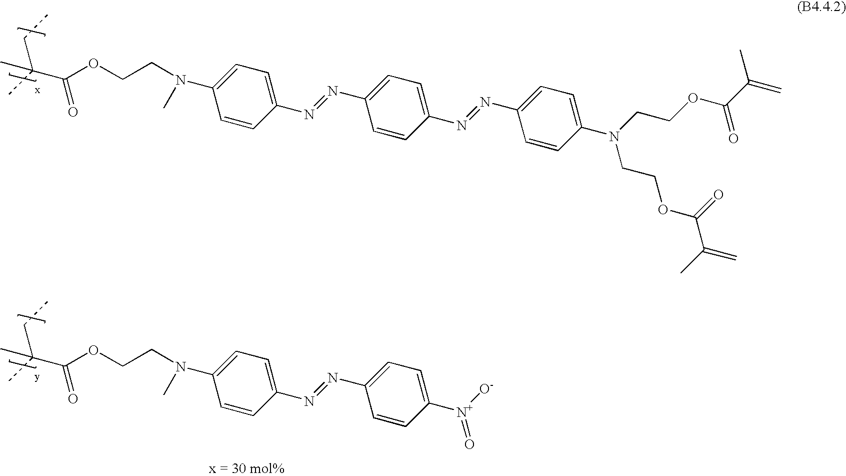
is prepared from the copolymer B4.2.2.
4.5

Using an analogous method, the polymer 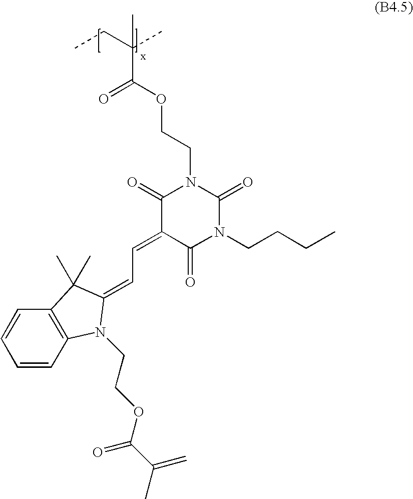
is prepared from the polymer B4.3.
4.5.1

Using an analogous method, the polymer 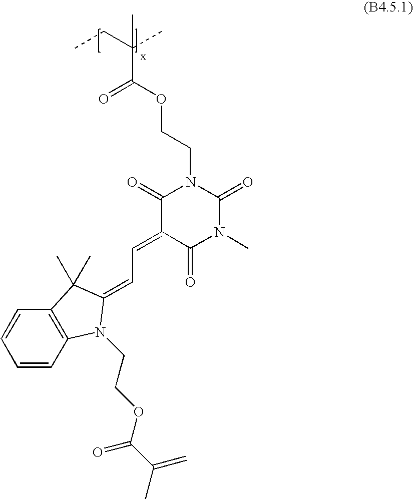
is prepared from the polymer B4.3.1.
4.6

Using an analogous method, the homopolymer 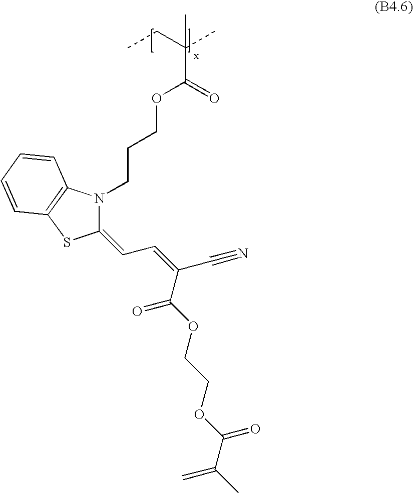
is prepared from the polymer B4.3.2.
4.7

Using an analogous method, the homopolymer 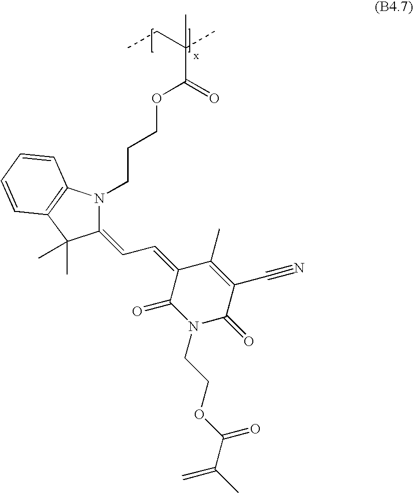
is prepared from the homopolymer B4.3.3.

¹H NMR (400 MHz; DMSO-d₆/TMS)=δ=5.48 br., 5.87 br. (═CH₂)

4.8

2.4 g of the polymer B4.3.4 are dissolved in 100 ml of anhydrous DMF. 7.86 g of triethylamine are added. A solution of 8.14 g of methacryloyl chloride in 30 ml of THF is slowly added dropwise to this solution. The reaction mixture is stirred at room temperature for another 2 hours and evaporated on a rotary evaporator. The residue is stirred firstly with water and then with dioxane a number of times at room temperature, filtered and dried at room temperature in a high vacuum. The yield of the product: 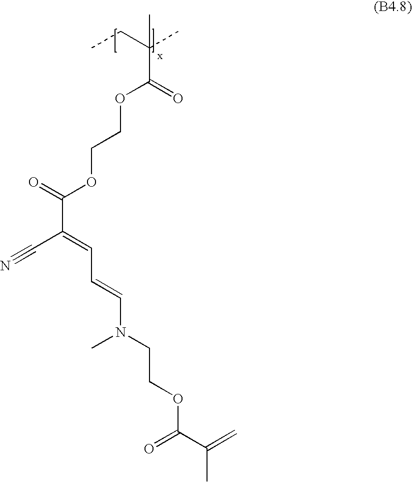
is 1.77 g.

¹H NMR (400 MHz; DMSO-d₆/TMS) δ=5.65 br., 6.01 br. (═CH₂)

### Example 5

The substance B3.5 from Example 3 is dissolved in tetrafluoropropanol (TFP) in a mass ratio of 1 part of solid to 99 parts of TFP. 0.1 part of 2,2′-dimethoxy-1,2-diphenylethan-1-one is introduced into this solution and dissolved. The resulting solution is filtered through a 0.5 μm Teflon filter and applied by spin coating to a fused silica support. This gives a transparent film.

The layer system was introduced into a glove box containing a nitrogen atmosphere (O₂<0.1 ppm; H₂O<0.1 ppm) and exposed to UV light (λ=360 nm; Philips HPW 125 W lamp) for 20 minutes. This gives an insoluble coating B5.1 having a thickness of 45 nm.

Repeating the procedure using a solution consisting of 2 parts of B3.5, 98 parts of TFP and 0.2 parts of 2,2′-dimethoxy-1,2-diphenylethan-1-one gives an insoluble coating B5.1 having a thickness of 92 nm.

The transmission and reflection spectra of the layer systems film/fused silica were determined with vertical incidence of a parallel beam of light having a wavelength range from 200 nm to 1700 nm. The fused silica substrates had a thickness of ˜1 mm. The reflected light was depicted at an angle of 172°to the direction of incidence. Two specimens having different layer thicknesses in the range from 30 nm to 500 nm were examined in each case. The transmission and reflection spectra were evaluated using the known Fresnel formulae and the interferences due to multiple reflections in the layer system were taken into account. A simultaneous least squares fit of the measured transmission and reflection spectra to the calculated spectra for the two layer systems of differing thicknesses enables the layer thicknesses and the complex index of refraction of the organic substance at each wavelength to be determined. For this purpose, the index of refraction of the fused silica support has to be known. The index of refraction of the fused silica substrate as a function of wavelength in this spectral region was determined independently on an uncoated substrate.

Evaluation of the transmission and reflection spectra of the two specimens gave an index of refraction n=1.13 and an absorption coefficient k=0.15 at λ=405 nm for the coating 5.1.

Other curable substances were applied to the fused silica, cured and measured in an analogous way. The results are presented in the table:

| | | | Absorption |
|---|---|---|---|
| | Curable | Index of refraction | coefficient |
| Coating | substance | (λ = 405 nm) | (λ = 405 nm) |
| B5.2 | B3.3 | 1.34 | 0.13 |
| B5.3 | B.3.1 | 1.11 | 0.14 |
| B5.4 | B.3.12 | 1.17 | 0.35 |
| B.5.5 | B.3.9 | 1.16 | 0.18 |
| B5.6 | B3.5 (50% by | 1.07 | 0.21 |
| | weight) | | |
| | B3.10 (50% by | | |
| | weight) | | |
| B5.7 | B3.10 | 1.03 | 0.28 |
| B5.8 | B.4.4 | 1.11 | 0.17 |
| B5.9 | B4.5 | 1.25 | 0.11 |
| B5.10 | B4.5 (20% by | 1.09 | 0.21 |
| | weight) | | |
| | B3.10 (80% by | | |
| | weight) | | |
| B5.11 | B4.6 | 1.06 | 0.22 |
| B5.12 | B3.10.1 | 1.12 | 0.31 |
| B5.13 | B3.13 | 1.74 | 0.09 |
| B5.14 | B3.23 | 0.96 | 0.21 |
| B5.15 | B3.24 | 0.91 | 0.48 |
| B5.16 | B3.27 | 2.75 | 0.56 |
| B5.17 | B3.28 | 2.37 | 0.47 |
| B5.18 | B3.29 | 2.49 | 0.57 |
| B5.19 | B4.5.1 | 1.16 | 0.15 |
| B5.20 | B4.8 | 2.21 | 0.24 |

### Example 6

### Kinetics of UV Curing

For using a method analogous to that of Example 5, eleven coatings are produced on the glass supports from 9 parts of the monomer B.3.5 and 1 part of 2,2′-dimethoxy-1,2-diphenylethan-1-one and cured for different times at 80° C. using a UV light intensity of 10 mW/cm² (Tab.). After curing, the optical density at 477 nm (OD₂) and layer thickness (d₂) are measured on the specimens.

The specimens are then dipped into tetrafluoropropanol (TFP) for 5 minutes, taken out and dried. The optical density at 477 nm (OD₃) and layer thickness (d₃) are measured again on the coatings which remain.

The degree of conversion of curing is determined from these values (Tab.).

After 20 seconds, this parameter is 37%, after 5 minutes 80% and after 40 minutes 100%. All molecules of the monomer are in this case incorporated into a polymeric network.

| | | | | | | | d₃ | | |
|---|---|---|---|---|---|---|---|---|---|
| | | | OD₃ | | | | Layer | | Q_{d} = d₃/d₂ |
| | | | (477 nm) | | d₂ | | thickness | | Degree |
| | | OD₂ | after | Q_{UV} = OD₃/OD₂ | Layer | | after | | of |
| | | (477 nm) | immersion | Degree of | thickness | | immersion | | conversion |
| Time of | | after | in TFP for | conversion | after | | in TFP for | | of |
| illumination | | illumination | 5 minutes | of curing | illumination | | 5 minutes | | curing |
| 20 | sec | 0.660 | 0.246 | 0.37 | 61 | nm | 20 | nm | 0.33 |
| 40 | sec | 0.668 | 0.376 | 0.56 | 61 | | 19 | | 0.31 |
| 1 | min | 0.664 | 0.400 | 0.60 | 60 | | 20 | | 0.33 |
| 1.5 | min | 0.666 | 0.452 | 0.68 | 61 | | 31 | | 0.51 |
| 2 | min | 0.740 | 0.504 | 0.68 | 64 | | 36 | | 0.56 |
| 5 | min | 0.718 | 0.580 | 0.81 | 70 | | 50 | | 0.71 |
| 10 | min | 0.727 | 0.614 | 0.84 | 56 | | 47 | | 0.84 |
| 15 | min | 0.770 | 0.675 | 0.88 | 58 | | 55 | | 0.95 |
| 20 | min | 0.693 | 0.651 | 0.94 | 56 | | 56 | | 1.00 |
| 40 | min | 0.718 | 0.724 | 1.01 | 59 | | 58 | | 0.98 |
| 60 | min | 0.724 | 0.705 | 0.97 | 61 | | 61 | | 1.00 |

Using an analogous method, coatings are produced from the monomer B3.28 and 2,2′-dimethoxy-1,2-diphenylethan-1-one and cured for different 5 times at 40° C. by means of UV light (λ=312 nm). (Tab). Further treatments of the layers which are necessary for determining the degree of conversion of curing are carried out analogously.

| | | | | | d₃ | |
|---|---|---|---|---|---|---|
| | | OD₃ | | | Layer | Q_{d} = d₃/d₂ |
| | | (375 nm) | | d₂ | thickness | Degree |
| | OD₂ | after | Q_{UV} = OD₃/OD₂ | Layer | after | of |
| | (375 nm) | immersion | Degree of | thickness | immersion | conversion |
| Time of | after | in TFP for | conversion | after | in TFP for | of |
| illumination | illumination | 5 minutes | of curing | illumination | 5 minutes | curing |
| 1 min | 0.91 | 0.29 | 0.32 | 76 | 20 | 0.26 |
| 5 min | 0.88 | 0.68 | 0.77 | 74 | 65 | 0.88 |
| 20 min | 0.89 | 0.90 | 1.01 | 75 | 75 | 1.00 |
| 60 min | 0.84 | 0.84 | 1.00 | 75 | 75 | 1.00 |

After 1 minute, the degree of conversion of curing is 30% and after 20 minutes it is 100%. All molecules of the monomer are in this case incorporated into a polymeric network.

Using an analogous method, coatings are produced from 8 parts of the monomer B3.28, 1 part of 2,2′-dimethoxy-1,2-diphenylethan-1-one and 1 part of KAYASORB IRG022 (quencher, from NIPPON KAYAKU) and cured for different times at 40° C. by means of UV light (λ=312 nm). (Tab).

| | | | | | d₃ | |
|---|---|---|---|---|---|---|
| | | OD₃ | | | Layer | Q_{d} = d₃/d₂ |
| | | (375 nm) | | d₂ | thickness | Degree |
| | OD₂ | after | Q_{UV} = OD₃/OD₂ | Layer | after | of |
| | (375 nm) | immersion | Degree of | thickness | immersion | conversion |
| Time of | after | in TFP for | conversion | after | in TFP for | of |
| illumination | illumination | 5 minutes | of curing | illumination | 5 minutes | curing |
| 1 min | 0.88 | — | — | 78 | — | — |
| 5 min | 0.93 | 0.59 | 0.63 | 68 | 39 | 0.57 |
| 20 min | 0.89 | 0.75 | 0.84 | 74 | 64 | 0.86 |
| 60 min | 0.79 | 0.81 | 1.03 | 74 | 74 | 1.00 |

The addition of the quencher leads to some delay in commencement of the reaction, but does not prevent complete curing.

### Example 7

### PUR Curing

The substance B4.3 from Example 4 is dissolved in tetrafluoropropanol (TFP) in a mass ratio of 1 part of solid to 93 parts of TFP. 0.38 part of hexamethylene diisocyanate containing isocyanurate groups and having an NCO content of 21.8%, an equivalent weight of 193 and a viscosity at 23° C. of 3500 mPas (Desmodur® N 3300) is introduced into this solution and dissolved. The resulting solution is filtered through a 0.2 μm Teflon filter. Another solution which consists of 6 parts of dibutyl ether and 0.014 part of dibutyltin dilaurate (DBTL; Desmorapid® 7) and has been filtered in the same way is added to the first solution. The resulting solution is applied by spin coating to a fused silica support. This gives a transparent film.

The layer system was introduced into a glove box containing a nitrogen atmosphere (O₂<0.1 ppm; H₂O<0.1 ppm) and exposed at 130° C. for 2 hours. This gives an insoluble coating B6.1 having a thickness of 142 nm.

Using an analogous method, an insoluble coating B6.1 having a thickness of 234 nm is obtained from a solution consisting of 2 parts of B4.3, 92 parts of TFP, 6 parts of dibutyl ether, 0.76 part of Desmodur® N 3300 and 0.028 part of DBTL.

Examination of this coating in a manner analogous to Example 5 indicates an index of refraction of 1.38 and an absorption coefficient of 0.15 (λ=405 nm).

### Example 8

### Testing the Hardness of Coatings

Dynamic scratch tests were carried out using a nanoindenter on two coatings (from 9 parts of the monomer B3.5 and 1 part of 2,2′-dimethoxy-1,2-diphenylethan-1-one) which had been cured for 20 seconds and 40 minutes (Example 6). In these tests, a 10 μm needle (indenter) is drawn over the coating for 30 seconds using a constant vertical force of 75 μN. The scratches formed are recorded and measured by means of an Atomic Force Microscope (AFM). The depth of the scratch, which can serve as a measure of the hardness of the material, is 37.4±7.8 nm in the case of the coating cured for 20 seconds and is 8.3±2.2 nm in the case of the coating cured for 40 minutes. The experiment shows that the 100%-cured specimen is significantly more scratch resistant than that having a degree of curing of only 37%.

1. Optical data stores having at least one information layer comprising a polymeric network containing covalently bound light-absorbent compounds.

2. Optical data stored according to claim 1, characterized in that the polymeric networks used are networks based on
A) polyfunctional monomers and, if desired,
B) monofunctional monomers,
where at least 50% by weight of the monomers used bear a radical of a light-absorbent compound.

3. Optical data carrier according to claim 1, characterized in that at least one monomer on which the polymeric network is based has an absorption maximum λₘₐₓ₁ in the range from 340 to 410 nm or an absorption maximum λₘₐₓ₂ in the range from 400 to 650 nm or an absorption maximum λₘₐₓ₃ in the range from 630 to 820 nm, where the wavelength λ_{1/2}, at which the absorbance in the long wavelength flank of the absorption maximum at the wavelength λₘₐₓ₁, λₘₐₓ₂ or λₘₐₓ₃ or the absorbance in the short wavelength flank of the absorption maximum at the wavelength λₘₐₓ₂ or λₘₐₓ₃ is half of the absorbance value at λₘₐₓ₁, λₘₐₓ₂ or λₘₐₓ₃ and the wavelength λ_{1/10} at which the absorbance in the long wavelength flank of the absorption maximum at the wavelength λₘₐₓ₁, λₘₐₓ₂ or λₘₐₓ₃ or the absorbance in the short wavelength flank of the absorption maximum at the wavelength λₘₐₓ₂ or λₘₐₓ₃ is one tenth of the absorbance value at λₘₐₓ₁, λₘₐₓ₂ or λₘₐₓ₃ are preferably not more than 80 nm apart.

4. Optical data carrier according to claim 2, characterized in that the functional monomers bear polymerizable C—C double bonds.

5. Optical data carrier according to one or more of claims 1 to 4, characterized in that the information layer comprises a polymeric network based on monomers of the formula II
KₖB_{b}F_{f} (II),
where
F is a chromophoric centre, with all f chromophoric centres being able to be different;
K is a polymerizable group, with all k polymerizable groups being able to be different,
B is a bridge, with all b bridges being able to be different,
k is an integer from 2 to 1000,
b, f are integers which can independently assume values from 1 to 1000.

6. Optical data carrier according to claim 1, characterized in that at least one monomer on which the polymeric network is based has at least one functional group of the formula (M1) 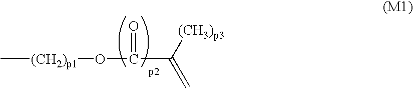
where
p1 is from 1 to 6, in particular 2 or 3,
p2 is 0 or 1 and
p3 is 0 or 1; in particular, (M1) is a radical of the formula 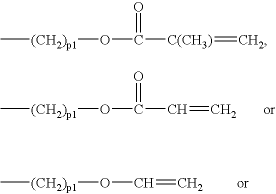
at least one functional group of the formula 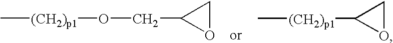
where
p1 is as defined above or
at least two functional groups K—B of the formula (M2) 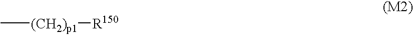
where
p1 is as defined above and
R¹⁵⁰ is 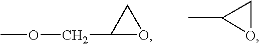
—OH or NH₂.

7. Optical data carrier according to claim 1, characterized in that the monomers used for producing its information layer have the formulae III-VI:
(K—B¹—)ₙF (III)
(K—B¹—)ₙF—B²—F(—B¹—K)ₙ (IV)
B³[—F(—B¹—K)ₙ]ₘ (V)
[(K—)₍ₘ₋₁₎B³—]ₙF (VI)
where
B¹ and B² are each a bivalent bridge,
B³ is an m-valent bridge,
n is an integer from 1 to 8,
m is 3 or 4.

8. Process for producing the optical data carriers according to claim 1, characterized in that a solution comprising
a) the monomers on which the polymeric network is based, in particular
A) polyfunctional monomers and, if desired
B) monofunctional monomers,
where at least 50% by weight of the monomers bear the radical of a light-absorbent compound,
b) if desired, a preferably organic solvent,
c) if desired, polymerization initiators and
d) if desired, further additives such as quenchers or sensitizers,
is applied to a substrate, the polymerization is initiated and this procedure is, if desired, repeated a number of times.

9. Process for producing optical data stores according to claim 1, characterized in that at least one polymer layer comprising a crosslinked polymer based on the monomers on which the polymeric network is based, in particular
A) polyfunctional monomers and, if desired,
B) monofunctional monomers,
where at least 50% by weight of the monomers bear a radical of a light-absorbent compound,
is applied as information layer to a substrate.

10. Composition comprising a monomer on which the polymeric network is based, in particular
i) a monomer having at least one functional group of the formula (M1) or at least 2 functional groups of the formula (M2) according to claim 6 and a light-absorbing group and
ii) an organic solvent and
iii) if desired, further additives.

11. Polymer layers made up of at least one crosslinked polymer based on
A) a polyfunctional monomer and, if desired,
B) monofunctional monomers,
where at least 50% by weight of the monomers bear a radical of a light-absorbent compound.

12. Process for producing polymer layers according to claim 11, characterized in that the monomers on which the polymeric network is based, in particular the solution of the invention, is applied to a suitable support which can be detached again, the polymerization is initiated and the steps of application of the solution, polymerization and, if applicable, removal of the solvent are repeated a number of times if appropriate, thus applying the second and any further layer to the previous layer, and the support which can be detached again is subsequently removed again.

13. Compounds containing at least one functional group of the formula (M1) 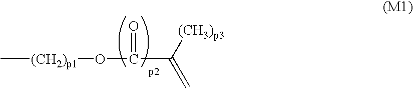
where
p1 is from 1 to 6, in particular 2 or 3,
p2 is 0 or 1 and
p3 is 0 or 1; in particular, (M1) is a radical of the formula 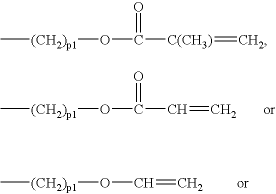
at least one functional group of the formula 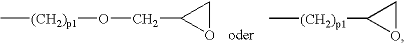
where
p1 is as defined above or
at least two functional groups K—B of the formula (M2) 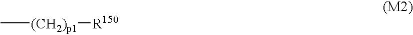
where
p1 is as defined above and
R¹⁵⁰ is 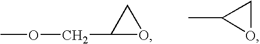
—OH or NH₂,
and at least one light-absorbing group.

14. Use of polymer layers according to claim 11 for producing optical data carriers.

15. Optical data carriers according to claim 1 which have been written on by means of blue, red or infrared light, in particular laser light.

16. Polymeric network comprising covalently bound light-absorbent compounds.
